(19) United States
(12) Patent Application Publication
(10) Pub. No.: US 2013/0191445 A1
(43) Pub. Date: Jul. 25, 2013

(54) METHOD AND APPARATUS FOR CONTENT MANAGEMENT

(71) Applicant: Curriculum Loft LLC, Indianapolis, IN (US)

(72) Inventors: JOHN RYAN GAYMAN, INDIANAPOLIS, IN (US); JOSHUA DALE WHITIS, GREENWOOD, IN (US); DONALD HARRY HARMON, III, GREENWOOD, IN (US)

(73) Assignee: CURRICULUM LOFT LLC, INDIANAPOLIS, IN (US)

(21) Appl. No.: 13/745,412

(22) Filed: Jan. 18, 2013

Related U.S. Application Data
(60) Provisional application No. 61/588,570, filed on Jan. 19, 2012.
(60) Provisional application No. 61/599,214, filed on Feb. 15, 2012.

(51) Int. Cl. H04L 29/06

(52) U.S. Cl. CPC H04L 29/06047
USPC 709/203

(57) ABSTRACT

A system and method for content generation and management is provided. A content management system includes an administration system, a local content server, and one or more portable devices. Software modules are operative to perform education-based functions and to manage digital curriculum content on the content management system.

### CROSS-REFERENCE TO RELATED APPLICATIONS

This application claims the benefit of U.S. Provisional Application No. 61/588,570, titled “Method and Apparatus for Content Management,” filed Jan. 19, 2012, and U.S. Provisional Application No. 61/599,214, titled “Method and Apparatus for Content Management,” filed Feb. 15, 2012, the disclosures of which are expressly incorporated by reference herein.

### BACKGROUND AND SUMMARY

The disclosure relates generally to content generation and management. More particularly, the disclosure relates to content generation and management for one or more devices.

As computers and computing devices continue to be integrated into workflows and to store and recall content, the ability to effectively manage and control the content is increasingly important. Content may be, for example, spread across many different systems and the systems may not communicate with one another, making content sharing or other tasks difficult, and making unnecessary duplication of existing content a likely possibility.

Accordingly, there exists a need for an improved content generation and management system for devices.

According to an illustrative embodiment of the present disclosure, a method of managing content on at least one network in an educational environment is provided. The method includes receiving, by a local content server, at least one software module from an administration system over a wide area network. The administration system includes a plurality of software modules operative to perform education-based functions and to manage digital curriculum content. The method includes at least one of generating and managing digital curriculum content with the at least one software module at the local content server. The local content server is connected to a local area network. The method includes detecting at least one student computing device on the local area network, and digital curriculum content is stored at the at least one student computing device. The method further includes syncing the digital curriculum content at the local content server with the digital curriculum content stored on the at least one student computing device.

According to another illustrative embodiment of the present disclosure, a content management system is provided that is configured to manage content on at least one network in an educational environment. The content management system includes an administration system configured to communicate over a wide area network. The administration system includes a plurality of software modules configured to perform education-based functions and to manage digital curriculum content stored on a cloud system. The content management system includes a local content server connected to a local area network. The local content server is configured to receive at least one software module from the administration system over the wide area network and to at least one of generate and manage digital curriculum content with the at least one software module. The content management system further includes a plurality of student computing devices each including a transceiver for communicating over the local area network with the local content server. The local content server is operative to sync digital curriculum content at the local content server with digital curriculum content stored on the plurality of student computing devices when the plurality of student computing devices are connected on the local area network.

According to yet another illustrative embodiment of the present disclosure, a method of managing curriculum content on at least one network in an educational environment. The method includes providing a portable computing device operative to execute a curriculum module and at least one non-education based application. The curriculum module is configured to perform education-based functions including at least one of assignment management and test management and to connect to a network for accessing electronic course materials. The method includes transmitting, by a computing system, a lock mode signal to the portable computing device to initiate a lock mode at the portable computing device. In the lock mode, the portable computing device allows operation of the curriculum module and blocks user access to the at least one non-education based application. The method includes transmitting, by the computing system, digital curriculum content to memory of the portable computing device.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating an example of a content management system according to an embodiment of the present disclosure;

FIG. 2 is a block diagram illustrating an example of a local content server and administration system according to an embodiment of the present disclosure;

FIG. 3A is a block diagram of an exemplary administration system according to an embodiment of the present disclosure;

FIG. 3B is a block diagram of an exemplary local content server according to an embodiment of the present disclosure;

FIG. 4 is a block diagram of an exemplary portable device according to an embodiment of the present disclosure;

FIG. 5A is an exemplary graphical user interface showing a cloud system set up screen according to an embodiment of the present disclosure;

FIG. 5B is an exemplary graphical user interface showing a building set up screen according to an embodiment of the present disclosure;

FIG. 5C is an exemplary graphical user interface showing a resources and subscriptions configuration screen according to an embodiment of the present disclosure;

FIG. 6 is an exemplary graphical user interface showing an explore system set up screen according to an embodiment of the present disclosure;

FIG. 7 is an exemplary graphical user interface showing another exemplary explore system set up screen according to an embodiment of the present disclosure;

FIG. 8 is an exemplary graphical user interface showing a local content server settings screen according to an embodiment of the present disclosure;

FIG. 9 is an exemplary graphical user interface showing a web link management screen according to an embodiment of the present disclosure;

FIG. 10 is an exemplary graphical user interface showing a web link approval screen according to an embodiment of the present disclosure;

FIG. 11 is an exemplary graphical user interface showing web link management according to an embodiment of the present disclosure;

FIG. 11A is an exemplary graphical user interface showing web link request management according to an embodiment of the present disclosure;

FIG. 12 is an exemplary graphical user interface showing web link request approval/denial according to an embodiment of the present disclosure;

FIG. 13 is an exemplary graphical user interface showing an automate module set up screen according to an embodiment of the present disclosure;

FIG. 14 is an exemplary graphical user interface showing another automate module set up screen for data export field mapping according to an embodiment of the present disclosure;

FIG. 15 is an exemplary graphical user interface showing a user management screen according to an embodiment of the present disclosure;

FIG. 16 is an exemplary graphical user interface showing another user management screen according to an embodiment of the present disclosure;

FIG. 17 is an exemplary graphical user interface showing device management at the local content server according to an embodiment of the present disclosure;

FIG. 18 is an exemplary graphical user interface showing user group permission management at the local content server according to an embodiment of the present disclosure;

FIG. 19 is an exemplary graphical user interface showing global device control at the local content server according to an embodiment of the present disclosure;

FIG. 20 is an exemplary graphical user interface showing global activation settings according to an embodiment of the present disclosure;

FIG. 20A is an exemplary graphical user interface showing standards selections according to an embodiment of the present disclosure;

FIG. 20B is an exemplary graphical user interface showing global LDAP settings according to an embodiment of the present disclosure;

FIG. 21 is an exemplary graphical user interface showing an administrator home screen according to an embodiment of the present disclosure;

FIG. 22 is an exemplary graphical user interface showing account information set up for a user according to an embodiment of the present disclosure;

FIG. 23 is an exemplary graphical user interface showing classroom device control according to an embodiment of the present disclosure;

FIG. 24 is an exemplary graphical user interface showing a classroom device view according to an embodiment of the present disclosure;

FIG. 25 is an exemplary graphical user interface showing the active screens of available devices according to an embodiment of the present disclosure;

FIG. 26 is an exemplary graphical user interface showing the active screen of one device according to an embodiment of the present disclosure;

FIG. 27A is an exemplary graphical user interface showing assignment management of the automate module according to an embodiment of the present disclosure;

FIG. 27B is an exemplary graphical user interface for creating an assignment with the automate module according to an embodiment of the present disclosure;

FIG. 27C is another exemplary graphical user interface for creating an assignment with the automate module according to an embodiment of the present disclosure;

FIG. 27D is an exemplary graphical user interface for creating an assignment question with the automate module according to an embodiment of the present disclosure;

FIG. 28 is an exemplary graphical user interface showing assignment generation according to another embodiment of the present disclosure;

FIG. 29 is an exemplary graphical user interface showing course content available from other users according to an embodiment of the present disclosure;

FIG. 30 is an exemplary graphical user interface showing assignment management according to an embodiment of the present disclosure;

FIG. 31 is an exemplary graphical user interface showing assignment distribution settings according to an embodiment of the present disclosure;

FIG. 32 is an exemplary graphical user interface showing assignment group distribution settings according to an embodiment of the present disclosure;

FIG. 33 is an exemplary graphical user interface showing assignment grading with the automate module according to an embodiment of the present disclosure;

FIG. 34 is an exemplary graphical user interface showing assignment grading management by class according to an embodiment of the present disclosure;

FIG. 35A is an exemplary graphical user interface showing assignment results by student according to an embodiment of the present disclosure;

FIG. 35B is an exemplary graphical user interface showing question-by-question assignment results according to an embodiment of the present disclosure;

FIG. 36 is an exemplary graphical user interface showing assignment results by class and student according to an embodiment of the present disclosure;

FIG. 37A is an exemplary graphical user interface showing standards mapping to assignments and an instant response session according to an embodiment of the present disclosure;

FIG. 37B is an exemplary graphical user interface showing standards assignment according to an embodiment of the present disclosure;

FIG. 37C is an exemplary graphical user interface showing standards according to an embodiment of the present disclosure;

FIG. 38 is an exemplary graphical user interface showing the analysis of an instant question according to an embodiment of the present disclosure;

FIG. 39 is an exemplary graphical user interface showing a student home screen according to an embodiment of the present disclosure;

FIG. 40 is an exemplary graphical user interface showing a student assignment and courses screen according to an embodiment of the present disclosure;

FIG. 41 is an exemplary graphical user interface showing an assignment upload form for a student user according to an embodiment of the present disclosure;

FIG. 42 is an exemplary graphical user interface showing a student assignment information screen according to an embodiment of the present disclosure;

FIG. 43 is an exemplary graphical user interface showing a student question screen according to an embodiment of the present disclosure;

FIG. 44 is an exemplary graphical user interface showing an assignment summary screen for a student according to an embodiment of the present disclosure;

FIG. 45 is an exemplary graphical user interface showing a student instant response screen according to an embodiment of the present disclosure;

FIG. 46 is an exemplary graphical user interface showing a units of study overview screen according to an embodiment of the present disclosure;

FIG. 47 is an exemplary graphical user interface showing a unit of study management screen according to an embodiment of the present disclosure;

FIG. 48 is an exemplary graphical user interface showing a unit launcher template builder screen according to an embodiment of the present disclosure;

FIG. 49 is an exemplary graphical user interface showing a content creator screen according to an embodiment of the present disclosure;

FIG. 50 is an exemplary flowchart showing a method of receiving and recording assignments according to an embodiment of the present disclosure;

FIG. 51 is an exemplary flowchart showing a method of allocating applications according to an embodiment of the present disclosure; and

FIG. 52 is an exemplary flowchart showing a method of assigning and reporting standards information according to an embodiment of the present disclosure.

### DETAILED DESCRIPTION

The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the embodiments, various logic may be implemented in any appropriate fashion and would remain in accordance with the embodiments herein disclosed.

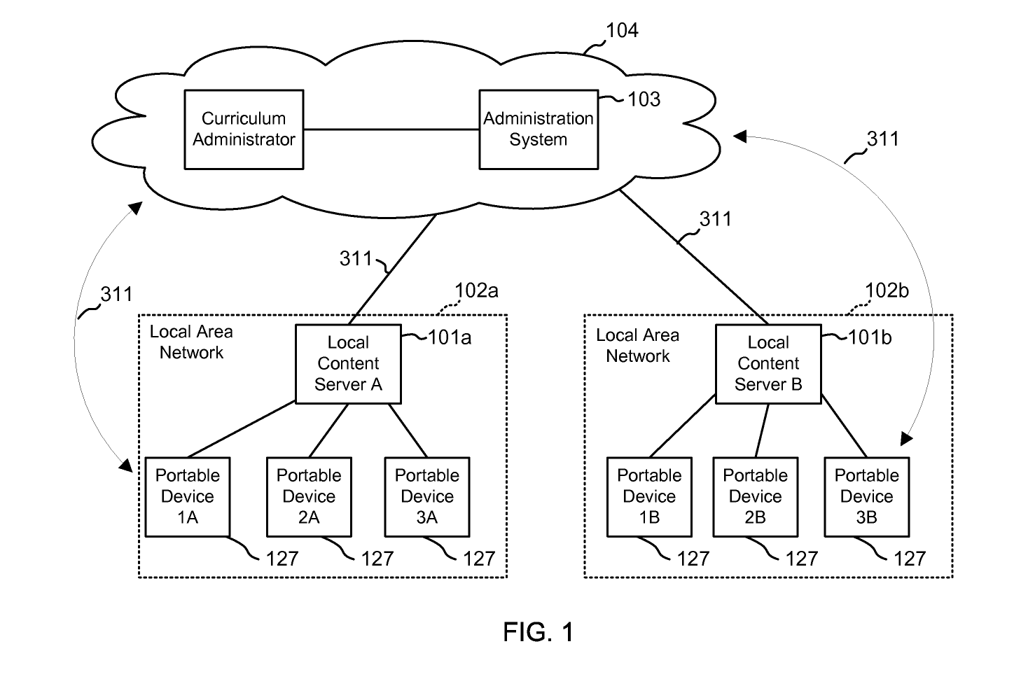

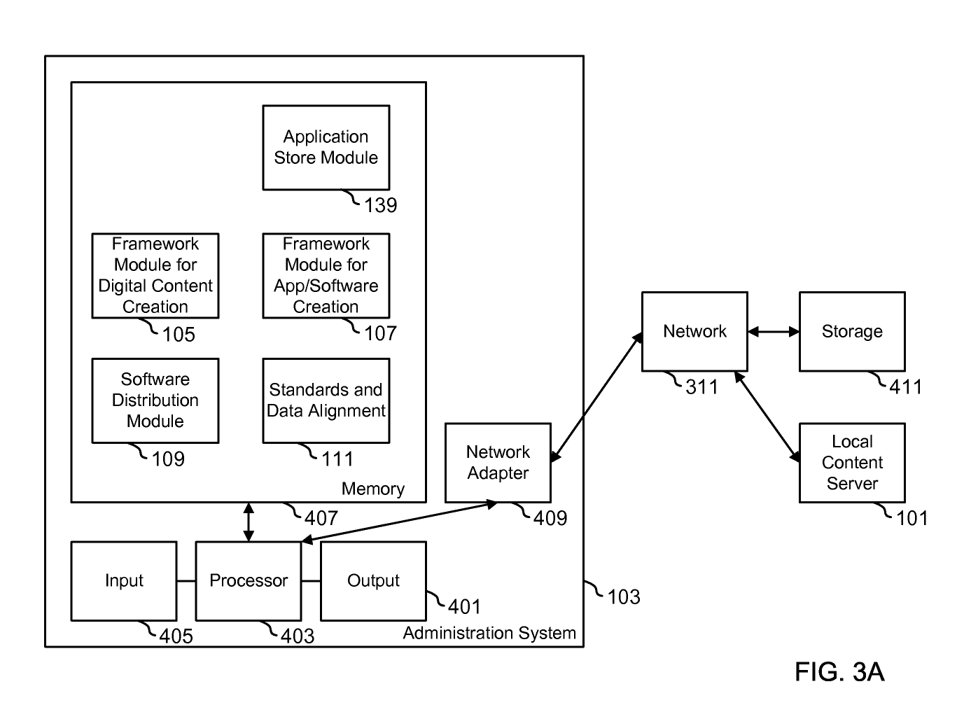

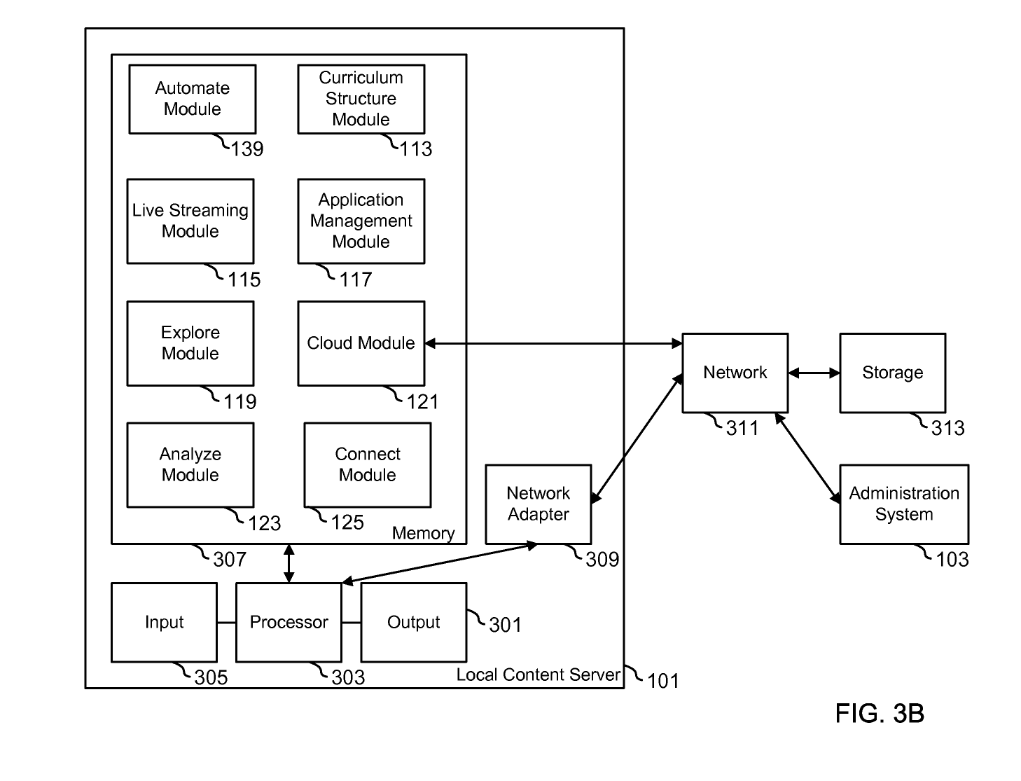

FIG. 1 illustrates an example of a content management system according to an embodiment of the present disclosure that includes an administration system 103. The administration system 103 communicates via one or more networks to one or more local content systems, illustratively local content servers 101a, 101b. Administration system 103 is illustratively provided in an internet-hosted environment 104 to communicate with local content servers 101a, 101b via a wide-area network 311, such as an Internet-based network 311, or other suitable network. In one embodiment, administration system 103 is a cloud-based system including cloud storage (e.g., storage 411 of FIG. 3A). Local content servers 101a, 101b are provided on a local area network 102a, 102b, respectively. The local area network 102 may be provided in a school building, office building, manufacturing facility, or other suitable environment or site. The local content server 101a, 101b communicates with one or more portable devices 127 on the local area network 102a, 102b. Although each local content server 101a, 101b in the exemplary embodiment is provided with three portable devices 127, more or fewer portable devices 127 may be provided.

The portable devices 127 may be, for example, tablet computers, laptop computers, desktop computers, smart phones, or other computing devices. In the illustrated embodiment, the portable devices 127 are also configured to communicate directly with administration system 103 via one or more networks, such as the wide-area network 311. As such, portable devices 127 are configured to retrieve and transmit content with administration system 103 when the portable devices 127 are offsite and not connected to the local area network 102a, 102b. In the illustrated embodiment, third-party systems may also communicate with the administration system 103 via one or more networks, or may communicate with one or more of the local content systems, or may communicate with one or more of the portable devices 127. In the examples shown throughout the figures, a school setting is illustrated, with curriculum-based content created by teachers, administrators, or students. The content is reviewed and/or consumed by the users of the portable devices 127. Other examples of applications for the device management system are also applicable, and the disclosure is not limited to a teacher and student application. In the illustrated embodiment, curriculum content as referenced herein includes, for example, assignments, tests, quizzes, reference materials, videos, applications, web links, presentations, text documents, other course materials, and any other curriculum and education based documents and data.

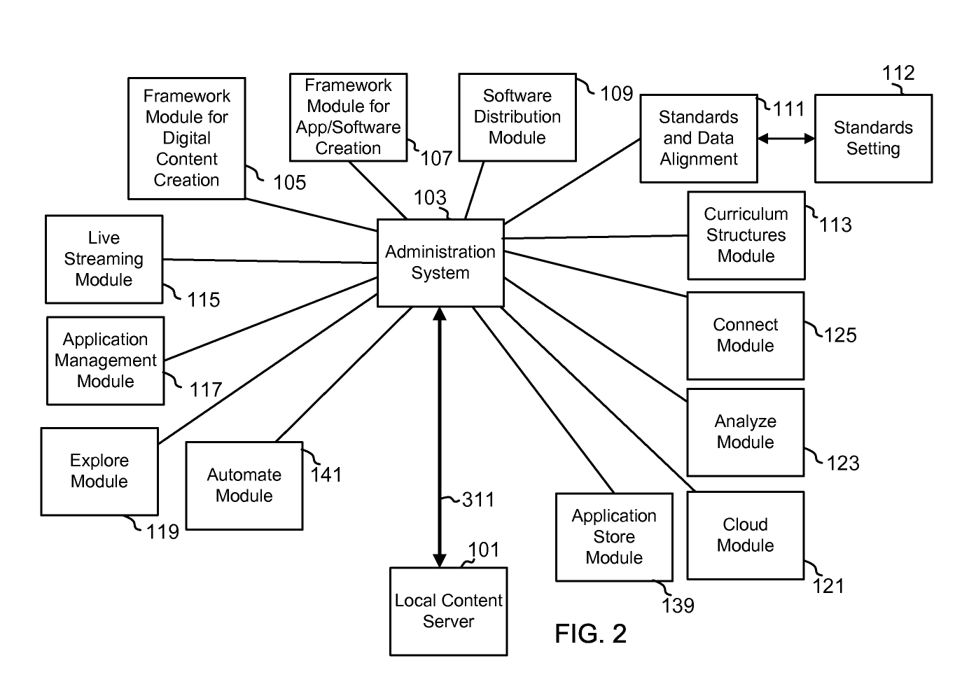

FIG. 2 illustrates a block diagram showing an example of cloud-based administration at administration system 103 and a local content server 101 according to an embodiment of the present disclosure. In the embodiment, an administration system 103 and a local content server 101 communicate with one another via one or more networks, such as the Internet-based network 311, for example. The administration system 103 illustratively includes a plurality of modules that provide various functionalities for the content management system, including education-based functions, managing and generating digital curriculum content, etc., as described herein. The administration system 103, in an embodiment, may include fewer or additional modules than illustrated in FIG. 2. In the illustrated embodiment, the modules in communication with the administration system 103 are executed on the administration system 103. In another embodiment, one or more of the modules in communication with the administration system 103 are executed on one or more stand-alone systems, and are in communication with the administration system 103 via one or more networks. In the illustrated embodiment, the administration system 103 includes a framework module for digital content creation 105, a framework module for application and/or software creation 107, a software distribution module 109, a standards and data alignment module 111, a live streaming module 115, an application management module 117, an explore module 119, a cloud module 121, an analyze module 123, a connect module 125, a curriculum structures module 113, an automate module 141, and an application store module 139. In an embodiment, the framework module for digital content creation 105, the framework module for application and/or software creation 107, the software distribution module 109, the standards and data alignment module 111, and the application store module 139 are in communication with one or more third-party systems. In an embodiment, the administration system 103, and associated modules, are cloud-based and/or are accessible via one or more networks.

In one embodiment, one or more of the modules of administration system 103 are accessible by the local content server 101 and/or the portable devices 127 (FIG. 1). As described herein, one or more of the modules of administration system 103 may be received by and stored at the local content server 101. For example, the local content server 101 may request one or more of the administration modules from the administration system 103 and cache the modules in memory such that the local content server 101 executes the module(s). As such, communication and bandwidth consumption between the administration system 103 and the local content server 101 and/or the administration system 103 and the portable devices 127 may be reduced. In addition, the local content server 101 may copy curriculum-based content stored at the administration cloud (e.g., storage 411 of FIG. 3A) and store or cache the curriculum-based content at the local content server 101 or other memory accessible by the local content server 101, thereby mirroring content stored at the administration system 103. Once the modules and/or content are cached and stored, the portable devices 127 may communicate with the modules executed at the local content server 101 and may access/receive the curriculum content at the local content server 101 without communication with the administration system 103. In one embodiment, the local content server 101 stores or caches curriculum content upon a request for the content from the portable device 127. In one embodiment, curriculum content from the cloud mirrored at the local content server 101 or other LAN storage location increases the likelihood that multiple portable devices 127 (tens to thousands, for example) can receive/retrieve the content simultaneously without internet bandwidth limitations encountered when accessing the cloud over the internet-based network 311. In one embodiment, the local content server 101 locally stores and executes the modules that are frequently used by the local content server 101 and/or the portable devices 127. As such, while the modules are illustratively linked to the administration system 103 in FIG. 2, the local content server 101 may also retrieve and execute one or more of the modules locally at the server 101. Exemplary modules executed at the local content server 101 include the live streaming module 115, the application management module 117, the explore module 119, the cloud module 121, the analyze module 123, the connect module 125, the curriculum structures module 113, and the automate module 141, although fewer or additional modules may be provided.

Similarly, the portable device 127 may store or cache one or more of the administration modules in memory such that the portable device 127 executes the module(s), thereby reducing communication and bandwidth consumption between the portable device 127 and the administration system 103 or the local content server 101 for executing certain functions. In one embodiment, the portable device 127 receives the module(s) from the local content server 101, although the portable device 127 may alternatively receive the module(s) directly from the administration system 103 over the network 311. In one embodiment, the portable device 127 comes pre-loaded with one or more modules. Exemplary modules executed at the portable device 127 include the explore module 119, the cloud module 121, the analyze module 123, the automate module 141, the connect module 125, and the live streaming module 115.

In one embodiment, one or more of the modules in communication with the local content server 101 are executed on one or more stand-alone systems, and are in communication with the local content server 101 via one or more networks. The local content server 101 may be in communication with the one or more modules via one or more additional networks, such as, for example, a local area network 102 (FIG. 1). The one or more additional networks may be wired or wireless or may contain a mixture of wired and wireless access points.

The local content server 101, described with respect to FIGS. 2 and 3B, may be, for example and without limitation, an executing software module executing by logic, such as logic that includes one or more processors 303 and suitable memory 307, discrete logic, an ASIC or any suitable structure. The local content server 101 includes suitable communication interfaces as known in the art, and one or more input devices 305 (e.g., keyboard, mouse, touchscreen, etc.) and output devices 301 (e.g., display, speakers, etc.), as known in the art. The administration system 103 may be in communication with the local content server 101 and/or one or more of the local content servers 101 via one or more networks 311. In an embodiment, the local content server 101 includes additional circuitry or other hardware, such as network adapter 309, to provide access to one or more networks 311, such as, for example, the Internet. In an embodiment, the local content server 101 includes one or more processors 303 that are operable to execute instructions, retrieve from locations in the memory 307, and write to locations to the memory 307. The processor 303 may access the memory 307 via one or more busses. In an embodiment, the memory 307 includes, but is not limited to, hard disk drives, flash memory, random-access memory, or other data storage and recall devices. The local content server 101 may also be associated with additional elements, such as an operating system, a display or other output device 301, and an input device 305. The input device may be, for example and without limitation, a keyboard and/or touch screen. The local content server 101 may include more than one input device, or may be capable of input from one or more input devices. The local content server 101 includes one or more applications or functionality stored in memory 307 and executed by logic, such as the processor. The functionality may include, but is not limited to a live streaming module 115, an application management module 117, an explore module 119, a cloud module 121, an analyze module 123, a connect module 125, a curriculum structures module 113, and/or an automate module 141. One or more modules may be installed during the initial set up of the local content server 101, and one or more modules may be installed at a later date. For example, and without limitation, an administrator or other user of the local content server 101 may request and/or purchase one or more of the modules from the administration system 103, and may install the one or more modules onto the local content server 101. In one embodiment, the administration system 103 pushes the requested modules onto the local content server 101. The local content server 101 may also be in communication with one or more storage devices 313 via the network 311. The storage devices 313 may be, for example and without limitation, associated with the local content server 101, or associated with one or more systems separate from the local content server 101, and accessible to the local content server 101 via one or more networks. In the illustrated embodiment, storage 313 is a part of a cloud-based computing or storage solution, and include storage 411 of FIG. 3A. In the illustrated embodiment, content generated and received at the local content server 101 is stored at the cloud storage 313, 411, although the local content server 101 may also cache or store some of the content, as described herein.

In an embodiment, the modules associated with the local content server 101 described herein may be implemented as software or firmware programs stored on computer readable storage medium such as but not limited to CD-ROM, RAM, ROM, other forms of ROM, hard drives, distributed memory, etc., in combination with processors. As such, software programs may be stored computer readable storage medium. The computer readable storage medium stores instructions executable by one or more processors that causes the one or more processors to perform operations described herein.

The live streaming module 115 receives content from one or more third-party systems. The content may include, but is not limited to, television signals, radio signals, streaming video and/or audio and/or other data from one or more content servers, or other streaming video and/or audio and/or other data from other third-party systems. The content servers may include, but are not limited to, content servers available from third parties such as, for example, video and/or audio on demand systems. The content servers, in an embodiment, may include one or more computers in communication with the local content server 101 via a network.

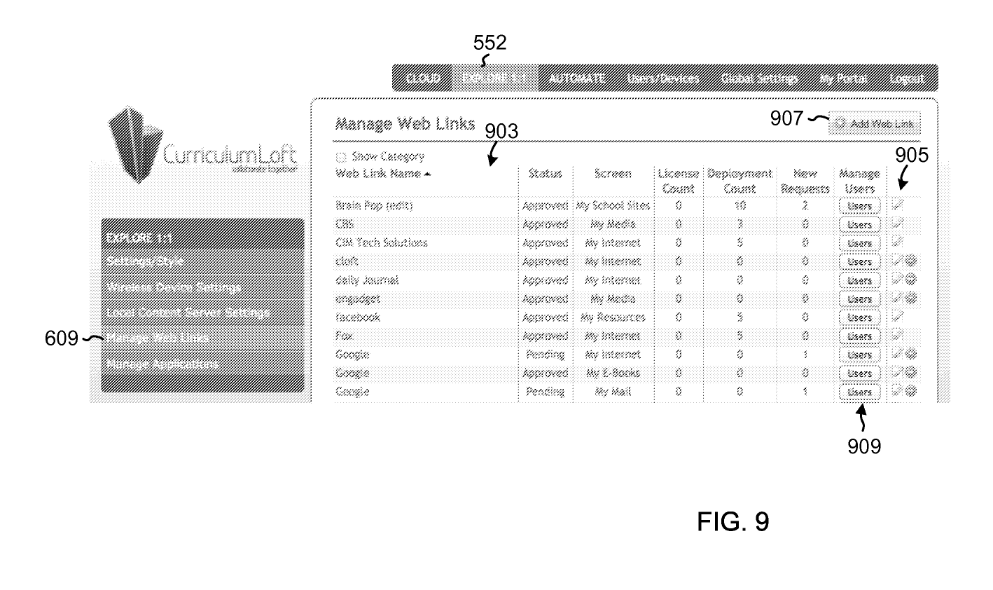

The application management module 117 may receive one or more requests for one or more applications, such as computer programs, or web links to be installed on one or more portable devices 127. The request may, in an embodiment, originate from an administrator of the portable device 127, such as a school administrator or teacher, for example. In an embodiment, the request may originate from the user of the portable device 127, such as a student, for example. The application management module 117 may, in an embodiment, maintain one or more databases and/or other file structures to track the portable devices 127 and the applications that are installed on the one or more portable devices 127. In one embodiment, the application management module 117, upon receiving a request for an application or web link for installation on a portable device 127, checks whether the requested application or web link is already installed on the portable device 127 based on tracking information in the database or on pinging the portable device 127 for a list of already loaded applications or web links. In an embodiment, the one or more databases and/or other file structures also maintain information regarding one or more applications. In an embodiment, the information may include, but is not limited to, the number of licenses that are available for each of the applications, the number of licenses that have been used to install applications on each of the portable devices 127, the number of licenses that remain unassigned, usage records for the licenses, or other information used to track and maintain applications across one or more portable devices 127. In an embodiment, the application management module 117 manages the installation and removal of applications and web links from portable devices 127. In an embodiment, the application management module 117 may push content onto a portable device 127 if, for example, a new application or web link is to be loaded on the portable device 127. In one embodiment, the new application is selected for loading on the portable device 127 based on a request received from the portable device 127, but the local content server 101 may provide the application to the portable device 127 without a request. In an embodiment, the application management module 117 may send commands to a portable device 127 to request or cause the portable device 127 to remove an application or web link. In an embodiment, a teacher or administrator, using the application management module 117, may request an application or web link for a particular group of students from the administrator system 103 or from the administrator of the local content server 101. The request may be granted or denied for the entire group of students, or may be granted or denied for one or more subsets of the group of students. In an embodiment, applications or web links may be assigned to particular groups of students, such as a particular class of students, or a particular grade level. If a student is assigned to the particular group of students, the application or web link may be pushed onto the students' portable device 127. If a student was assigned to the particular group of students, but is no longer assigned to the particular group of students, the application or web link may be deleted from the students' portable device 127. See, for example, the user interfaces illustrated in FIGS. 9-12 and described herein. In one embodiment, the application management module 117 works in conjunction with the explore module 119 to provide the described functionality.

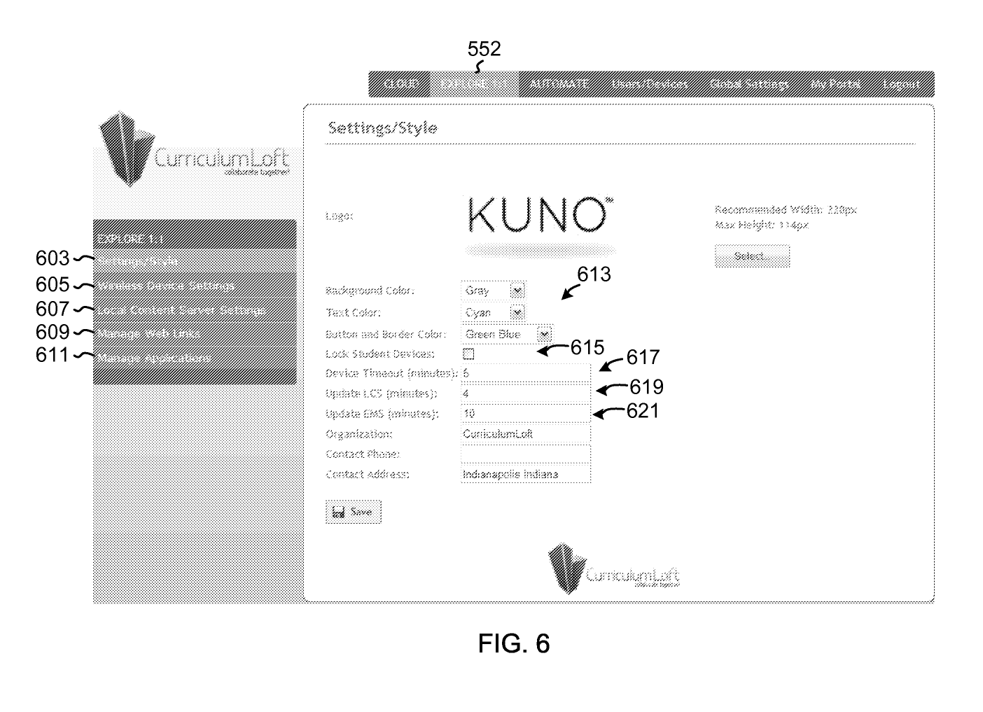

The explore module 119 may receive signals from the administration system 103 and/or the local content server 101 related to one or more administrative tasks. The explore module 119 executed at the local content server 101 (or administration system 103) and the portable devices 127 may transmit and receive signals between the portable devices 127 and the local content server 101 (or administration system 103) to accomplish the one or more administrative tasks. In an embodiment, the explore module 119 executed at the portable devices 127 may send application requests to the explore module 119 of the local content server 101, and the explore module 119 of the local content server 101 may transmit the application requests to the application management module 117. In an embodiment, the explore module 119 may push applications, or other data, to the one or more portable devices 127. In an embodiment, the explore module 119 may push other content to the one or more portable devices 127. In an embodiment, the explore module 119 may route content from the explore modules 119 executed at the one or more portable devices 127 to the local content server 101, the administration system 103, and/or one or more other systems. The explore module 119 is configured to automatically sync the portable device 127 with content stored on the cloud system and/or other storage accessed by the local content server 101. In one embodiment, the content sync is performed at regular intervals configured by the administrator. See, for example, the user interfaces illustrated in FIGS. 6-12 and other figures described herein. Similarly, the explore modules 119 of the portable devices 127 and the explore modules 119 of the administration system 103 may also communicate and sync content via network 311.

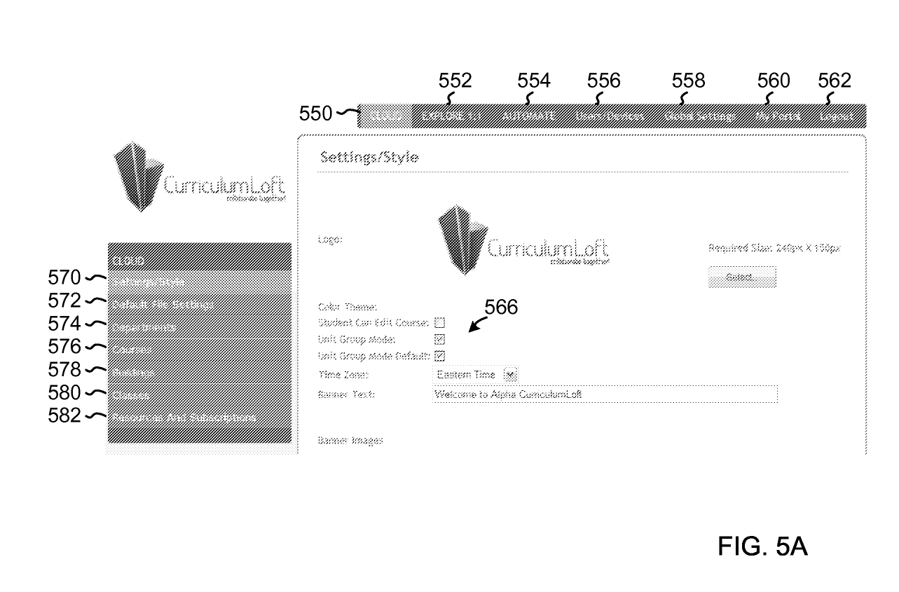

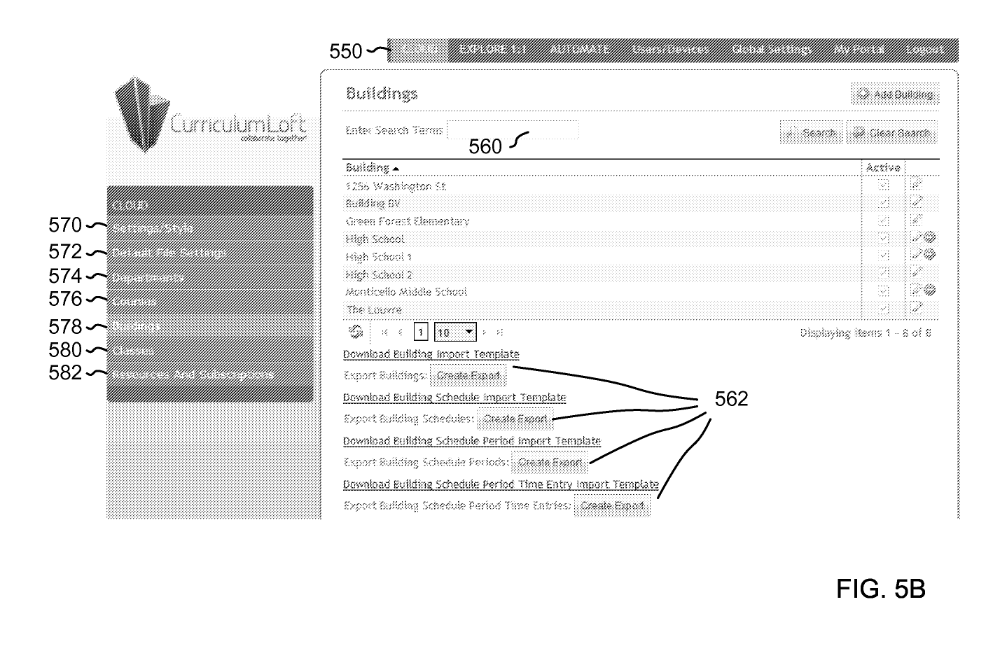

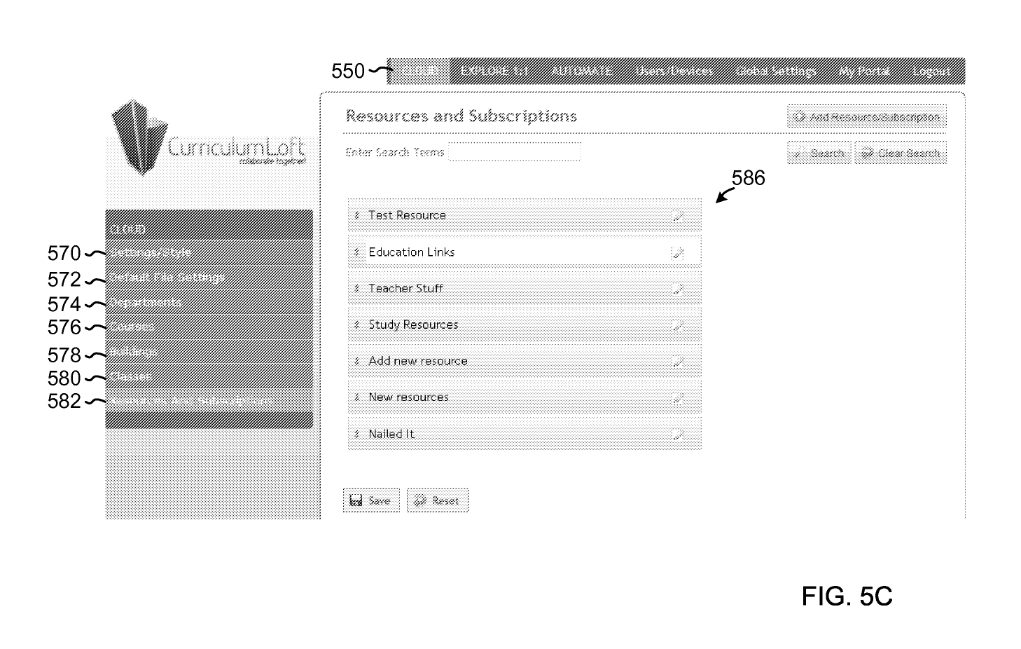

The cloud module 121, in the embodiment, may store and recall content generated by the teacher, students, or administrators. The cloud module 121 may include, or may be associated with, one or more databases to store and/or index the content, such as cloud storage 411, for example. In addition to the content, the one or more databases may include additional metadata describing the content. In an embodiment, the metadata may include, but is not limited to, a unique identification assigned to each piece of content, permissions and security data regarding each piece of content or groups of content, access information regarding pieces of content, or other information related to the storage and recall of the content. For example, the one or more databases associated with the cloud module 121 may include information on the number of accesses on a piece of content, the last access date of a particular piece of content, or other information. In an embodiment, the cloud module 121 may include cached content from one or more third parties. In an embodiment, the cloud module 121 is executed on a standalone computer system, with one or more processors and memory in communication with the one or more processors. In an embodiment, the cloud module 121 is executed at the administration system 103 and/or the local content server 101. In the embodiment, the one or more databases are stored in the memory. In another embodiment, the one or more databases are associated with a system that is separate from the cloud module 121, and the cloud module 121 and the system are in communication. In an embodiment, the communication may be over the one or more networks 311. The cloud module 121 of FIG. 3B may be in communication with the local content server 101 and/or the administration system 103, and may store content accessible by the local content server 101 or administration system 103, or other systems or modules associated with the local content server 101, including the live streaming module 115, the Explore module 119, the analyze module 123, the application management module 117, the connect module 125, the curriculum structures module 113, and/or other suitable modules. In an embodiment, the cloud module 121 stores content associated with the other modules associated with the local content server 101. In an embodiment, the cloud module 121 associated with a local content server 101 is accessible to other local content servers 101, the administration system 103, or other third-party systems. See, for example, the user interfaces illustrated in at least FIGS. 5A-5C and described herein.

In an embodiment, the cloud module 121 may be in communication with cloud modules associated with other local content servers 101, other administration systems 103, or other third parties. The communication may allow the cloud module 121 to receive content from, and/or transmit content to, the other local content servers 101, other administration systems 103, or other third parties. The receipt or transmission of content may allow users within a specific local content server 101 to communicate with other users outside of the specific local content server 101.

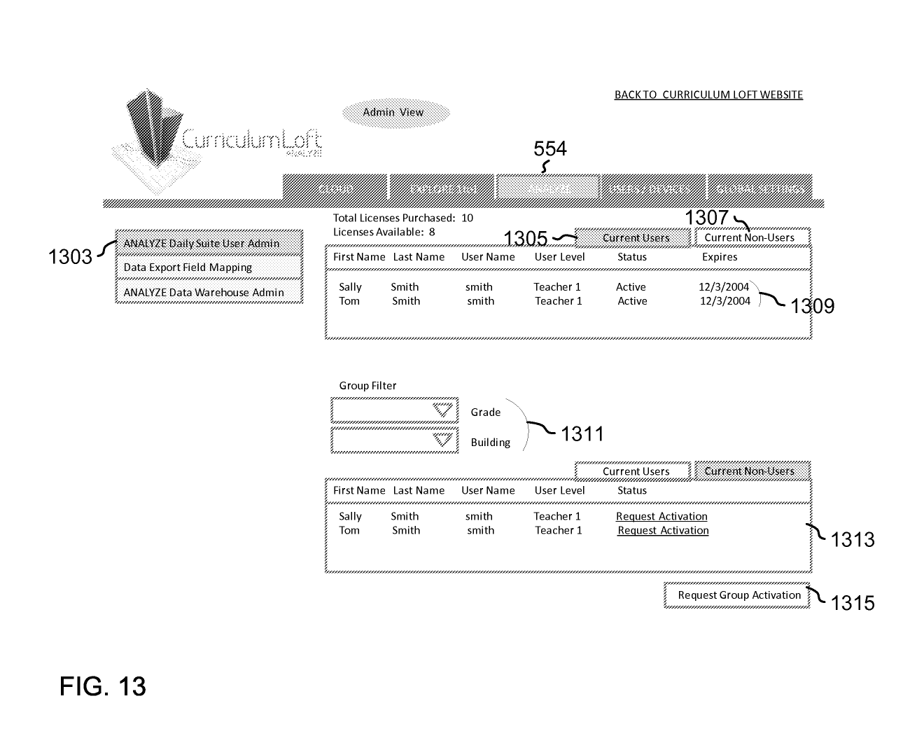

The analyze module 123 and automate module 141 may include interfaces for, in the illustrated embodiment described herein, teachers and students and administrators. See, for example, the user interfaces illustrated in at least FIGS. 13, 14, 27A-38, and 41-45 and described herein. While the automate module 141 is described herein, some functionality described may be executed by the analyze module 123, such as but not limited to, assignment grading. In the embodiment, the automate module 141 pushes assignments, or other curriculum content, to the portable devices 127. The curriculum content may be stored in the cloud system, at the local content server 101, or at another suitable storage location, and accessed via the automate module 141. The automate module 141 may push a particular assignment, or other piece of content, to an individual portable device 127, or a group of portable devices 127. For example, in an embodiment, if a group of portable devices 127 is assigned to a class, the automate module 141 may push assignments and/or other content to the entire class, a smaller group within the entire class, for example high achieving or remedial students, or may push assignments and/or other content to a particular student within the class. The automate module 141 may also receive completed assignments, or partially completed assignments, or other content from one or more of the portable devices 127. Based on the received assignments, the automate module 141 may generate one or more grade reports. If, for example, the assignment included one or more multiple-choice questions, the analyze module may have an answer key, may receive the completed multiple-choice questions from one or more of the portable devices 127, and may grade the completed multiple-choice questions against the answer key, to generate one or more grade reports. If, for example, the assignment included one or more free-form questions, the automate module 141 may receive answers to the one or more free-form questions from one or more of the portable devices 127, and may present the answers to a grader, or to the teacher. The teacher and/or grader may grade the free-form questions, and input the grades or other scores into the automate module 141. Based on the scores, the automate module 141 may generate one or more grade reports. In an embodiment, the grade reports may be individualized, to include the response to the question presented in the content, the correct answer, and points assigned to the particular response. In an embodiment, the grade reports may be shown with respect to the entire group. For example, an average score may be calculated from the responses received from the portable devices 127, or other statistical analyses may be performed on the answers received from the portable devices 127.

In an embodiment, the automate module 141 may push one or more pieces of content to a portable device 127 that may require or suggest an instant response. In the embodiment, the user of the portable device 127 may answer the question, and the answer may be transmitted by the portable device 127 to the automate module 141. The automate module 141 may present the answer to a teacher or administrator, or, based on an answer key, may grade the instant response. Based on the responses to the piece of content that requires or suggests an instant response, the automate module 141 may generate one or more grade reports.

In an embodiment, the automate module 141 also includes functionality to review content and/or grade reports at a higher level. For example, a school may review grade reports for a particular grade, if the grade includes one or more classes. Or, a district may review grade reports for a particular school, a particular grade level, or other division to measure achievement, progress, or other factors. In an embodiment, the automate module 141 may interact with one or more third-party systems, and transmitted data and/or content to the one or more third-party systems. For example, the automate module 141 may transmit grade information or other content to the one or more third-party systems, so that the one or more third-party systems may analyze grade reports and or additional content.

In an embodiment, the automate module 141 may allow content creators to use existing content, or create new content, to create one or more assignments. For example, and without limitation, the teacher may use one or more existing questions to create an assignment. The one or more existing questions may have been previously created by the teacher, or the teacher may use questions created by other teachers, or other content creators such as administrators or students. The automate module 141 provides one or more frameworks to allow a content creator to use existing content or create new content to create one or more assignments. For example, and without limitation, if the teacher wishes to create a multiple-choice question, one or more screens may allow the teacher to input the question, input the answers, and choose the correct answer. The automate module 141 may store the created content with the cloud module 121, and may recall content from the cloud module 121, from other third-party systems, from the local content server 101, from the administration system 103, or from other associated systems. In addition to assignments, the automate module 141 may also provide framework for content creators to create other content. For example, a teacher may create one or more presentations from the framework provided by the analysis module. In an embodiment, the automate module 141 also allows content creators to assign metadata to the created content. For example, and without limitation, the metadata may include one or more standards that the content is created to address. The metadata, including the standards information, may be transmitted to other third-party systems, or other modules, to provide for standards analysis.

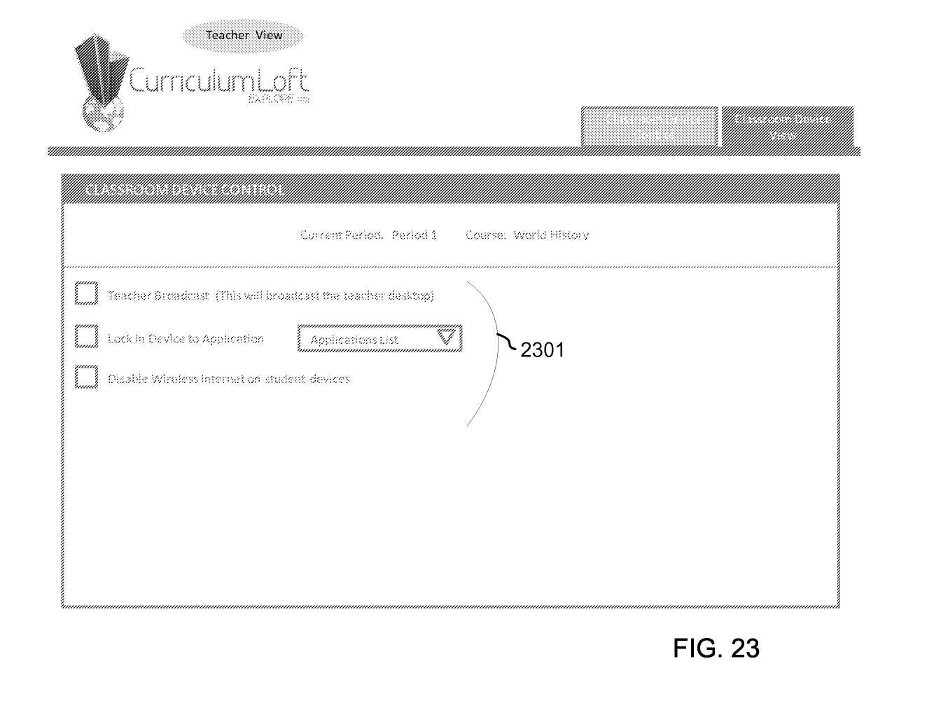

The connect module 125 may allow, in the embodiment, a teacher or other administrator to remotely view the content of one or more of the portable devices 127. In an example, a teacher may preside over a class of ten students, each with a portable device 127. The teacher may have a portable device 127 with access to the connect module 125, or may use another computer, such as a laptop, to access the connect module 125. While the students are in the classroom with the teacher, the teacher may use the connect module 125 to remotely view the displayed content of one or more of the portable devices 127. In an embodiment, the teacher may remotely view all of the portable devices 127 at the same time. The teacher may, in an embodiment, have the ability to remotely view one of the screens of the portable device 127, and may have the ability to project or display the screen of the particular portable device 127 in the class. In an embodiment, the teacher may take over the functionality of one or more of the portable devices 127, so that the teacher may manipulate objects, or perform tasks on the portable device 127 without user intervention. In an embodiment, the connect module 125 may record the screen of one or more of the portable devices 127. In the embodiment, the connect module 125 may transmit the screen information to the cloud module 121, or to another third-party system. See, for example, the user interfaces illustrated in at least FIGS. 23-26 and described herein.

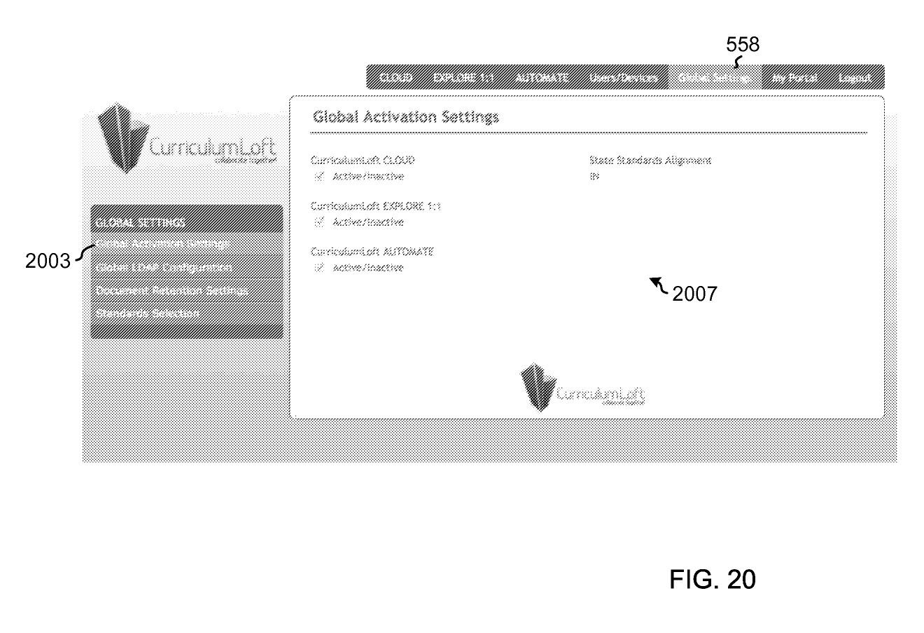

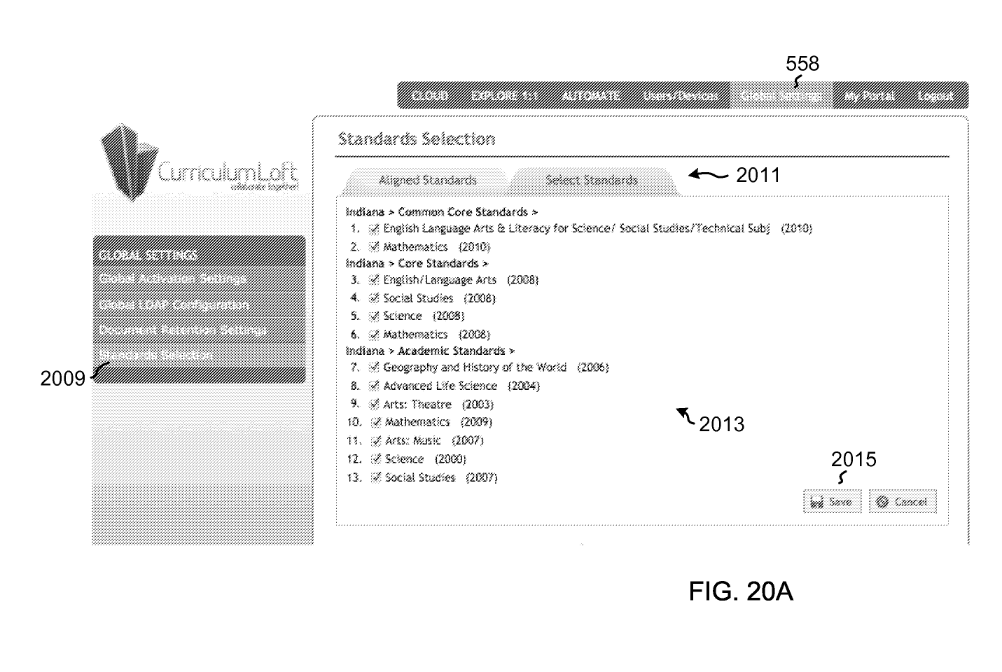

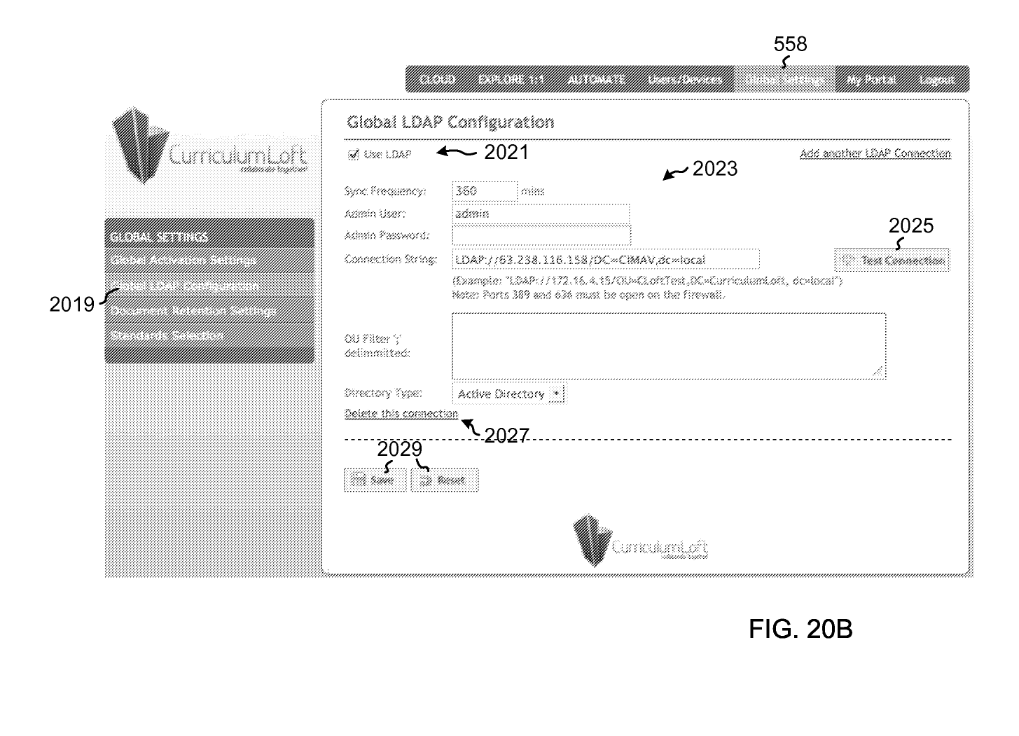

The curriculum structures module 113 may allow, in the example, a teacher and/or administrator to create a structured curriculum for one or more classes, one or more grade levels, or for a school. For example, and without limitation, an administrator may use the curriculum structures module 113 to create a new class. The new class may adhere to one or more standards, and have one or more requirements. The curriculum structures module 113 may allow the teacher, for example, to create structure for a class, including one or more lesson plans for the class, and adherence to one or more standards. In one embodiment, the curriculum structures module 113 works with the automate module 141 to perform the functionality described herein. See, for example, the user interfaces illustrated in at least FIGS. 20A, 27, 30, and 37A-37C and described herein.

The administration system 103, described with respect to FIGS. 2 and 3A, may be, for example and without limitation, an executing software module executing by logic, such as logic that includes one or more processors 157 and suitable memory 135, discrete logic, an ASIC or any suitable structure. The administration system 103 includes suitable communication interfaces, such as network adapter 409 as known in the art, and one or more input devices 405 (e.g., keyboard, mouse, touch screen, etc.) and output devices 401 (e.g., display, speakers, etc.), as known in the art. The administration system 103 may be in communication with the local content server 101 and/or one or more additional administration systems 103 via one or more networks 311. In an embodiment, the administration system 103 includes additional circuitry or other hardware to provide access to one or more networks, such as, for example, the Internet. In an embodiment, the administration system 103 includes one or more processors 403 that are operable to execute instructions, retrieve locations in the memory, and write locations to the memory 407. The processor 403 may access the memory 407 via one or more busses. In an embodiment, the memory 407 includes, but is not limited to, hard disk drives, flash memory, random-access memory, or other data storage and recall devices. The administration system 103 may also be associated with additional elements, such as an operating system, a display, and an input device 405. The input device 405 may be, for example and without limitation, a keyboard and/or touch screen. The administration system 103 may include more than one input device 405, or may be capable of input from one or more input devices 405. The administration system 103 includes one or more applications or functionality stored in memory 407 and executed by logic, such as the processor 403. The functionality may include, but is not limited to the modules illustrated in FIG. 2, including, for example, a framework module for digital content creation 105, a framework module for application and/or software creation 107, a software distribution module 109, a standards and data alignment module 111, and/or an application store module 139. The other modules of FIG. 2, although not shown in FIG. 3A, are also provided in memory 407 of administration system 103. Additional functionality may also be included. In an embodiment, the modules are executed as instructions residing in the memory 407 of the administration system 103. In another embodiment, one or more of the modules may be implemented separately from the administration system 103, such as, for example, on one or more separate computer systems that include processors and suitable memory 407, or any suitable structure, distinct from the administration system 103. One or more modules may be installed during the initial set up of the administration system 103, and one or more modules may be installed at a later date. For example, and without limitation, an administrator or other user may purchase one or more of the modules, and may install the one or more modules into the system. The administration system 103 may also be in communication with one or more storage devices 411 via the network 311. The storage devices 411 may be, for example and without limitation, associated with the administration system 103, or associated with one or more systems separate from the administration system 103, and accessible to the administration system 103 via one or more networks. In an embodiment, storage devices 411 may be a part of a cloud-based computing or storage solution.

In an embodiment, the modules associated with the administration system 103 described herein may be implemented as software or firmware programs stored on computer readable storage medium such as but not limited to CD-ROM, RAM, ROM, other forms of ROM, hard drives, distributed memory, etc., in combination with processors. As such, software programs may be stored computer readable storage medium. The computer readable storage medium stores instructions executable by one or more processors that causes the one or more processors to perform operations described herein.

The framework module for digital content creation 105 may include frameworks to create instructional materials, such as presentations and/or other materials for presentation in class, and frameworks for the creation of knowledge assessment, including, but not limited to, test questions and/or assignments. The framework module for digital content creation 105 may work with the automate module 141 to allow a content creator to easily create content for distribution to the portable devices 127. In an embodiment, the framework module for digital content creation 105 may include one or more help screens, one or more tutorials, or additional queries that allow a content creator to add content to an existing framework. As an example, a content creator could use an existing framework to quickly create one or more assignments, based on the content that the content creator provides to the framework. In this way, the content creator is free to create content in a structured environment that provides consistent results. In one embodiment, module 105 works in conjunction with the automate module 141 and/or framework module for application and/or software creation 107 to provide the functionality described herein.

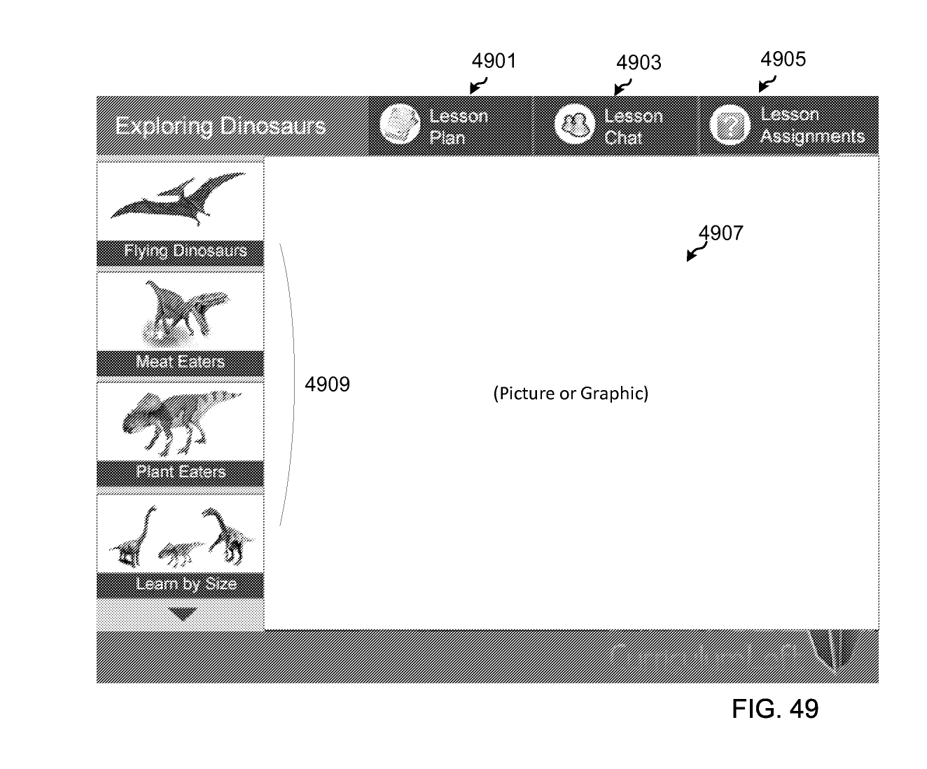

The framework module for application and/or software creation 107 may include software frameworks to create applications (“apps”) and/or additional software that operates on the portable devices 127. In an embodiment, the framework module for application and/or software creation 107 may include structures or engines that allow a content creator to add content and create an application from the added content. For example, and without limitation, the framework module for application and/or software creation 107 may include one or more forms, one or more tutorials, or one or more walk-through screens to help and/or guide a content creator, and to allow the content creator to input content into the framework, and create an application from the content. See, for example, the user interface illustrated in FIG. 49 and described herein as well as other figures described herein. In one embodiment, the module 107 works in conjunction with the automate module 141 and/or module 105 to provide the functionality described herein.

The software distribution module 109 may allow a centralized administration and/or purchasing of software, content, and/or applications for use with the portable devices 127. The software distribution module 109 may work with the application management module 117 to manage available licenses, appropriately route requests for new content, applications, or other software, and add or delete content, applications, or other software to or from the portable devices 127. In an embodiment, the software distribution module 109 may be in communication with one or more content, application, or other software distribution systems. The software distribution module 109 may request content, applications, or other software from the other distribution systems, and may receive content, applications, or other software from the other distribution systems.

The standards and data alignment module 111 may store standards information, or may access standards information from one or more third-party systems. Standards information, illustrated with block 112 of FIG. 2, may include, for example, information regarding requirements for a particular school grade, class, or other administrative division. In the illustrated embodiment, the administrator or teacher selects via module 111 the standards information that is applicable to the particular school grade, class, or assignment. For example, standards information may require certain topics to be covered in a particular class, may require test scores to be at or above a certain level in a particular class or in a particular grade, or may include other information regarding requirements for classes, schools, teachers, administrators, districts, or other divisions. The standards information may be broken out by subject. The standards information, or particular requirements within a number of standards, may be assigned a unique value or identifier by the standards and data alignment module 111. The unique value may be used by the automate module 141, the explore module 119, or other modules associated with the local content server 101, the administration system 103, or other third-party systems. Additionally, the unique identifiers or other information from the standards and data alignment module 111 may allow for third-party alignment, or may allow for alignment within content associated with the local content server 101. For example, and without limitation, module 111 associates specific pieces of content with one or more standards, or one or more requirements generated by one or more standards. Test questions, in the example, may be generated, and may be mapped to one or more of the standards. Answers to test questions provided by the portable devices 127 may be associated with one or more standards, to allow a teacher, administrator, or other party to view progress. The standards and data alignment module 111 may allow an administrator, third party, or other user to view assignments based on one or more standards, to determine if additional assignments should be created to fill standards requirements. For example, and without limitation, if all elements of a standard are not met by the current assignments in a particular school, the administrator, third party, or other user may create, or request the creation, of one or more assignments to address the deficiencies. Additionally, grade and test reporting may be tied to the standards and data alignment module 111, to allow administrators, third parties, or other users to see or understand strengths and weaknesses of a particular student, one or more classes, one or more grade levels, one or more schools, or one or more districts or other grouping of schools, teachers, and/or students for analysis. See, for example, the user interfaces illustrated in at least FIGS. 20A, 27, 30, and 37A-37C and described herein. In one embodiment, the standards and data alignment module 111 works in conjunction with the automate module 141 to provide the functionality described herein.

The application store module 139 provides a centralized interface for a user to request and/or purchase applications for use with the portable devices 127. The applications may include learning blocks/tools, games, or any other suitable applications. For example, an administrator, a teacher, or other user may access a web-based user interface provided by the application store module 139 to browse, download, upload, and/or sample one or more applications that are configured to run on the portable device 127. The application store module 139 may be accessed via the portable device 127 or via another computer, such as a laptop, using a web page, for example. In one embodiment, the application store module 139 stores the applications available for purchase or download in an application library at storage devices 411. The application store module 139 may also be in communication with one or more third party application distribution systems such that the application store module 139 can make applications from the other distribution systems available for purchase or download at the application store module 139. The application store module 139 allows users or third party publishers to upload or otherwise make available applications for download by other users via the application store module 139. In one embodiment, an application, such as a learning tool, may be created by a user via the framework module for application and/or software creation 107, and the application store module 139 makes the application available for purchase and/or download by other users. In one embodiment, the application store module 139 works with the application management module 117 to manage transactions (e.g., purchases, downloads, uploads, etc.), manage licenses if applicable, appropriately route requests for applications, and add or delete applications to the application library. In one embodiment, the licensing of the applications provided by users or third party publishers is managed by the user or third party publisher.

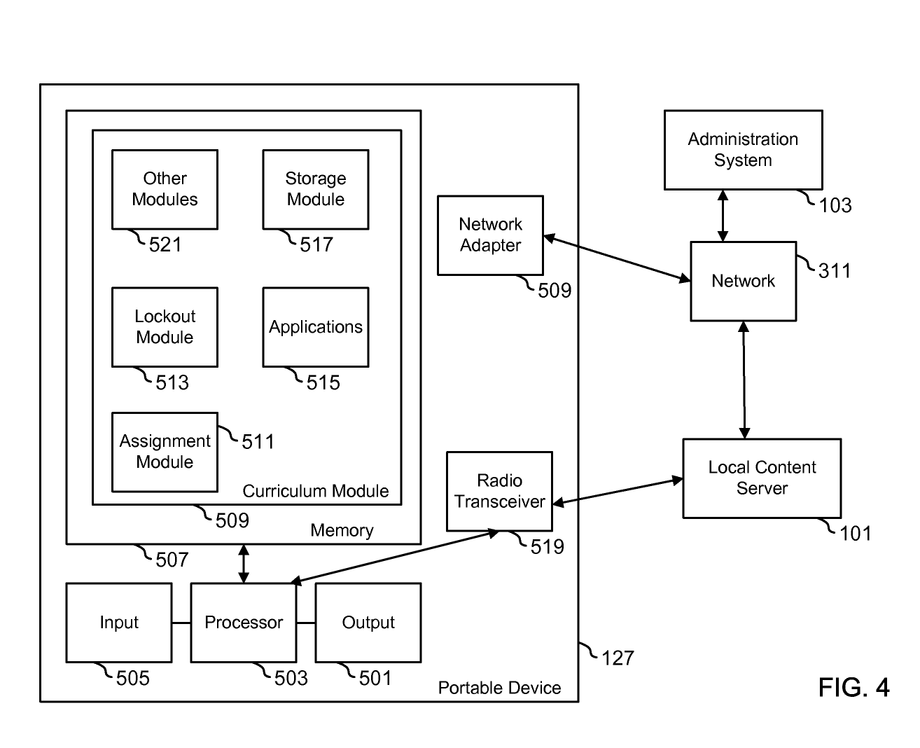

Illustrated in FIG. 4, the portable device 127, in an embodiment, is a computing system or device or other hardware that includes logic, such as logic that includes, but is not limited to, one or more processors 503, suitable memory 507, suitable communication interfaces as known in the art, and one or more input 505 and output devices 501, such as a display, as known in the art. In an embodiment, the portable device 127 includes, but is not limited to, a tablet computer, laptop computer, a netbook, a desktop computer, smart phone, or any other suitable computing device. In the illustrated embodiment, the portable device 127 includes one or more radio transceivers 519. The radio transceiver 519 enables communication between the portable device 127 and the local content server 101, the administration system 103, any of the modules associated with either the local content server 101 or the administration system 103, or other systems via one or more networks. In an embodiment, the portable device 127 radio transceiver 519 operates over a short range. In an embodiment, the short range is approximately one hundred meters or less. In an embodiment, the portable device 127 also includes a radio transceiver 519 that allows for longer range communication, in the embodiment, more than one hundred meters, such as over a 3G or 4G radio network, or other cellular network as known in the art. Either short range or long-range radio transceivers may be used, as appropriate, for the portable device 127 to communicate with the local content server 101, the administration system 103, other third-party systems, or any module associated with the local content server 101 and/or the administration system 103 via one or more networks. In an embodiment, the portable device 127 includes additional circuitry or other hardware, such as network adaptor 509, to provide access to one or more networks 311, such as, for example, the Internet, for accessing the administration system 103. In an embodiment, the portable device 127 includes one or more processors that are operable to execute instructions, retrieve locations in the memory 507, and write locations to the memory 507. The processor may access the memory 507 via one or more busses. In an embodiment, the memory 507 includes, but is not limited to, hard disk drives, flash memory 507, random-access memory 507, or other data storage and recall devices. The portable device 127 may also be associated with additional elements, such as an operating system, a display, and an input device 505. The input device 505 may be, for example and without limitation, a keyboard, a mouse, and/or touch screen. The portable device 127 may include more than one input device 505, or may be capable of input from one or more input devices 505. The portable device 127 includes one or more applications 515 and functionality stored in memory 507 and executed by logic, such as the processor. The functionality may include, but is not limited to, a curriculum module 509 that may execute a lockout module 513, an assignment module 511, one or more applications 515, and or a storage module 517. The portable device 127 is further operative to execute other modules 521 provided with administration system 103, such as, for example, the explore module 119, the cloud module 121, the automate module 141, the analyze module 123, the connect module 125, and the live streaming module 115 illustrated in FIG. 2 and described herein.

One or more modules or applications may be installed during the initial set up of the portable device 127 by an administrator or other user, and one or more modules may be installed at a later date upon request by the user. For example, and without limitation, a user of the portable device 127 may initiate a request via the portable device 127 for one or more of the modules or applications of the administration system 103. In the illustrated embodiment, the request is routed from the portable device 127 to the local content server 101 (or administration system 103), and the school administrator or a teacher approves or denies the request. Upon approval, the local content server 101 or administration system 103 may push the one or more requested modules or applications onto the portable device 127 via the radio transceiver 519 for installation by the portable device 127. In another embodiment, the administration system 103 pushes the requested modules to the portable device 127 via the network 311.

In one embodiment, the modules executed at the portable device 127 interact with the corresponding modules executed at the local content server 101 or administration system 103 to provide some of the functionalities described herein. As one example, the automate modules 141 of the local content server 101 and the portable device 127 may cooperate to implement the test taking or assignment administration functionality of the automate module 141. As described herein, some of the functionality of the modules stored at the portable device 127 may be locked out via lockout module 513. Other suitable interaction between modules of the local content server 101 and portable device 127 is provided to implement the module functionalities described herein. Similarly, interaction between the corresponding modules of the local content server 101 and the administration system 103 as well as the portable device 127 and the administration system 103 provides for the implementation of some of the functionalities described herein.

In the illustrated embodiment, the curriculum module 509 executes in memory 507 and provides one or more graphical user interfaces allowing the user of the portable device 127 to interface with the curriculum module 509, any other module, the local content server 101, and/or the administration system 103. The curriculum module 509 may include functionality, such as provided with the lockout module 513, that disallows or restricts a user of the portable device 127 from using applications 515, modules, or certain features of the applications 515 and modules that are not associated with the curriculum module 509. For example, and without limitation, the user may be restricted from operating one or more modules or software or non-education based functionality that is not associated with the curriculum module 509 such as, for example, a web browser, or other applications 515 that are not granted access by the curriculum module 509, the local content server 101, and/or the administration system 103.

The lockout module 513 selectively restricts functionality available to the user. For example, and without limitation, a lockout module 513 may prevent the user from accessing non-approved content on the Internet or other network, may prevent the user from accessing one or more applications 515 associated with the portable device 127, either associated with the curriculum module 509 or not associated with the curriculum module 509, or may prevent the user from accessing other programs or modules installed on the portable device 127. The lockout module 513 may receive commands from the local content server 101, the administration system 103, or other portable devices 127 to selectively allow or disallow any functionality associated with the portable device 127. For example, and without limitation, the teacher may restrict functionality on a portable device 127 during an examination, during a certain time when a class is in session, during all times that the student is in possession of the device 127, or for other purposes. If the teacher restricts functionality during an examination, certain aspects of the curriculum module 509 may be displayed, but other aspects may not be displayed, or may be otherwise restricted. For example, during an examination, the teacher may restrict functionality to only the examination that is currently taken, disallowing the student from accessing the Internet, from accessing notes or other materials stored either on the portable device 127 or outside of the portable device 127, or from performing other tasks with the portable device 127.

The assignment module 511 may receive content from the automate module 141 associated with the local content server 101, from one or more modules associated with the administration system 103, or from other third-party systems. The assignment module 511 may display the content to the user, and may allow the user to add content to the existing content. For example, and without limitation, a student may complete an assignment pushed from the automate module 141, and the assignment module 511 may transmit the answers, or other content, to the local content server 101. In one embodiment, the assignment module 511 is a part of the automate module 141 and analyze module 123 described herein.

Applications 515 may include, but are not limited to, software or other instructions executing in memory 507 by the one or more processors associated with the portable device 127. Applications 515 may access content, or send communication to or receive communication from, the local content server 101, the administration system 103, or other third-party systems. Applications 515, in an embodiment, are managed by local content server 101, one or more modules associated with the local content server 101, the administration system 103, or one or more modules associated with the administration system 103. For example, the local content server 101 may manage permissions and access to the applications 515 that are made available on the portable device 127, as described herein. In one embodiment, applications 515 are purchased and/or downloaded from the application store module 139 described herein.

The storage module 517 may interface with memory 507 and/or additional storage associated with the portable device 127, with the cloud module 121 associated with the local content system, with another storage system accessible via one or more networks, or other systems. The storage module 517 may cooperate with the cloud module 121 and/or explore module 119 to synchronize content between the portable device 127 and the local content server 101, the administration system 103, modules associated with the local content server 101 and/or the administration system 103, and/or other third-party systems. In an embodiment, the user may erase one or more pieces of content in storage associated with the portable device 127, and the local content server 101, the administration system 103, one or more modules associated with the local content server 101 and/or the administration system 103, or other third-party systems may resynchronize content, and may push additional content to the storage associated with the portable device 127.

In an embodiment, the curriculum module 509, including the assignment module 511, the lockout module 513, applications 515, other modules 521, and the storage module 517 described herein, may be implemented as software programs stored on computer readable storage medium such as but not limited to CD-ROM, RAM, ROM, other forms of ROM, hard drives, distributed memory, etc., in combination with processors. As such, software programs may be stored computer readable storage medium. The computer readable storage medium stores instructions executable by one or more processors that causes the one or more processors to perform operations described herein.

In FIGS. 5-49, exemplary graphical user interfaces and screenshots of aspects of the local content server 101, the administration system 103, other modules, and the portable device 127 are shown. The graphical user interfaces and screenshots indicate one or more graphical user interfaces that may be implemented by the administration system 103, the local content server 101, any of the modules associated with the administration system 103 and/or the local content server 101, and/or the portable device 127. In an embodiment, the graphical user interfaces reside in memory, and are executed by one or more processors. In an embodiment, the graphical user interfaces are stored on computer readable storage media. The graphical user interfaces include data representing one or more modules of the administration system 103, the local content server 101, and the portable devices 127. Some of the data is selectable and/or modifiable by the user, and some of the data allows a user to select or enter user input to the corresponding module. The graphical user interfaces in FIGS. 5-49 are presented as exemplary. The graphical user interfaces shown in FIGS. 5-49 may be split into separate graphical user interfaces, one or more of the graphical user interfaces may be combined, or the graphical user interfaces may be modified to change, for example and without limitation, placement, size, shape, or function of the elements described with respect to the graphical user interface. Additionally, the graphical user interfaces in FIGS. 5-49 are directed to administrator, teacher, and student roles in a classroom or school setting. Other embodiments of the disclosure may include additional uses for the disclosure, and the examples shown are not intended to be limiting to administrator, teacher, and student roles.

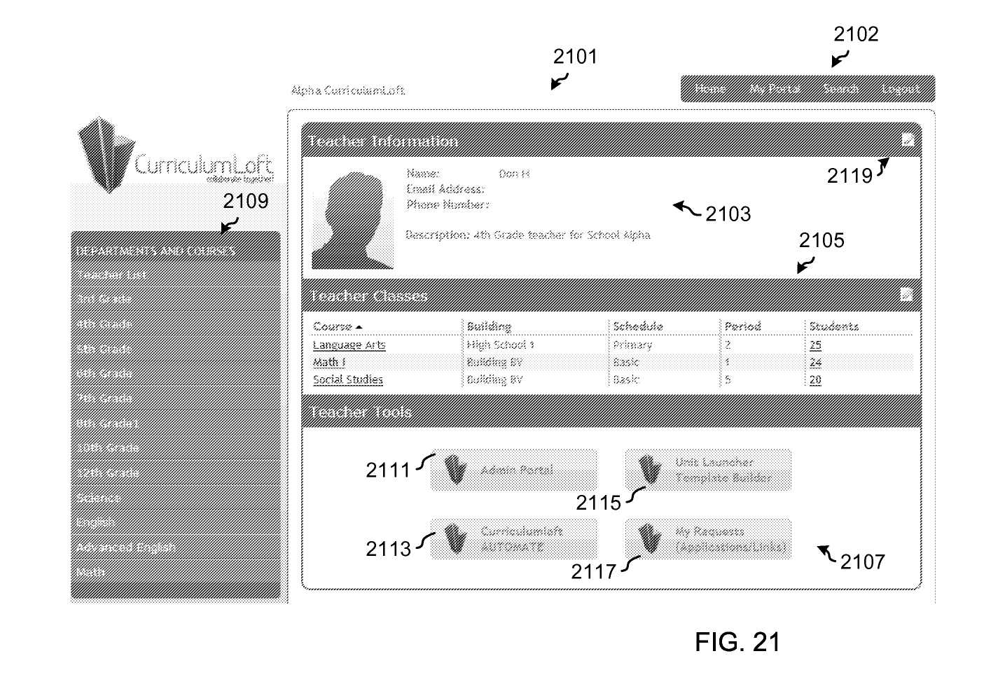

In the illustrated embodiment, the graphical user interfaces of FIGS. 5A-22 are accessible by an administrator of the local content server 101. For example, the administrator has access privileges to the various modules executed at the local content server 101 as well as one or more modules executed at the administration system 103. In one embodiment, the administrator accesses the graphical user interfaces of FIGS. 5A-22 via an administrator portal that requires a privileged login, such as the selectable administrator portal 2111 illustrated in FIG. 21. In one embodiment, teachers without administrator privileges and students are unable to access and/or modify some or all of the content and functionality described with respect to FIGS. 5A-22. In the illustrated embodiment, the graphical user interfaces of FIGS. 5A-22 relate to system set-up information and configuration, application approval and management, assignment/test/quiz administration and analysis, user and device management, global settings, and other settings and information.

FIG. 5A is an exemplary graphical user interface illustrating a cloud system setup screen according to an embodiment of the present disclosure. The graphical user interface of FIG. 5A includes a plurality of selectable tabs, including a cloud tab 550, an explore tab 552, an automate tab 554, a users/devices tab 556, a global settings tab 558, my portal tab 560, and a logout tab 562. Selection of the tabs by the user allows access to the various functionalities of the local content server 101 and administration system 103 and provides additional selectable data, as described in the following figures. The cloud tab 550 is selected in FIGS. 5A-5C, thereby allowing a user to configure settings related to the cloud module 121 of FIG. 2 and to content stored on the cloud (e.g., storage 411 of FIG. 3A or other suitable cloud storage). Settings may include, for example and without limitation, general cloud settings and styles accessed via input 570, enabling/disabling default file settings via input 572, department setup accessed via input 574, course setup accessed via input 576, building setup accessed via input 578, class setup accessed via input 580, and resource and subscriptions accessed via input 582. With input 570 illustratively selected in FIG. 5A, general settings may be configured via inputs 566 including, for example, setting the time zone, selecting the banner text that is presented on a home display page of the system, selecting the screen resolution, user interface color theme selections, and enabling/disabling a student's ability to edit course information. In one embodiment, student view and access settings may be configured via default settings input 572. For example, when a collaboration mode is selected, all students can see all documents for a course or associated with a department or building. Deselecting collaboration mode causes students to see only documents associated with their classes or teachers. Inputs may be selected to enable or disable a student's ability to see and access documents on the cloud storage and to enable or disable a student's ability to receive documents and files that are pushed to the portable device 127 from the cloud.

FIG. 5B is an exemplary graphical user interface, selected via input 578 of the cloud tab 550, showing a building set up screen according to an embodiment of the present disclosure. In FIG. 5B, profiles for one or more buildings, such as school buildings and campuses, may be created and/or modified. The profiles may include, for example, a name and address as well as class schedules associated with the building. Building profiles may be searched 560 using one or more criteria, such as, for example and without limitation, building name or other unique identifiers. Schedules for buildings and classes within buildings may be specified or may be imported/exported from an electronic file via selectable inputs 562.

Similarly, the selection of input 574 causes cloud module 121 to present a graphical user interface similar to FIG. 5B that allows a user to create and/or modify profiles for departments, such as grade level and course subject (e.g., science, math, literature, etc.). The profiles may include information and data related to, for example, a department name and associated classes/courses. The departments may be displayed in a list or table and may be selectable for editing. Similarly, selection of input 576 causes cloud module 121 to present a graphical user interface similar to FIG. 5B that allows a user to create and/or modify profiles for courses (e.g., freshman algebra, advanced English, etc.). The course profiles may include information and data related to, for example, a course name, alias, description, associated department, whether the course is active, etc. The courses may be displayed in a list or table and may be selectable for editing. Similarly, selection of input 580 causes cloud module 121 to present a graphical user interface similar to FIG. 5B that allows a user to create and/or modify profiles for classes available for each course. The class profiles may include information and data related to, for example, a class name, associated department and course, building, period, teacher, number of students, course identifier, the students enrolled or pending enrollment, etc. The classes may be displayed in a list or table and may be selectable for editing.

In one embodiment, all data associated with a class, a course, a schedule, a building, or a department stored with the cloud module 121 may be exported or imported via inputs 562 of FIG. 5B or via other inputs provided by the cloud module 121. For example, the data may be exported to storage 411 of FIG. 3A or another storage location, and other users may import the exported data into the system or into another content management system. For example, class lists and schedules, assignment data, aligned standards information, and other data may be copied between teachers, building, departments, etc.

FIG. 5C is an exemplary graphical user interface, selected via input 582 of the cloud tab 550, showing a resources and subscriptions screen according to an embodiment of the present disclosure. A user may create and/or modify categorical names for storing resources and subscriptions via the cloud module 121, i.e., the specified categories create buckets for later storing various resources, links, and subscriptions added by teachers, students, and other users.

The explore tab 552 is selected in FIGS. 6-12, thereby allowing a user to configure settings related to the functionality of the explore module 121 of FIG. 2. In particular, the explore tab 552 allows a user to set up the portable devices 127. As described herein, the explore module 119 is configured to be executed on the portable device 127 as well as the local content server 101 and the administration system 103. The explore module 119 is executed on the portable device 127 to manage the various functionalities on the portable device 127 provided with the modules. In one embodiment, an administrator configures settings and manages the explore module 121 via the user interfaces of FIGS. 6-12, and the explore modules 121 on the portable devices 127 operate according to the settings. Settings of the explore module 121 that are configured via the explore tab 552 may include, for example and without limitation, general settings and style of the graphical user interfaces of portable device 127 (accessed via input 603), wireless settings of the portable device 127 accessed via input 605, settings of the local content server 101 accessed via input 607, web link management settings accessed via input 609, and application management settings accessed via input 611.

FIG. 6 illustrates an exemplary graphical user interface of a portable device setup screen according to an embodiment of the present disclosure. With input 603 illustratively selected in FIG. 6, general explore module settings may be configured including, for example, the display style, color, and logo of graphical user interfaces provided on the portable device 127 (selected with drop down menus 613) and selecting the portable device screen resolution. In addition, the portable devices 127 that are logged in to the local content server 101 may be locked to certain functionality with selectable input 615 (and unlocked upon de-selecting input 615). In particular, the portable devices 127 are locked such that the portable devices 127 only see and execute the curriculum software and/or only perform curriculum-based functions specified by the administrator. As such, the portable devices 127 are locked out from executing third-party applications or software. In one embodiment, the portable devices 127 may also be locked via the administration system 103. In one embodiment, the portable devices 127 remain locked after the devices 127 log out of the server 101. Further, a device timeout is set via field 617 to specify the idle time before portable devices 127 logout of the local content server 101.

The explore module 119 is operative to sync curriculum content stored on the cloud (e.g., storage 411 of FIG. 3A), at the local content server 101, or other suitable storage location to the portable devices 127 in an automated fashion, such as at regular polling intervals set by the administrator. Polling intervals may include, but are not limited to, times when devices 127 update from the local content server 101 (field 619), and/or times when devices 127 are updated from one or more other systems, including, but not limited to, a management system (field 621). In the illustrated embodiment, the local content server 101 pushes updated content from the cloud to the portable devices 127 at the polling interval specified with field 619, and the portable devices 127 are updated with another content management system at a polling interval specified via field 621 upon the local content server 101 not being located by the portable device 127. In one embodiment, the content sync includes the portable devices 127 providing updated content, such as completed assignments or tests/quizzes or other question responses, for example, to the local content server 101 and/or cloud at the polling intervals. In one embodiment, the content from the portable devices 127 routed to the local content server 101 is stored in the cloud by the local content server 101. In one embodiment, the content sync also automatically occurs upon the portable device 127 being detected on the local area network (LAN) 102. In one embodiment, the portable device 127 sends a request for updated content to the local content server 101 and/or cloud at the polling intervals or upon being detected on the LAN 102, and the local content server 101 pushes the updated content to the device 127 and receives updated content from the device 127 upon receiving each request.

Wireless network settings may be configured via input 605 of FIG. 6. Exemplary wireless settings include adding a wireless network, configuring the wireless identification settings, and configuring wireless passkey settings.

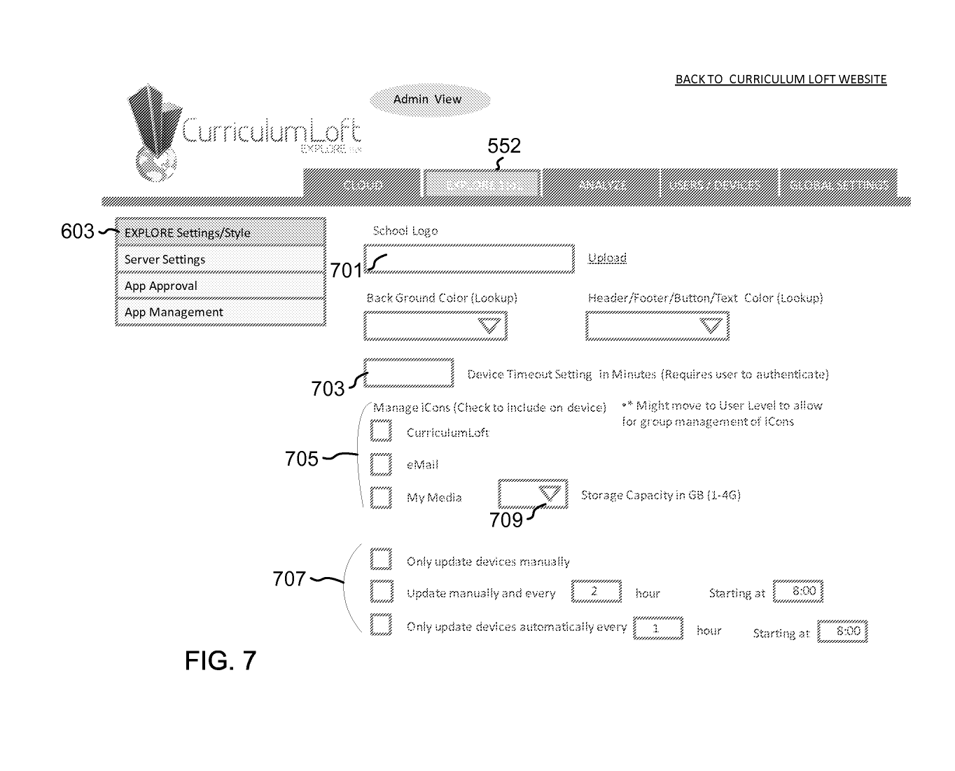

FIG. 7 illustrates another exemplary graphical user interface of a portable device setup screen according to an embodiment of the present disclosure. FIG. 7 shows an alternative to the graphical user interface of FIG. 6. The alternate view of FIG. 7 may allow a user to change settings associated with the explore module 119, and settings may include, but are not limited to, the school logo shown in element 701, background color, header color, device timeout settings shown in element 703, and icon settings, such as enabling/disabling the display of e-mail and/or other application icons shown with inputs 705. Settings may also include, but are not limited to, device update settings 707. Device update settings 707 may include, but are not limited to, an option to update portable devices 127 manually and an option to update devices 127 manually and at specific intervals, such as, for example, every two hours. Similar to FIG. 6, the devices 127 may be updated automatically at specified polling intervals. Devices may also be updated beginning at starting times. Additional device settings include storage capacity settings set with input 709. In particular, an amount of memory of the portable device 127 may be allocated for personal use, such as for storing music, photos, or other personal content.

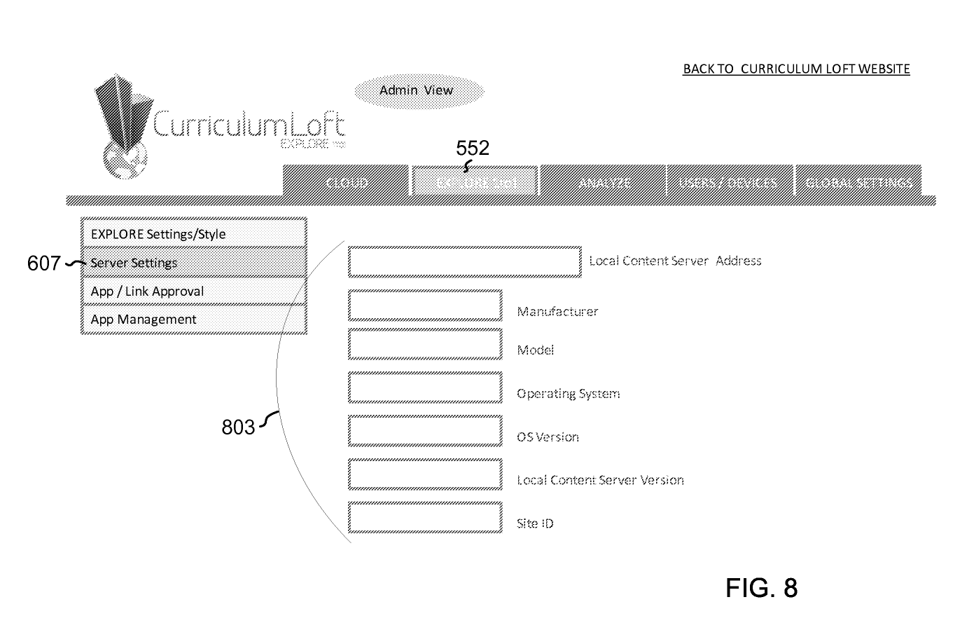

FIG. 8 illustrates an exemplary graphical user interface of a portable device setup screen according to an embodiment of the present disclosure. With input 607 illustratively selected in FIG. 8, the local content server information 803 may be viewed and/or configured. Server information 803 may include, but are not limited to, the local content server 101 address, manufacturer information, model information, operating system information, operating system version information, local content server 101 version information, and site ID information. The information may be polled from one or more of the administration system 103, local content server 101, or other computer systems associated with the system. Information may also be input by one or more users. In one embodiment, a system code is also provided as a local content server 101 identifier that is included with fault codes sent to the administration system 103 for analysis.

The explore module 119 is further configured to manage web links and applications that will be pushed to the portable devices 127 by the local content server 101. Web links are managed via input 609 of FIG. 6 and applications are managed via input 611 of FIG. 6. While the following description of FIGS. 9-12 is described with respect to web link management, the description also applies to the application management of input 611, which includes the same functionality and similar graphical user interfaces as the web link management screens described herein. FIG. 9 is an exemplary graphical user interface showing web link management according to an embodiment of the present disclosure accessed via input 609. In the embodiment, a list 903 of web links that have been created are displayed. The web links of list 903 may be created based on requests from students or teacher devices. The web links are either currently deployed or may be deployed to devices 127 in the future. Information regarding each web link is also shown in the list 903 such as, for example and without limitation, the name, the status of whether the web link is approved or pending, the display screen of the portable device 127 where the web link will be accessible, the license cost, the license count, the deployment count, the pending new requests for the web link from portable devices 127, the expiration of the license, if known or applicable, and a screen to add or delete users that have access to the web link. In an embodiment, additional information may be provided for web link or application requests regarding the cost of the application or web link.

In the illustrated embodiment, the user may also modify or delete web links using a corresponding button or link 905. In one embodiment, web links that do not have users, or that are not associated with users, may be deleted. The graphical user interface and/or the explore module 119 may not allow the deletion of applications and/or web links that are currently associated with one or more devices. In an embodiment, permanently deleting an application and/or a web link may automatically remove the application and/or web link from all devices on which it is installed.

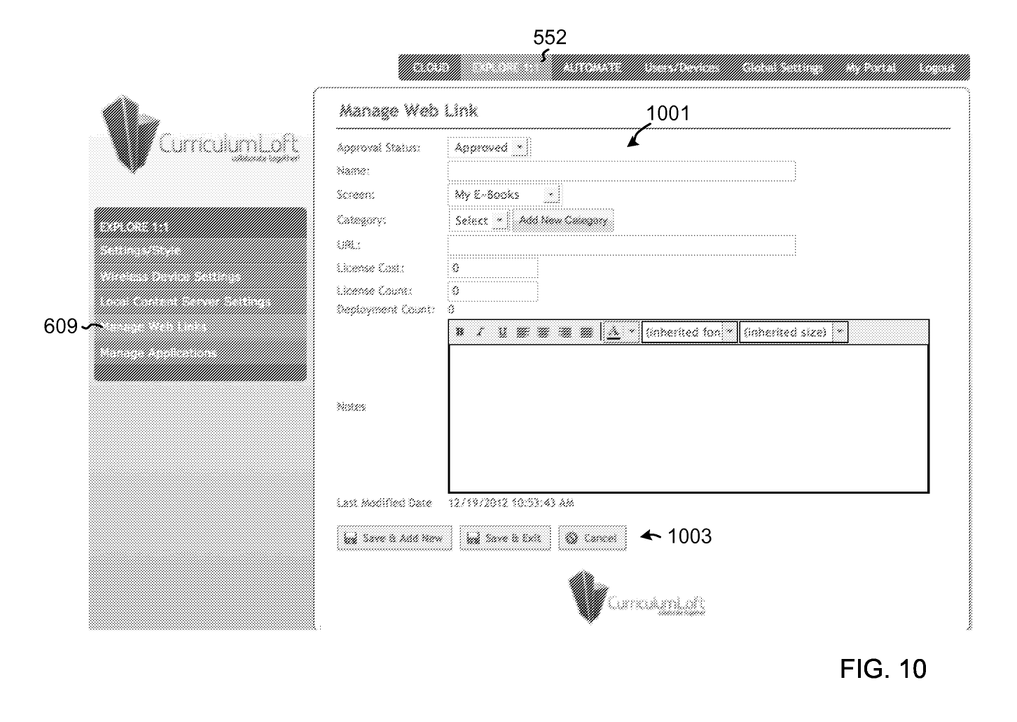

A user may also create a new web link via input button 907. Upon selecting the add web link button 907 of FIG. 9, the graphical user interface of FIG. 10 is displayed that allows the user to create the new web link to be added to list 903 of FIG. 9. In FIG. 10, inputs and fillable fields 1001 are provided to allow the user to create the web link, including the approval status, the web link name, the screen of the portable device 127 that the web link will appear, the web link category, the URL of the web link, the license cost and count (if applicable), and the number of web links already deployed to devices. The web link is saved and added/modified via inputs 1003. In one embodiment, the administrator or teacher creates the web links based on one or more requests from other users.

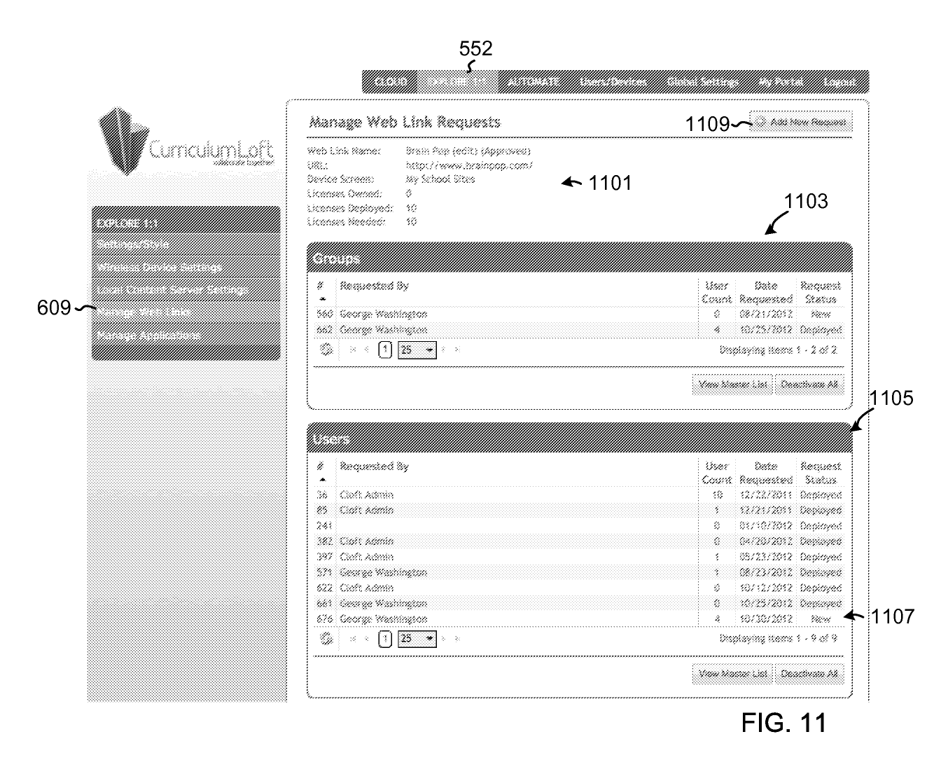

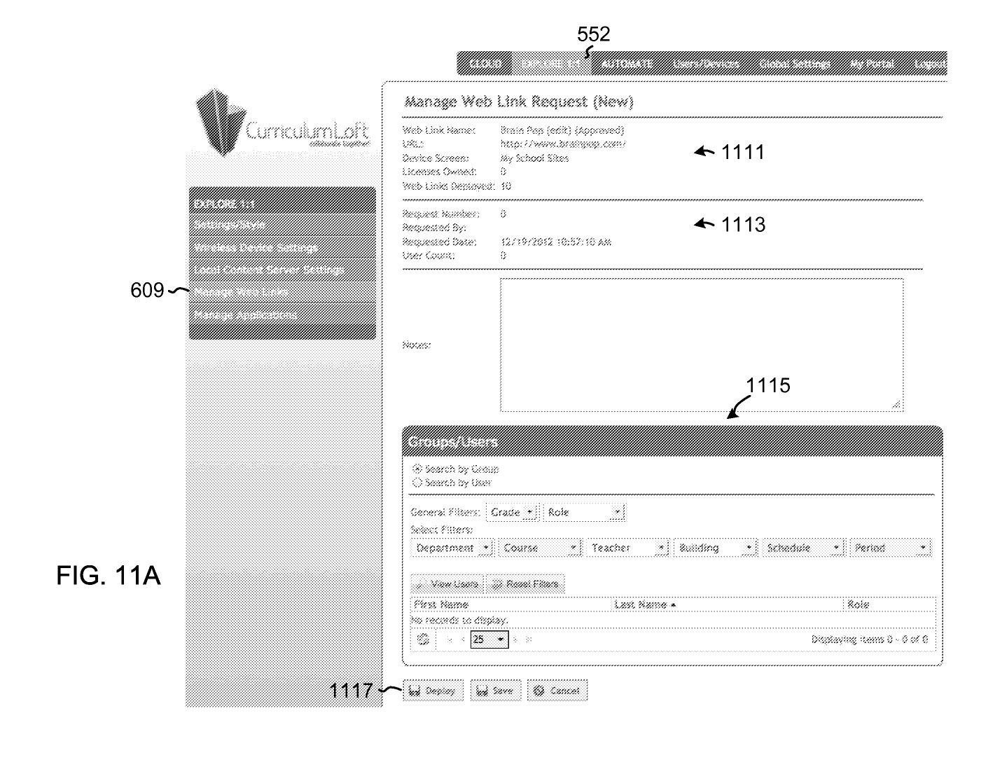

Upon selection of the “users” button 909 of a corresponding web link of FIG. 9, the graphical user interface of FIG. 11 is displayed that allows for the management of requesting users of the corresponding web link. Information 1101 related to the selected web link is displayed. FIG. 11 shows the current users of the web link as well as pending user requests for the web link. Group requests (multiple users) are listed in table 1103, and individual requests are listed in table 1105. Each table 1103, 1105 shows the request number, the user or group making the request, the current user count of the web link, the request date, and the status of the request (new, deployed, denied, etc.). A new request for the selected web link may be created by a user by selecting input 1101 of FIG. 11, which cause the graphical user interface of FIG. 11A to display. Referring to FIG. 11A, the web link information 1111 and current request and user count information 1113 is illustrated. In the embodiment, the requester may filter for users that will receive the requested web link upon approval in filter section 1115. The filter may be by group/user, grade, department, course, teacher, building, schedule, class, period, or other traits area, shown in filter section 1115. Based on the results of the filter, one or more users may be shown, along with associated information. The associated information may include but is not limited to, name of the user, the user's device ID, and the user status or role. Upon selection of one or more user from the filtered results, the request may be saved to the table of FIG. 11 and/or deployed via the inputs 1117. In one embodiment, a teacher or other user creates the web link request in FIG. 11A and deploys the request to the administrator for approval.

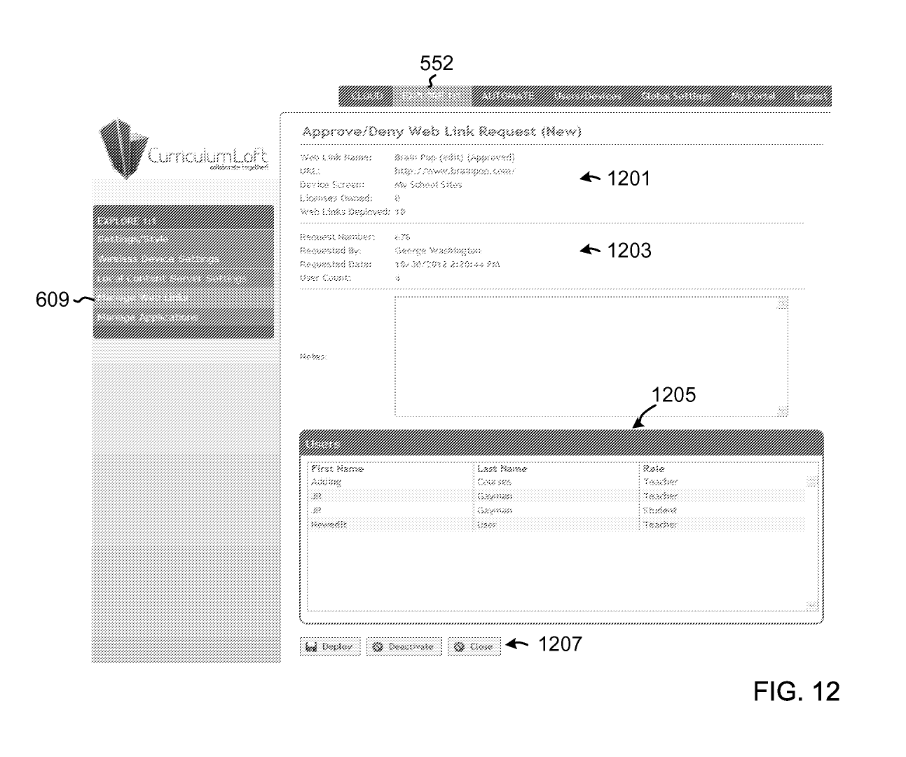

The web links may be deployed (pushed) to the requesting user devices via the explore module 119. Referring to FIG. 11, a pending web link request is selected, such as pending request 1107 of FIG. 11, and a new screen is displayed in FIG. 12 that allows the administrator or other user to review the request and approve or deny deployment of the web link. Referring to FIG. 12, web link information 1201 is displayed as well as information 1203 related to the requester, including the requester's name, the request date, and the number of users in the request. The users in the request are listed in table 1205. Upon review, the administrator or other user with deployment privileges is provided with several inputs 1207 to either approve and deploy the web link to one or more of the listed users, to deny and deactivate the request, or to cancel and exit without approval or denial.

Upon the web link or application being approved and deployed, the web link or application is pushed to the portable devices 127 of the requesting users. In an embodiment, the explore module 119 disallows web links and/or applications to be deployed, if the deployment would exceed the number of available licenses. In another embodiment, the explore module 119 allows a user to exceed the number of available licenses. In an embodiment, the explore module 119 may automatically purchase additional licenses if the deployment account exceeds the available license count, or may prompt the user or administrator to purchase additional licenses.

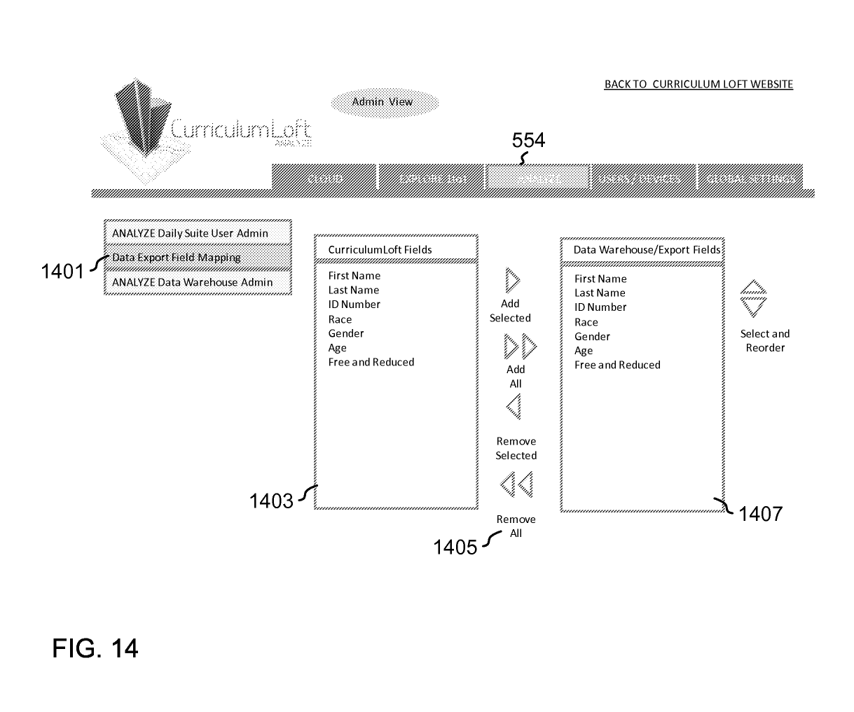

The automate (analyze) tab 554 is selected in FIGS. 13 and 14, thereby allowing a user to configure settings related to the functionality of the automate and analyze modules 141, 123 of FIG. 2. FIG. 13 is an exemplary graphical user interface showing application management 1303 according to an embodiment of the present disclosure. FIG. 13 shows an exemplary version of group activation of applications and/or web links. Total licenses purchased, and licenses available, may be displayed. The user may be able to filter users and/or devices 127 based on devices 127 where the application and/or web link is currently installed with tab 1305, or is currently not installed with tab 1307. Entries 1309 for current users, or current nonusers, may include, but are not limited to, first name, last name, username, user level, status, and expiration date. In an embodiment, devices 127 may be filtered via fields 1311 by grade and/or building, which are displayed in window 1313. In the embodiment, for example and without limitation, teachers have requested activation of one or more applications and/or web links. A user may request application and/or web link activation using button or link 1315.

FIG. 14 is an exemplary graphical user interface showing data export field mapping 1401 according to an embodiment of the present disclosure. In FIG. 14, data may be imported and/or exported through the automate module 141. In the embodiment, one or more fields 1403 associated with the local content server 101 and/or the administration system 103 may be exported to a data warehouse represented with 1407. The data warehouse may include, but is not limited to, third-party systems, or other computer system to receive data and process the data. The fields 1403 associated with the local content server 101 and/or the administration system 103 may be added or removed, or reordered, according to the requirements of the data warehouse. Selection tools 1405 may be supplied to change the order and/or amount of data supplied from the local content server 101 and/or the administration system 103 to the data warehouse. In another embodiment, the functionality provided via user interfaces of FIGS. 13 and 14 is provided with the explore tab 552 of FIGS. 6-12.

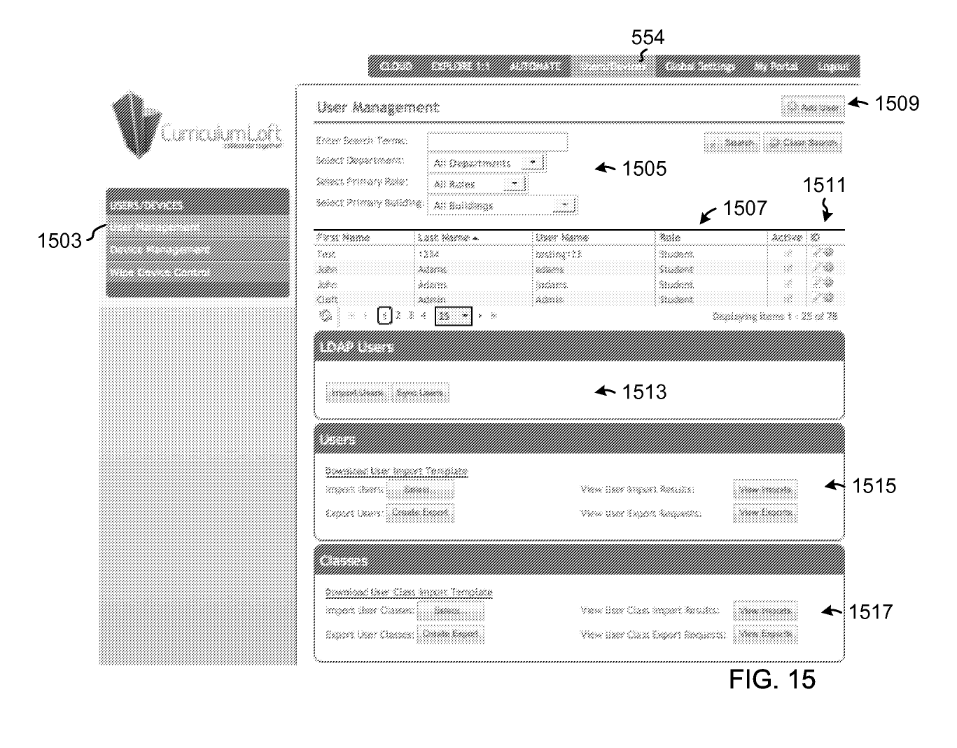

The users/devices tab 556 is selected in FIGS. 15-19, thereby allowing a user to configure settings related to users and devices 127. In one embodiment, the functions provided with the tab 556 are implemented with the explore module 119 and/or cloud module 121. FIG. 15 is an exemplary graphical user interface showing user management 1503 at the administration system 103 or local content server 101 according to an embodiment of the present disclosure. In FIG. 15, users associated with the local content server 101 and/or the administration system 103 may be managed. Management of users may include, but is not limited to, adding new users, deleting users, changing the status of one or more of the users, changing security permissions associated with the one or more users, assigning users to one or more groups, or other functionality designed to group and or manage one or more users. In the embodiment, users may be searched via search fields 1505. The search may include, but is not limited to, a search on the user's username, the user's first name, the user's last name, one or more unique identifiers associated with user, one or more groups that the user is associated with, departments, roles, buildings, or other data associated with one or more of the users. Users from the search profile are displayed in a window 1507, and one or more users displayed may be managed or edited corresponding inputs 1511, deleted, or one or more new users may be added via input 1509. In an embodiment, users may be added one at a time. In an embodiment, a plurality of users may be added. User data may be imported from, for example and without limitation, other systems, or other third-party electronic data and/or user lists via inputs 1515. Class data associated with the users may be imported via inputs 1517. In the illustrated embodiment, users may be imported via a lightweight directory access protocol (LDAP) 1513.

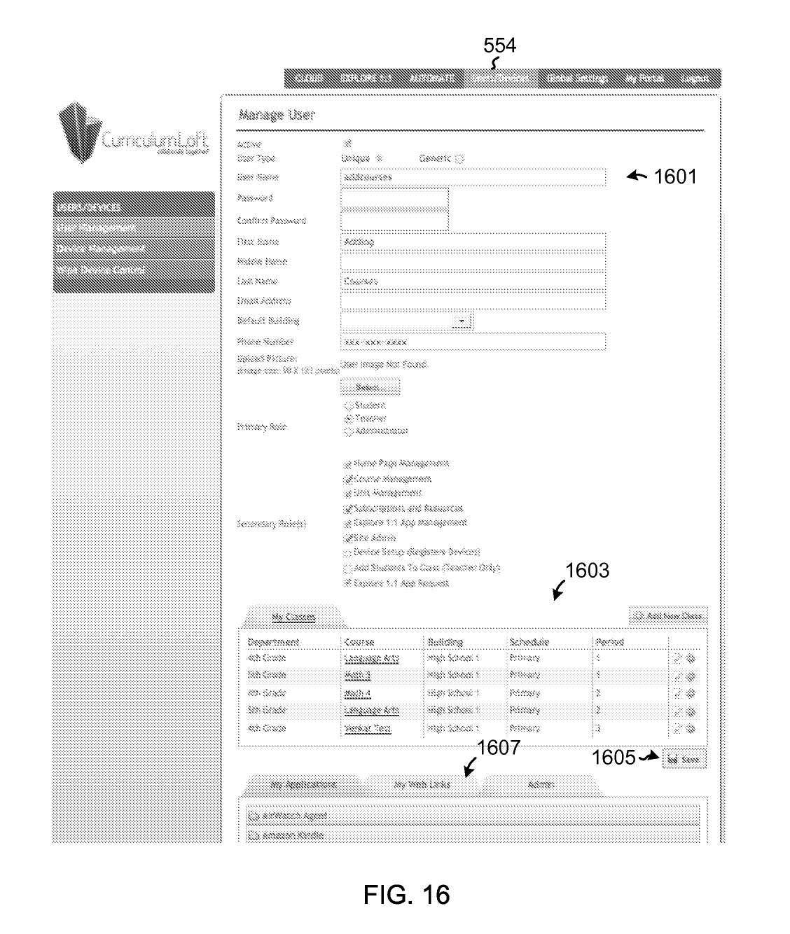

FIG. 16 is an exemplary graphical user interface showing user management at the local content server 101 or administration system 103 according to an embodiment of the present disclosure. In FIG. 16, users may be added or modified one at a time, using, for example and without limitation, the fillable fields 1601 shown. User data may be input into the system directly, or may be imported from one or more electronic lists. Exemplary data includes, for example, user name, password, email, building, phone number, role (student, teacher, administrator), and other roles. A primary role for the user may include one or more permissions to access or modify content. In addition to the primary roles, one or more secondary roles may be granted to a user, which modify the security profile granted through the primary role. For example, a user with a primary role of teacher may not have access to “course management,” but may be granted access to “course management” through a selection of the “course management” secondary role. The fields 1601 may include additional error and/or boundary checking, to ensure that the user inputs appropriate and consistent information into the fields 1601. Classes associated with the user may be added and edited with table 1603, and applications and web links associated with the user may be viewed with table 1607. The user may save the form after inputting information with button or link 1605.

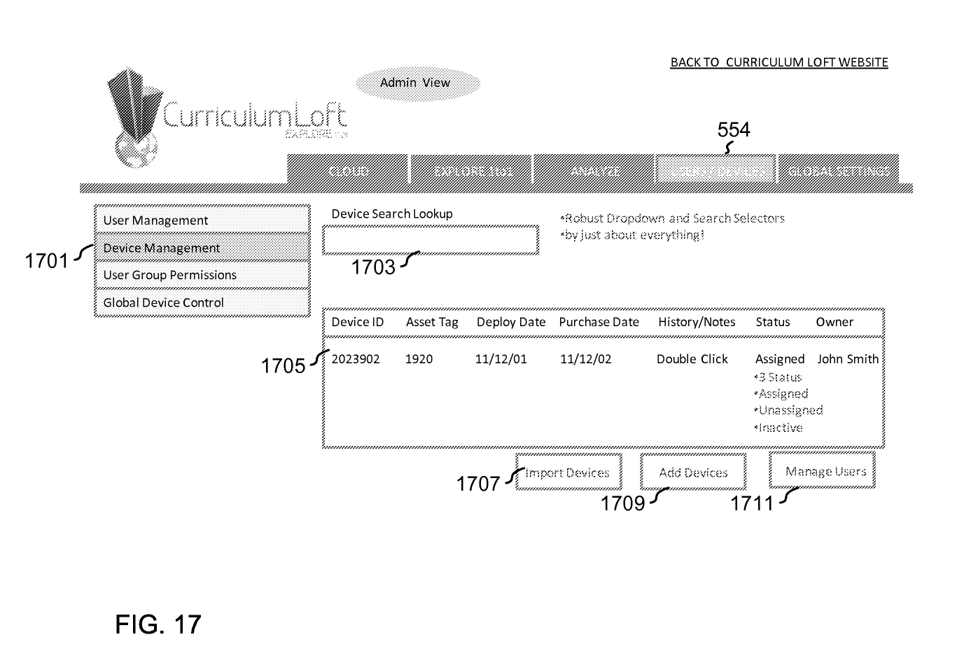

FIG. 17 is an exemplary graphical user interface showing device management 1701 at the local content server 101 or administration system 103 according to an embodiment of the present disclosure. In the embodiment, devices 127 may be searched via search field 1703. The search may include, but is not limited to, a search of the devices' unique identifier, the devices' name, the user associated with the device, either currently or in the past, or other unique identifier associated with individual devices, or groups of devices. Devices 127 associated with the search profile are displayed in the window 1705, and the device information may include, but is not limited to, device ID, asset tag number, date that the device was deployed, dates the devices were purchased, history or notes associated with the device, the status of the device, and the current and/or historical owner of the device. In one embodiment, devices may be imported via input 1707 from one or more files, or may be added on a one by one basis. In one embodiment, the user may have the option of adding or deleting devices with input 1709 from the graphical user interface, or managing devices with input 1711. In particular, input 1711 may allow a user to edit the device information associated with a device.

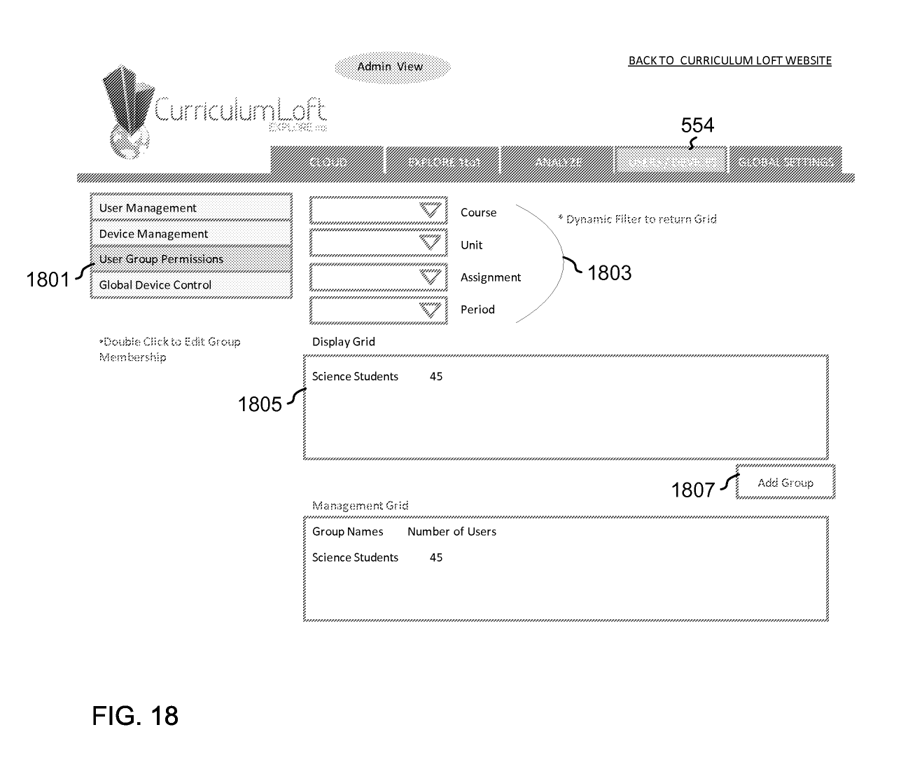

FIG. 18 is an exemplary graphical user interface showing user group permissions 1801 according to an embodiment of the present disclosure. In FIG. 18, one or more groups may be created. One or more users may be associated with one or more groups, to allow groups of users to more quickly and accurately be modified, added, or deleted. For example, and without limitation, a group of users may be placed into a group called grade 1. The grade 1 group may be modified by adding, for example and without limitation, one or more applications and/or web links. Instead of adding the one or more applications and/or web links to each of the individual users, a user or other administrator may add this application and/or web link to the group, and the application and/or web link may be pushed to each of the users within the group. Additionally, subgroups in a group may also be created. For example, and without limitation, a high-performing group within grade 1 may be created, a middle performing group within grade 1 may be created, and a low performing group within grade 1 may be created. Different applications and/or web links, or different assignments or other content, may be distributed to the different subgroups depending on the needs of the class. For example, and without limitation, remedial coursework may be pushed or made available to users associated with the low performing subgroup. In the figure, groups may be filtered 1803 according to, for example and without limitation, course, unit, assignment, and period. Results of the filter may be displayed in a display grid 1805, and a user may select one or more of the groups. Groups may also be managed, may be added, deleted, or modified 1807.

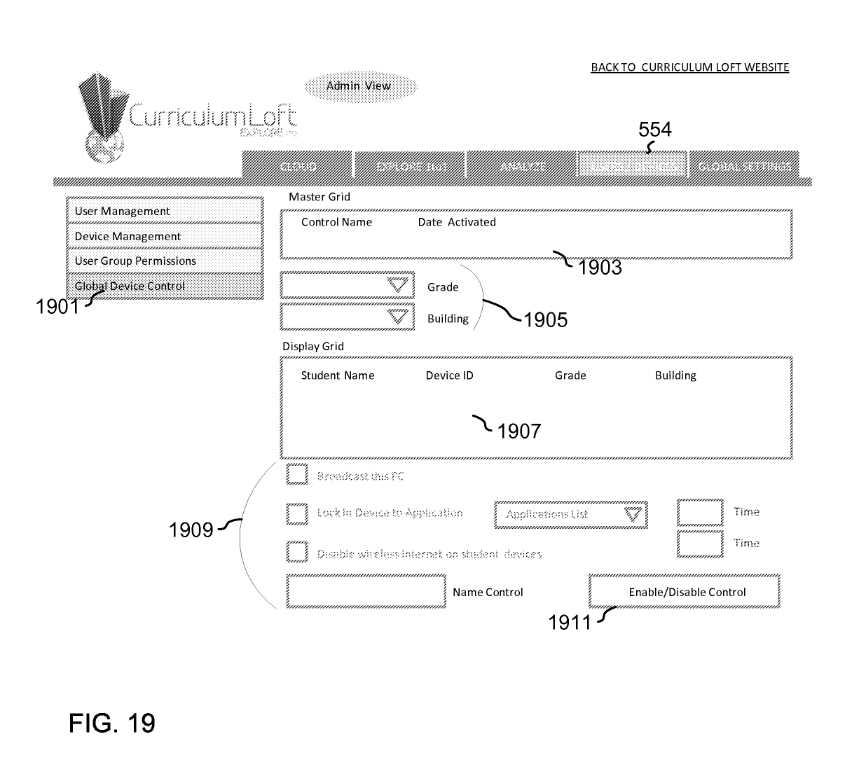

FIG. 19 is an exemplary graphical user interface showing global device control 1901 according to an embodiment of the present disclosure. In FIG. 19, one or more devices 127 may be managed globally. For example, and without limitation, devices 127 shown in a master grid 1903 may be filtered 1905 by grade and/or building, may be displayed in the display grid 1907, and appropriate actions, such as those shown in elements 1909, may be taken with respect to the group of devices as a whole. For example, and without limitation, the devices 127 may be locked to one or more applications, for a set time, or until the administrator or other user unlocks the devices 127 from the application. This may be useful, for example, when administering tests, so that users are locked into a specific test taking module, and may not be able to access notes or other content. Additionally, Internet and/or wireless access may be enabled and/or disabled on a device by device, or on a global basis. The user may approve selections with the enable/disable control button 1911. Additionally, the devices may be locked by the user only during the class or period specified, so that the devices may be automatically unlocked before and after the class or period. In another embodiment, the global device control described with FIG. 19 is accessed under the automate/analyze tab 552.

In one embodiment, the global device control of FIG. 19 includes a wipe control function by allowing the administrator to select devices 127 that are to be “wiped” remotely. In particular, one or more devices 127 are accessed by the administrator via the user/devices tab 556, and the content of the one or more devices 127 may be cleared or deleted remotely. The content may include operating systems, modules, personal content such as videos and music, and other applications, files, and software loaded on the devices 127.

The global settings tab 558 is selected in FIGS. 20-20B, thereby allowing a user to configure global settings related to the device management system. In one embodiment, the functions provided with the tab 558 are implemented with the explore module 119 and/or cloud module 121. FIG. 20 is an exemplary graphical user interface showing global activation settings 2003 for the content management system according to an embodiment of the present disclosure. In FIG. 20, one or more modules associated with the local content server 101 and administration system 103 such as, for example and without limitation, the cloud module 121, the explore module 119, the automate module 141, and/or an analyze data warehouse may be activated or deactivated with inputs 2007, according to the needs and/or subscription of the user.

Additionally, standards may be selected to align assignments and other content against. FIG. 20A is an exemplary graphical user interface showing standard selection settings for the administration system 103 and/or local content server 101 according to an embodiment of the present disclosure. In FIG. 20A, with input 2009 selected, the curriculum standards that are to be implemented with the school system are selected. Standards are selected via inputs corresponding to the listed standards 2013 under selection tab 2011. The selected standards are then listed under the Aligned Standards tab. The selected standards may be saved via input 2015.

FIG. 20B is an exemplary graphical user interface showing global LDAP configuration settings for the device management system according to an embodiment of the present disclosure. In FIG. 20B, with input 2019 selected, a user may enable the use of LDAP via input 2021. Fields 2023 allow a user to specify, for example, the sync frequency of the LDAP, the connection string, the administrator username and password, and the directory type. The LDAP connection is tested by the local content server 101 upon selection of input 2025. The LDAP connection may be deleted upon selection of element 2027. The LDAP configuration is saved or reset via inputs 2029.

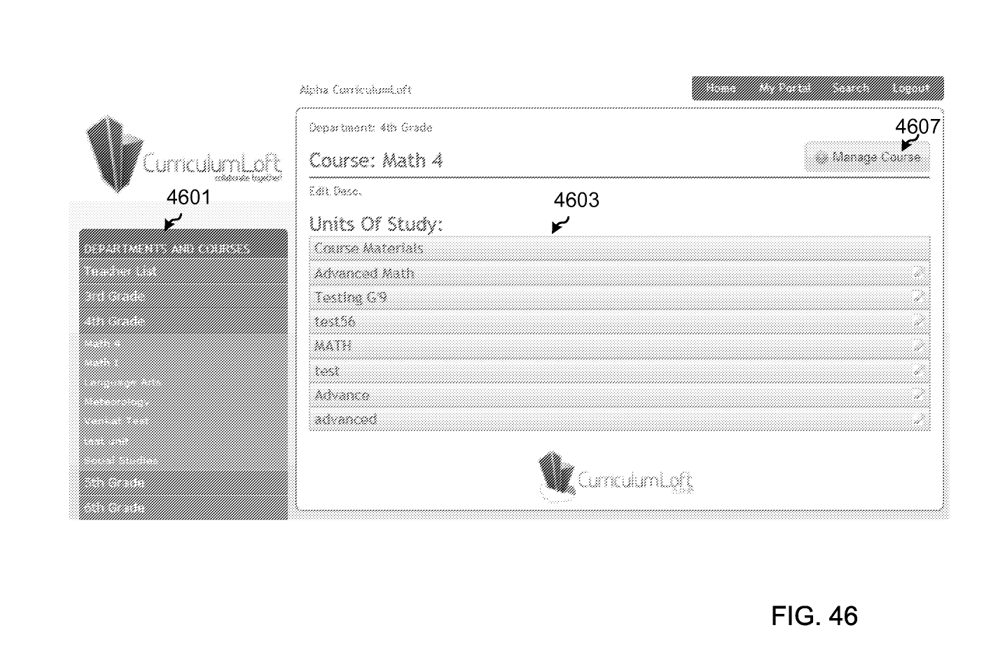

FIG. 21 is an exemplary graphical user interface showing a home screen 2101 upon a user logging into the content management system described herein. The home screen 2101 of FIG. 21 is illustratively a home screen for an administrator or teacher that includes links 2107 to administration or teacher tools and modules provided at the administration system 103 and local content server 101, although the home screen 2101 may also be for a student user. The home screen 2101 displays editable user information 2103, such as the user's name, photo, email, phone number, and description or role. In addition, the classes associated with the user are displayed in table 2105, and each class includes a quick link to access information and resources for that class. Classes may be added and removed from the table 2105. From the home screen 2101 of FIG. 21, a user may be able to access the user's information, may be able to search the content management system, or may be able to log out, as shown with selectable elements 2102. A navigation bar 2109 may also be provided, so that the user may be able to navigate one or more departments and courses. For example, and without limitation, the user may be able to navigate to the different departments, courses, and classes and view and/or modify the associated content, such as the course materials, assignments, student info, etc., and otherwise manage the course or class content. In one embodiment, the state and national (common core) standards associated with a course may be viewed and/or modified upon a user navigating to the course or unit of study. See, for example, FIG. 46 described herein.

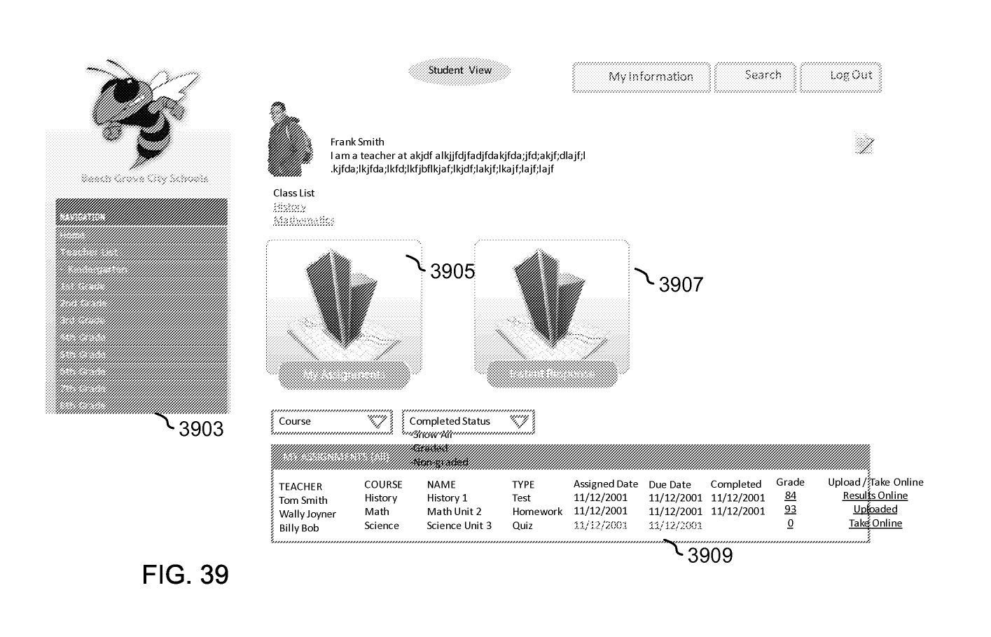

The available links 2107 may vary depending on the user's role and access privileges. In FIG. 21 for an administrator or teacher user, the links 2107 include an administrator portal 2111, an automate link 2113, a unit launcher template builder link 2115, and a my requests link 2117. Selection of the administrator portal 2111 provides access to the graphical user interfaces and functionality described herein with respect to FIGS. 5A-20B. Selection of the automate link 2113 provides the user access to some or all of the functionality of the automate module 141 of FIG. 2 described herein. Selection of the my requests link 2117 allows the user to view and manage all pending or completed requests for applications or web links. Selection of the unit launcher template builder link 2115 allows the user, such as a teacher or administrator, to access some or all of the functionality of the framework module for digital content creation 105 and/or the framework module for application/software creation 107 of FIG. 2 described herein for creating a unit of study. The links 2107 available on the home screen 2101 for a student user may include links to assignments, an instant response link, and a my requests link 2117, for example, as described herein with respect to FIG. 39.

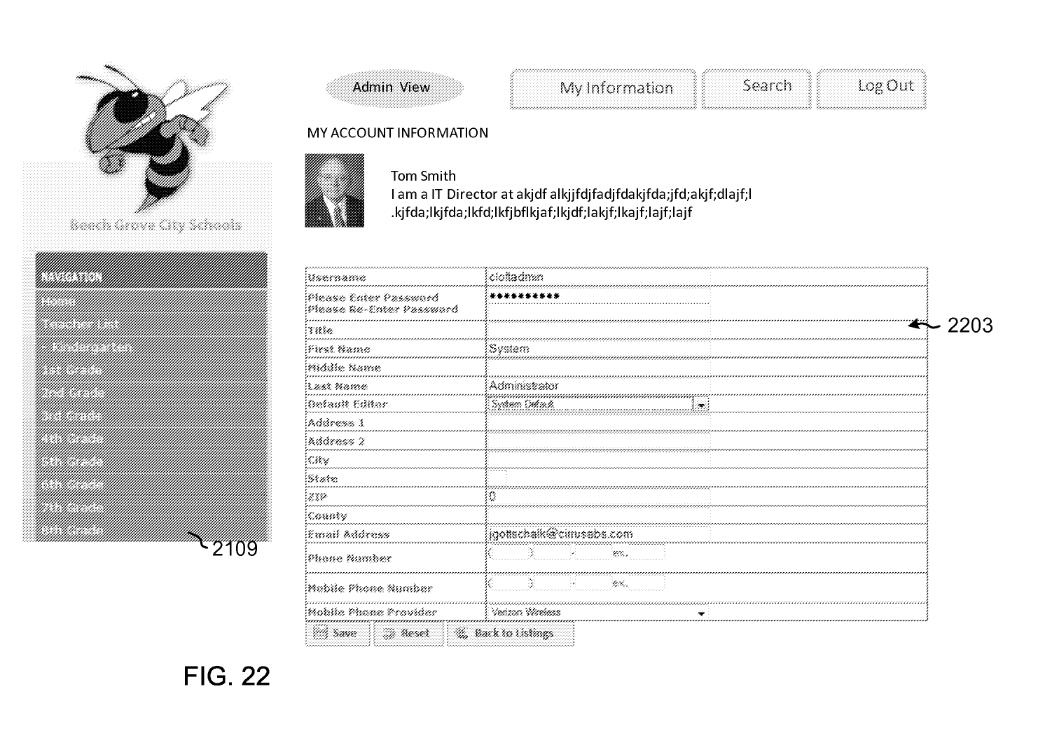

FIG. 22 is an exemplary graphical user interface showing a user's account information according to an embodiment of the present disclosure. The user interface of FIG. 22 is accessed by selecting the edit icon 2119 of FIG. 21. In FIG. 22, the user may add or change information about the user in fields 2203. The information may include, but is not limited to, the user name, password associated with the user, the user's title, the user's primary and secondary roles, first name, middle name, last name, one or more defaults editors, a user's address, city, state, zip code, county, e-mail address, phone number, and/or mobile phone number. The user may save the updated contact information, or may reset the information to the information as it was presented initially.

FIG. 23 is an exemplary graphical user interface showing classroom device control according to an embodiment of the present disclosure. In FIG. 23, the user may be able to control one or more of the devices 127 associated with the particular class or group that the user is leading, using the controls provided in, for example, elements 2301. For example, if the user is leading first period world history, as shown in the figure, the user may be able to control the devices 127 also associated with first period world history. For example, and without limitation, the user may be able to enable teacher broadcast, which broadcasts the desktop associated with the teacher and/or user to all of the devices 127 associated with the current course. The user may also be able to lock-in devices 127 to one or more specific applications, and may be able to choose the one or more applications from an application to list. This feature may be used during, for example, an examination, when the user wishes to lock devices 127 to a particular application, and not allow students to access additional content outside of the particular application. Additionally, the user may disable wireless Internet and/or Internet access to student devices 127. The user may be able to disable wireless Internet and/or Internet access to student devices 127 based on the time of the class, or may be able to selectively enable and disable wireless and/or Internet access for any device 127 at any time. In one embodiment, the some or all of the functionality described with the user interface of FIG. 23 is implemented with the lockout module 513 of the portable device 127 and the explore module 119.

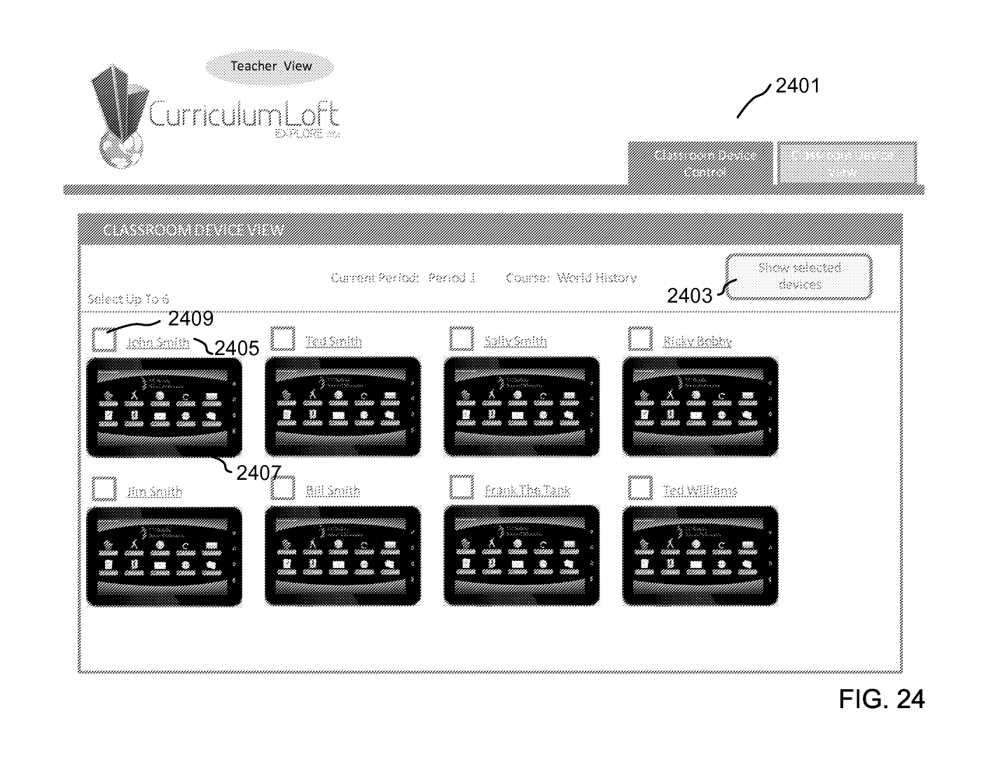

FIG. 24 is an exemplary graphical user interface showing a classroom device view of available devices 127 according to an embodiment of the present disclosure. In one embodiment, the connect module 125 of FIG. 2 implements some of the classroom device view functionality. In an embodiment, the user may have access to the current screen of the devices 127 associated with the particular course. For example, and without limitation, in the embodiment shown, the user teaches world history, and is able to view the current desktop of the devices 127 that are associated with that particular world history class. In an embodiment, the user may be able to view the current desktop 2407 of any associated device 127. The user is able to select one or more of the devices, and may display the current screen 2407 of one or more of the one or more selected devices at a time. In an embodiment, the username 2405 or other unique identifier associated with a particular device 127 is also shown by the screen of the particular device, and the user is able to select one or more of the devices 127 for viewing by using buttons or check boxes 2409. The current screens of the selected devices 127 may then be viewed upon selection of input 2403.

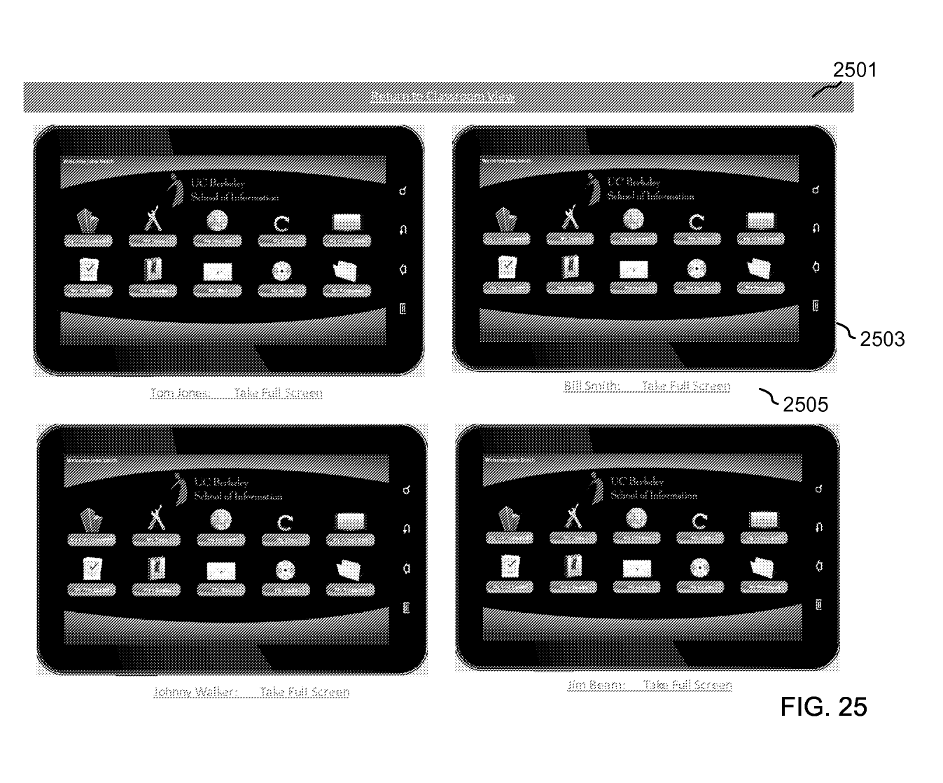

FIG. 25 is an exemplary graphical user interface showing the active screens of available devices 127 being viewed according to an embodiment of the present disclosure. In FIG. 25, the user has selected four devices, and is currently displaying the current screen 2503 for each of the four devices. In an embodiment, if the users of the device change the current screen, the screen is also changed in the classroom view. This may allow, for example and without limitation, a teacher to display the current screen of one or more of the students, and allowed one or more of the students to change his or her device screen, which may displayed to the full class. The user may also switch to the classroom view 2501, showing the displays of one or more of the devices 127, as in FIG. 25, or may use one of the currently selected devices and promote the device to full screen, shown with selection of link or button 2505.

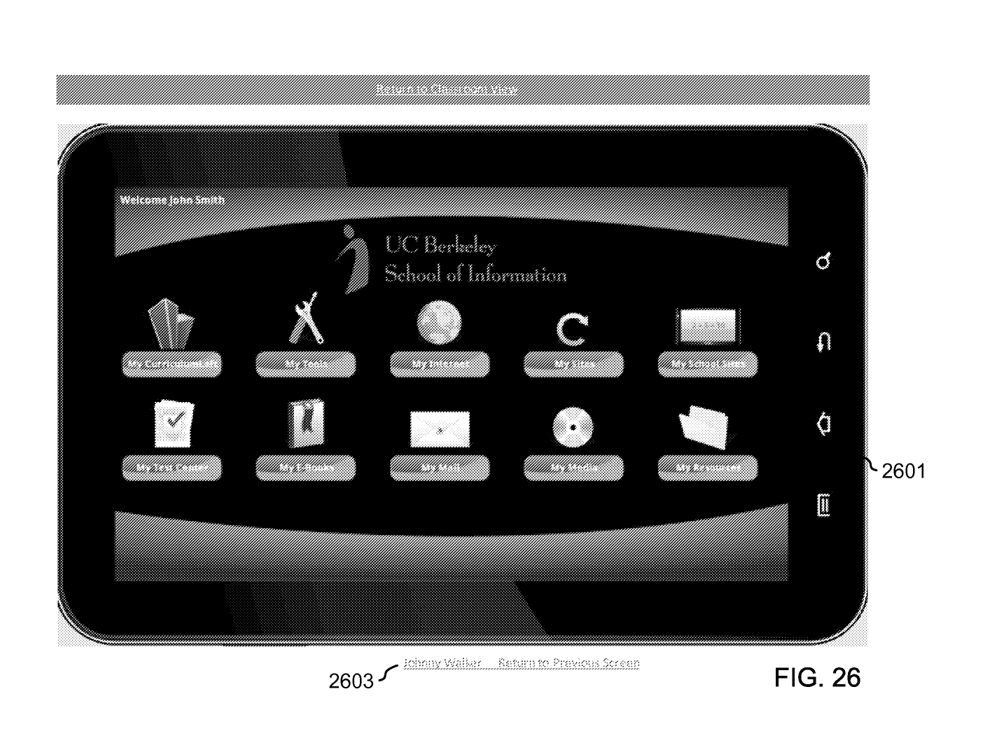

FIG. 26 is an exemplary graphical user interface showing the active screen of one device 127 in the classroom view according to an embodiment of the present disclosure. In an embodiment, the teacher may select a single device display 2601 to show to the class. The user of the device 127 which is being displayed to the class may be able to interact with the device 127, and the display 2601 as displayed to the class may also be updated. In this way, a teacher may grant a student access to a projector or other device, so that a class or other group of people may be able to follow along with the student, such as for example and without limitation, during a presentation. In an embodiment, the teacher may be able to interact with the display of a student's device, so that the teacher may change a student devices screen from a teacher device. In an example, a teacher may, for example and without limitation, highlight a correct answer on a student's device, or provide additional assistance to a student through their student device. The user may select a button or link 2603 to return to a classroom view of devices, or return to a subset view of the devices, as shown in FIGS. 24 and 25, respectively.

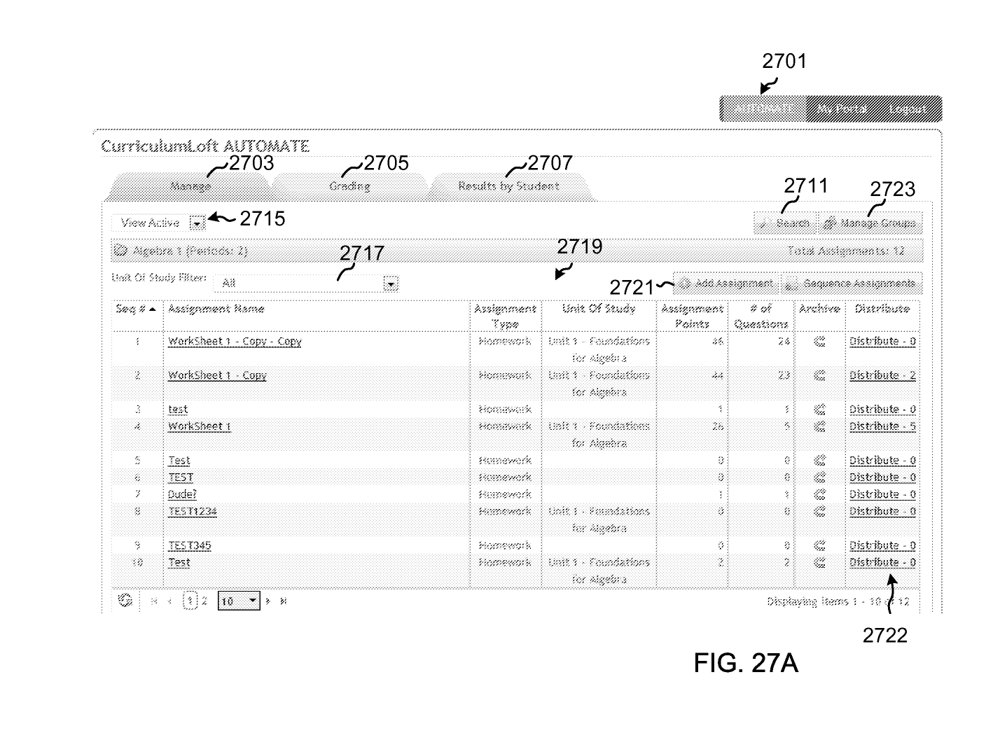

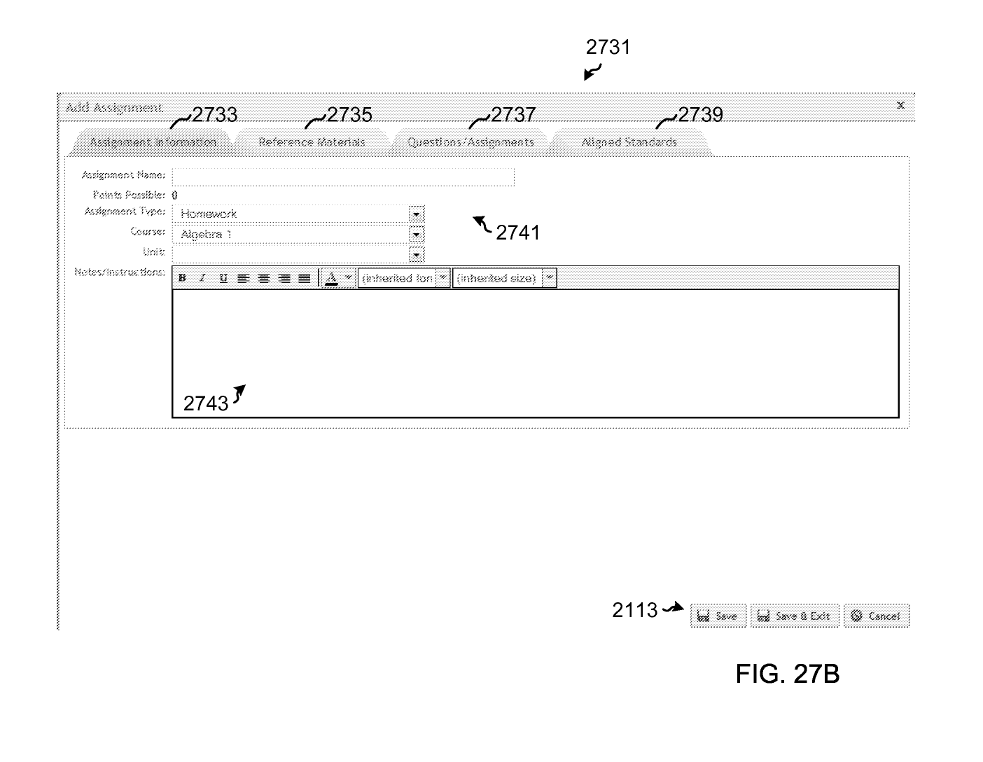

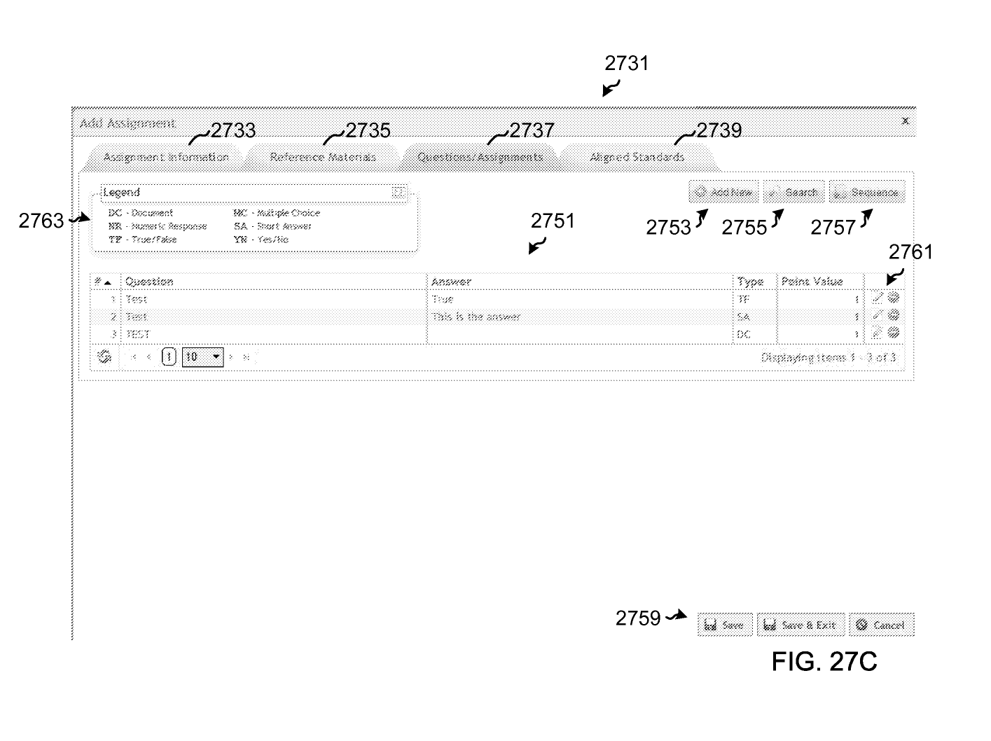

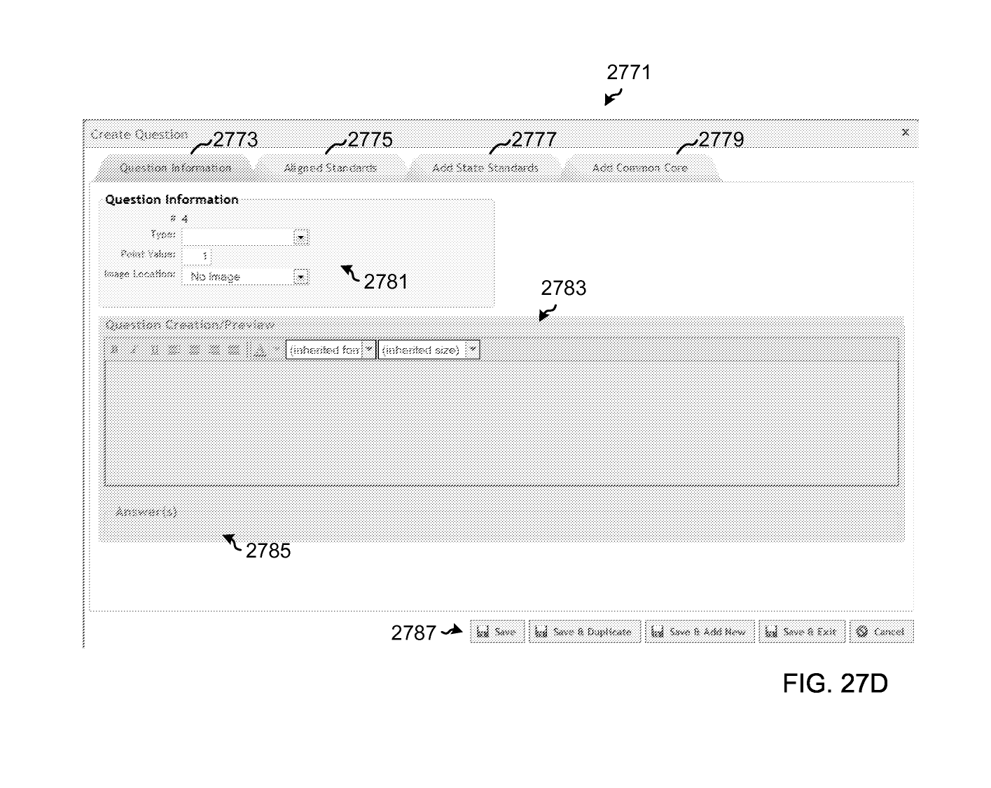

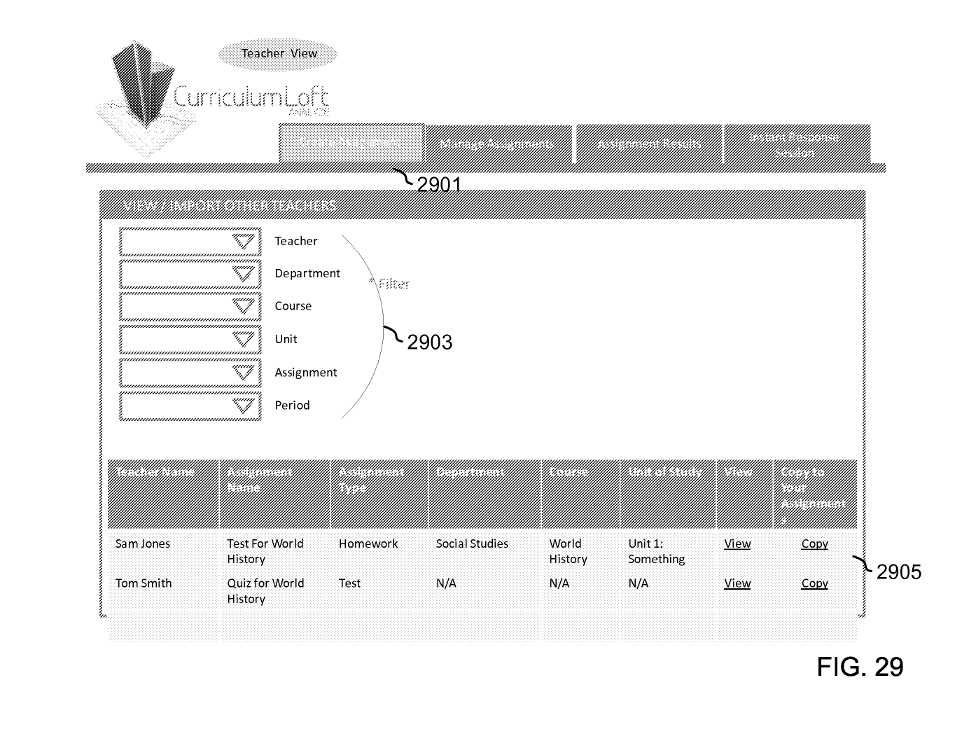

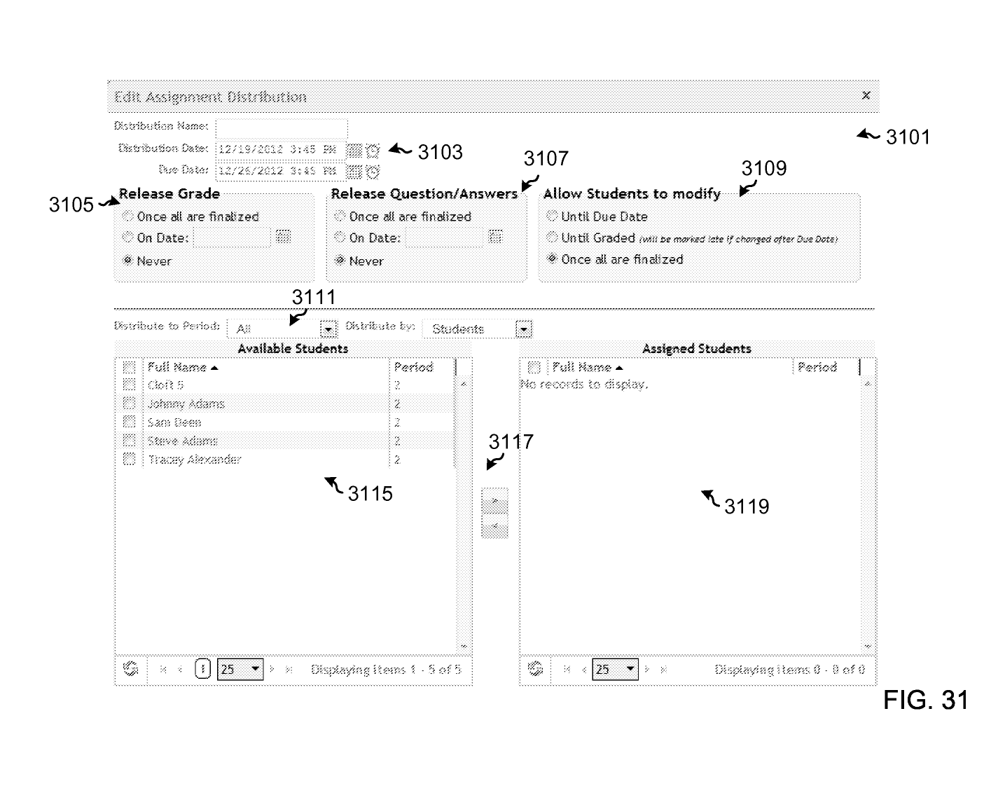

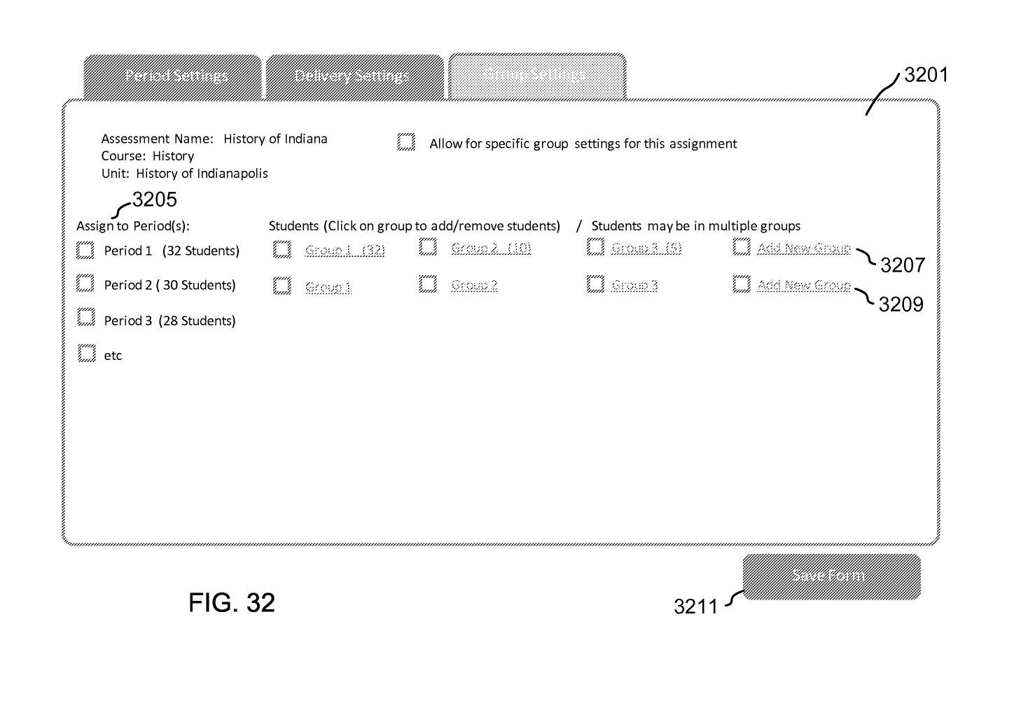

Selection of the automate link 2113 of FIG. 21 allows a user to access various functionalities of the automate module 141 of FIG. 2. The graphical user interfaces and functions described herein with respect to FIGS. 27A-37C are executed at least in part by the automate module 141. Upon selection of the automate link 2113 of FIG. 21, the automate module 141 provides the screen illustrated in FIG. 27A, which includes a manage tab 2703, a grading tab 2705, and a results by student tab 2707. Under the manage tab 2703 in FIG. 27A, the assignments that are accessible by the user (e.g., a teacher) are listed in a table 2719. With drop-down menu 2715, the user may select all active assignments or all archived assignments to be displayed in table 2719. In one embodiment, the archived and active assignments listed in the table 2719 comprise electronic data stored in cloud storage (e.g., storage 411 of FIG. 3A) via the cloud module 121. The user may filter the displayed assignments based on unit of study with drop-down menu 2717. For each assignment entry listed in the table 2719, information displayed may include, for example, the assignment name, the assignment type (homework, quiz, test, extra credit, etc), the unit of study of the corresponding course, the available assignment points a student may earn, the number of questions on the assignment, a selectable archive link that allows the assignment to be placed in the archived assignment list (accessed via input 2715), and a selectable distribute link 2722. In one embodiment, selection of the assignment name allows the user to modify or edit the corresponding assignment. Selection of the distribute link 2722 allows the user to distribute the corresponding assignment to the portable devices 127, as described herein with FIGS. 31 and 32. In one embodiment, the local content server 101 pushes the assignments to the devices 127, although the administration system 103 may also push the assignments. The user also may select the search input 2711 to open a search box for searching the cloud storage for a stored assignment, as described herein with respect to FIG. 29, for example, and for importing assignments into the user's assignment list. The assignments, in an embodiment, include electronic documents and data that may be sent from the local content server 101 or administration system 103 to a storage location of the portable device 127 and executed by the portable device 127. In one embodiment, the assignments completed at the portable device 127 are sent back to the local content server 101 for storage on the cloud. In one embodiment, assignments are stored or cached at the local content server 101 and are accessed by the portable device 127 via the local area network 102 (FIG. 1), and the portable device 127 transmits answers to the assignment questions to the local content server 101 over the local area network 102.

The assignment management tab 2703 also allows a user to create a new assignment to be added to the table 2719 via the add assignment input 2721. Upon selection of the input 2721, the add assignment screen 2731 of FIG. 27B is generated and displayed by the automate module 141. Screen 2731 provides access to several functional tabs, including, for example, an assignment information tab 2733, a reference materials tab 2735, a questions/assignments tab 2737, and an aligned standards tab 2739. With the assignment information tab 2733 selected in FIG. 27B, several fields 2741 are provided for adding assignment information such as, for example, the assignment name, the points possible, the assignment type and course, and the assignment unit of study. Additional notes or instructions associated with the assignment may be added to box 2743. The assignment information may be saved or cancelled without saving via selectable inputs 2113.

With selection of the reference materials tab 2735 of FIG. 27B, the automate module 141 is operative to allow a user to upload supporting documents, references, and other electronic files that are to be associated with the assignment being created. For example, a PowerPoint presentation, a video, a web link, an instructional or notes document, another link, or any suitable electronic file or document may be added and stored at the cloud and/or local content server 101 and associated with the assignment. As such, a student user receiving or accessing the assignment at a later time also has access to the corresponding reference materials. In one embodiment, the reference materials added are listed in a table similar to the table 2719 of FIG. 27A. With the selection of the aligned standards tab 2739, the automate module 141 allows a user to view and/or select the state and/or common core standards that are to be associated with the assignment, as described herein. In one embodiment, the standards may be associated with an assignment, a particular question of an assignment, reference materials, or any other suitable document or data.

With the question/assignments tab 2737 selected as illustrated in FIG. 27C, the user is able to manage the questions that are included in the assignment. The assignment questions are listed in a table 2751 along with question information including, for example, the question number, the question (or shortened version of the question), the correct answer, the type of question, the point value associated with the question, and an edit link 2761 that, upon, selection, allows the user to modify the question and corresponding information. A legend 2763 is provided that identifies the types of questions, illustratively including numeric, true/false, document (e.g., a student is required to upload a document with the question responses), multiple choice, short answer, and yes/no responses. The user also may select the search input 2755 to open a search box for searching the assignment for a question. Upon selection of sequence input 2757, the user may adjust the sequence of the questions as they appear in the assignment. Selection of the add new input 2753 opens a question builder module of the automate module 141 that allows the user to create a new question and add the new question to the assignment, as described in FIG. 27D. The assignment questions and question information may be saved or cancelled without saving via selectable inputs 2759.

Referring to FIG. 27D, the question builder screen 2771 is provided by the automate module 141 (based on selection of input 2753 or 2761 of FIG. 27C) that allows a user to create a new question or modify an existing question. The question builder screen 2771 includes a question information tab 2773, an aligned standards tab 2775, an add state standards tab 2777, and an add common core tab 2779. With the question information tab 2773 selected, the question information may be added via inputs 2781, including, for example, the type of question, the point value, and an image location selector for adding an image to be associated with the question. A word processing box 2783 is provided for typing or pasting the question and the answer 2785. In the illustrated embodiment, the font style and color may be adjusted via the word processing box 2783. State and common core standards may be selected and associated with the question using respective tabs 2777, 2779, and the standards currently aligned to the question are viewed via the aligned standards tab 2775. The new or modified question may be saved or cancelled without saving via selectable inputs 2787. In addition, the saved question may be duplicated to create a new, similar question, or a blank question template may be opened upon saving the current question with inputs 2787.

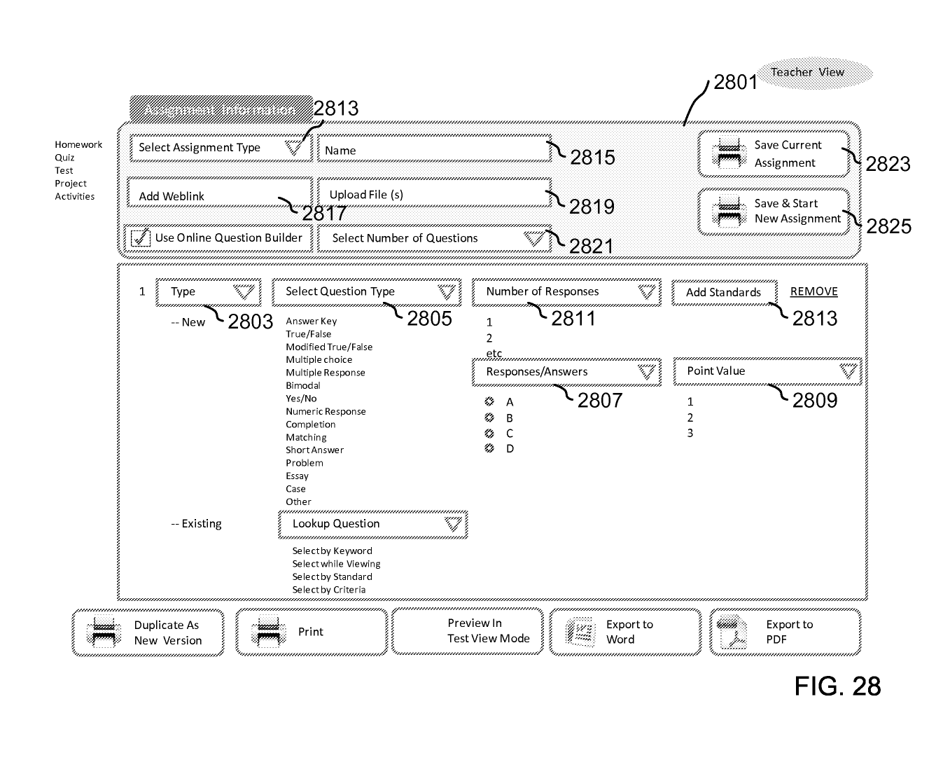

FIG. 28 is another exemplary graphical user interface 2801 for assignment generation and management (provided with the manage tab 2703 of FIG. 27A) according to another embodiment of the present disclosure. The assignment management and creation functionalities described with the embodiment of FIGS. 27A-27D and the embodiment of FIGS. 28-30 may be combined in part or in whole. In FIG. 28, a teacher or other user may be able to create one or more assignments that may be transmitted to one or more students. The user may select the assignment type 2813, and may provide a name for the assignment 2815. In an embodiment, the user may add one or more web links 2817 that may be beneficial to complete the assignment. In an embodiment, the user may upload one or more files 2819 that may be associated with the assignment such as, for example and without limitation, a video or other file which may be necessary to complete the assignment. In an embodiment, the user may use an online question builder, which may provide framework to create and distribute questions. In an embodiment, the user may select the total number of questions 2821 for the assignment. To generate a new assignment question, the user may select one or more types of questions 2803, and one or more question types 2805. The question types 2805 may include, but are not limited to, an answer key, true false questions, modified true/false questions, multiple-choice questions, bimodal questions, yes/no questions, numeric response questions, completion questions, matching questions, short answer questions, problem questions, essay questions, case questions, and/or other questions. Depending on the question type, the number of responses 2811 may be required. Additionally, responses and/or answers 2807 may be required. For example, and without limitation, the user may be prompted to, for a multiple-choice question, provide potential answers for the multiple choices. In an embodiment, the user may be able to assign the question to one or more standards 2813, or one or more substandard associated with a set of standard. In an embodiment, the user may be able to associate a point value 2809 with the particular question. In an embodiment, the user may be able to duplicate an existing test question, and modify the existing test question as a new test question. The user may also be able to print one or more of the questions of the assignment. In an embodiment, the user may be able to preview one or more of the questions in the assignment in a test view mode. In an embodiment, the user may be able to export one or more of the questions associated with the assignment to a word-processing document, or other electronic files. In an embodiment, the user may be able to export one or more of the questions associated with the assignment to a graphical publishing electronic format, such as, for example and without limitation, a postscript data file.

FIG. 29 is an exemplary graphical user interface showing a search filter for course content (e.g., assignments, reference materials, questions, etc.) available from other users according to an embodiment of the present disclosure. In an embodiment, the search filter of FIG. 29 is accessed via input 2711 of FIG. 27A. In FIG. 29, the user may be able to view and/or import assignments or questions from other users. The user may be able to filter 2903 assignments and/or questions by the teacher, department, course, unit, assignment, and/or period, or by using other factors. Assignments and/or questions that satisfy the one or more filter criteria are shown in window 2905. The assignments may be noted by, for example and without limitation, a teacher name, assignment name, assignment type, department, course, unit of study, or other factors. The user may be able to view one or more of the one or more assignments, and may be able to copy one or more of the one or more assignments and/or questions.

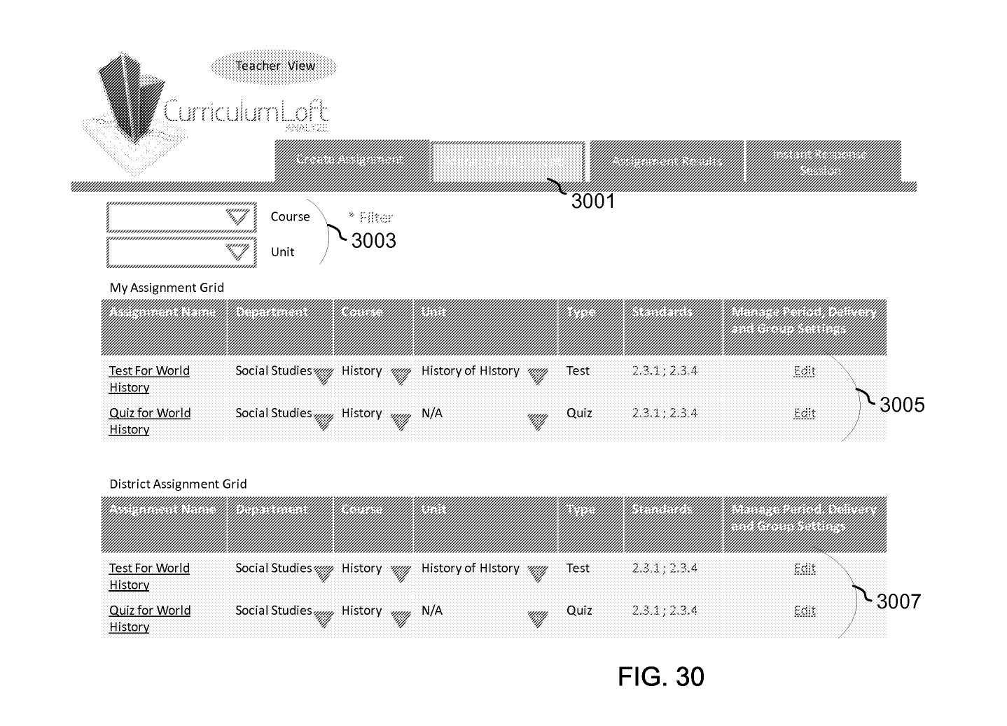

FIG. 30 is another exemplary graphical user interface showing assignment management 3001 according to an alternative embodiment of the present disclosure. In FIG. 30, the user may be able to filter 3003 by course and/or unit. Assignments associated with the user may be displayed in window 3005. For example, and without limitation, assignment name, department, course, unit, type, standards for filled, or other criteria may be shown for each assignment. The user may be able to manage delivery and group settings for individual assignments. The user may also be able to view assignments created by other teachers, administrators, or other entities 3007, and may be able to use all or a portion of the assignment for a particular class.

FIG. 31 is an exemplary graphical user interface showing an assignment distribution window 3101 provided by the automate module 141 according to an embodiment of the present disclosure. The user interface of FIG. 31 is accessed via the distribute link 2722 of FIG. 27A. In FIG. 31, the user (e.g., teacher) selects the student users who are to receive the assignment. In fields 3103, a name may be given to the assignment distribution, and a distribution date/time and assignment due date/time are entered. As such, the assignment is pushed from the local content server 101 to the portable devices 127, or otherwise made available to the student portable devices 127, at the specified distribution date/time, and the student user is required to submit answers to the assignment by the assignment due date/time, i.e., the assignment is no longer available for answers after the assignment due date/time. Window 3115 lists the students that are available to receive the assignment. The students listed in window 3115 are filtered based on the period selection 3111. Window 3119 lists the students selected for distribution of the assignment. Available students from window 3115 are added to window 3119 via input 3117. A release grade block 3105 includes inputs for selecting when to release grades to the student users for the assignment, with release options including once the assignments are all finalized, on a particular date, or never, for example. A release question/answers block 3107 includes inputs for selecting when to release answers to the student users for the assignment questions, with release options including once the assignments are all finalized, on a particular date, or never, for example. Block 3109 includes inputs for selecting when the students are no longer able to modify submitted answers to the assignment, with options including until the due date, until graded, and once all assignments are finalized, for example.

In one embodiment, the user may be able to make the particular assignment always available to a group of students, or may be able to make the assignment available to students for a particular period of time such as, for example and without limitation, twenty-four hours or one week. While the student user is completing the assignment, the device may be locked into the particular application providing the assignment.

FIG. 32 is an exemplary graphical user interface showing another assignment distribution window 3201 for creating and editing groups of users for receiving the assignment according to an embodiment of the present disclosure. The user interface of FIG. 32 is accessed via the manage groups link 2723 of FIG. 27A. The user is able to distribute assignments to specific groups, such as entire classes or periods with inputs 3205. The user is able define additional groups of students via inputs 3207, 3209 and to assign and distribute particular assignments to the particular groups. For example, and without limitation, if a specific section of students is divided into a group of high-performing students, a group of middle performing students, and a group of low performing students, the user is able to assign the assignment to one or more of the groups. For example, the user may be able to assign an assignment to high-performing students, or high-performing and middle performing students. The user is also able to add additional groups to groups already created. The user is also able to add new groups to classes. The user is able to save the settings using one or more buttons and/or links 3211.

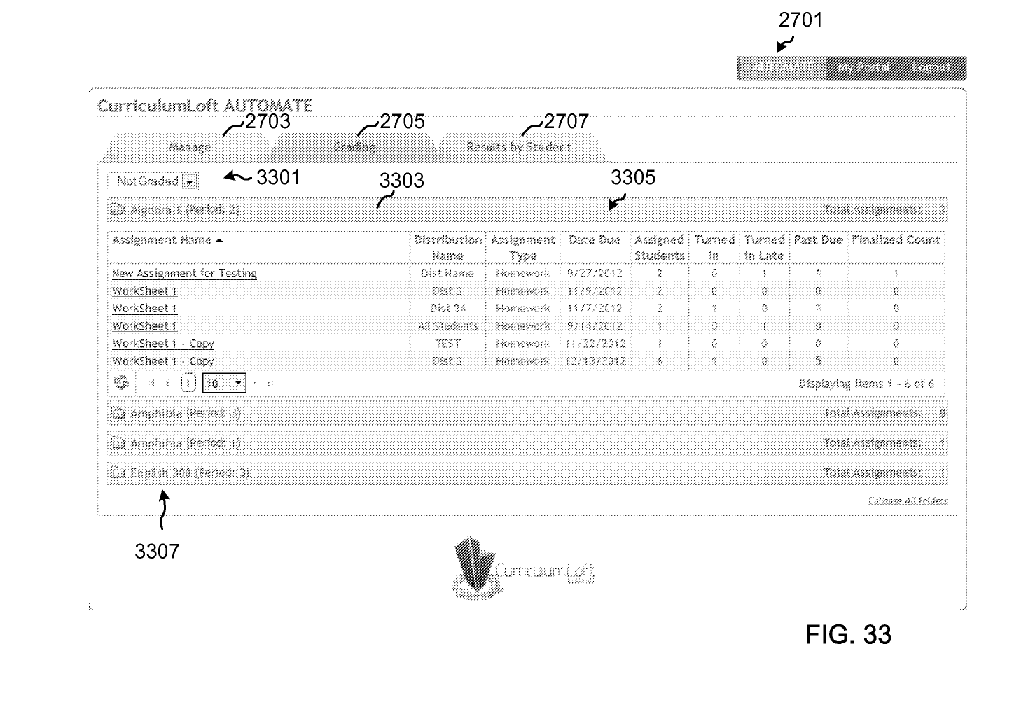

Referring to FIG. 33, the grading tab 2705 of the automate portal 2701 is selected. Under the grading tab 2705, the user is able to manage the assignments completed and the grading of the assignments. The classes accessible by the user are illustrated with expandable bars 3307. With the Algebra 1 Period 2 class 3303 selected in FIG. 33, a list 3305 of assignments associated with that class 3303 are displayed. The displayed assignments may be filtered with filter 3301 by, for example, whether the assignments are graded or not graded, or by other information. Each assignment in the list 3305 includes, for example, the assignment name, the distribution name specified in input 3103 of FIG. 31, the assignment type, the due date, the number of students the assignment was assigned to, the number of assignments turned in by students and turned in late by students, the number of assignments that are past due, and the number of assignments graded and finalized. Each assignment in the list includes a selectable link for accessing the student responses to that assignment. In particular, upon selecting an assignment, the students assigned to that assignment are listed along with their corresponding answers for grading. In one embodiment, the graphical user interface includes selectable inputs to allow a user to view reports on the assignment completion data, to print the results, to export some or all of the data to a spreadsheet program, such as Microsoft Excel, and/or to export the data to a graphical electronic files such as, for example and without limitation, a postscript data file.

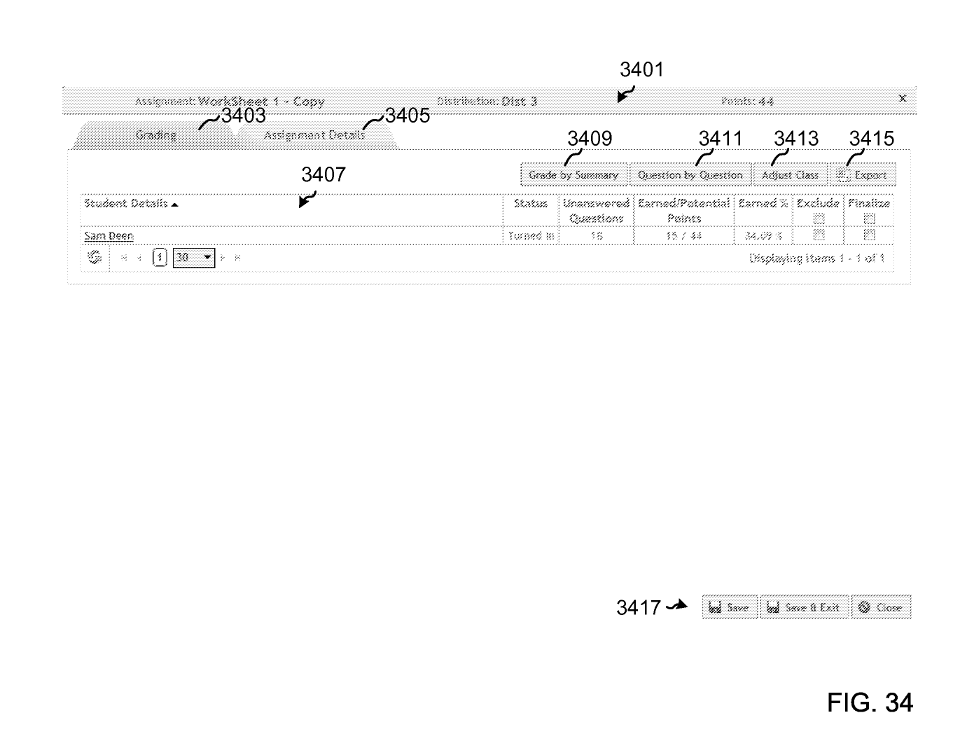

Upon selecting an assignment of FIG. 33 to grade or view, the exemplary graphical user interface of FIG. 34 is presented. In FIG. 34, an assignment summary screen 3401 is illustrated that lists the students assigned to the assignment in a table 3407 under the grading tab 3403. While only one student is listed in table 3407, additional students assigned to the assignment may be listed. The table 3407 includes, for example, the student name, the assignment status (turned in or not turned in, etc.) the number of unanswered questions, the points earned and points potential, the points percentage, an input to exclude the assignment from the student's grade, and an input to finalize the assignment. In one embodiment, finalizing the assignment adds the students' assignment grade and/or points total to the student's gradebook stored at the cloud. The assignment and student statistics may be exported via input 3415 to a spreadsheet document. The assignment details tab 3405 provides various statistics and details of the assignment, such as the assignment questions, the class averages, high scores, low scores, and other suitable assignment data. The assignment grading and other edits may be saved or cancelled without saving via inputs 3417.

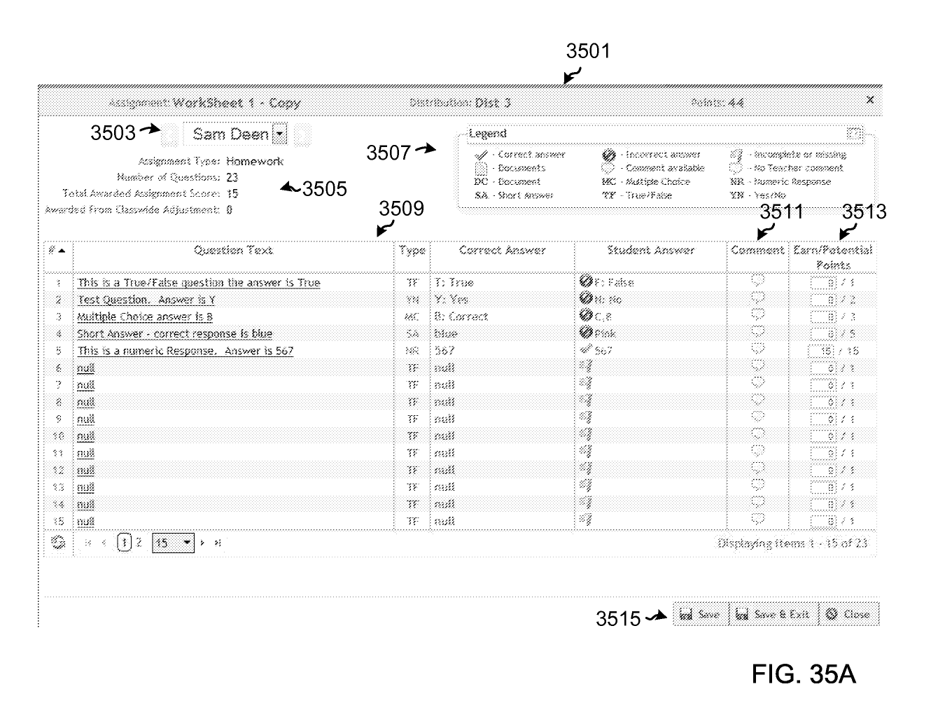

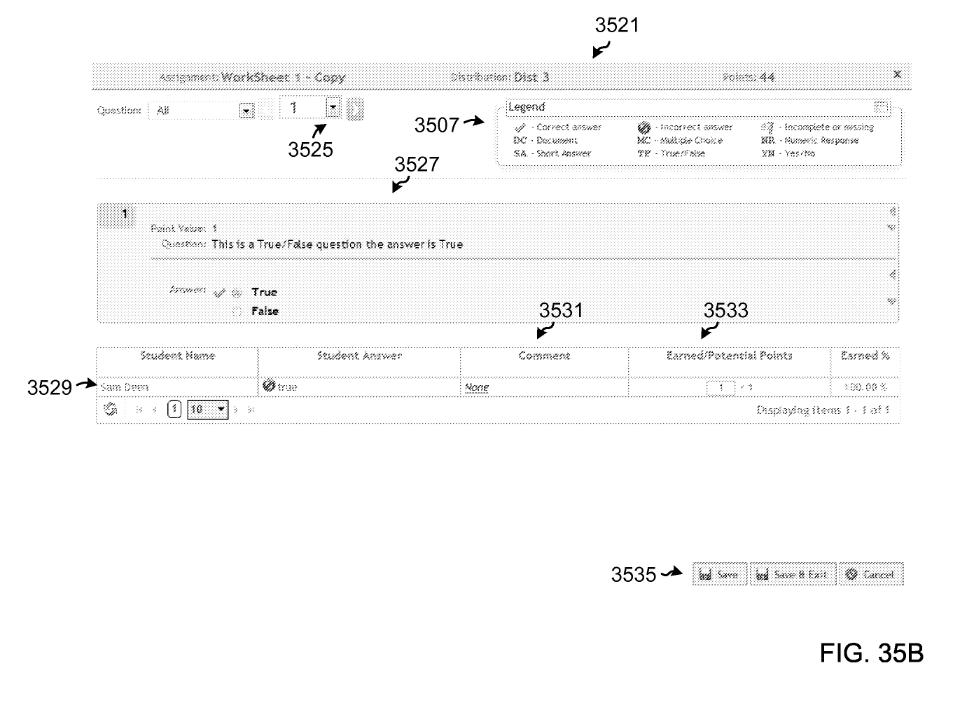

Upon selection of a student from the table 3407 of FIG. 34, a summary view of the students responses may be accessed for viewing and/or grading, as illustrated in the graphical user interface of FIG. 35A. In FIG. 35A, the student response summary screen 3501 is illustrated listing a selected student's responses in table 3509. A different student may be selected for viewing and/or grading via input 3503. An information section 3505 lists the assignment type, number of questions, the student's score, and class curve or adjustment, for example. The table 3509 lists the question and question number, the type of question, the correct answer, the student's answer, and a score field 3513 showing the earned points out of potential points. In one embodiment, the analyze module 123 of FIG. 2 automatically grades the students responses by comparing the student response to the correct response and populating the score field 3513. A teacher may edit that awarded points. In one embodiment, some types of questions require a teacher to manually input the awarded points, such as, for example, for essay, short answer, document questions, or other questions. A legend 3507 provides a key for associating codes from the table 3509, such as question type and student answer codes, with a definition of the code. A teacher may add or type a comment via the comment icons of column 3511 for each question. The assignment grading for the student and other edits may be saved or cancelled without saving via inputs 3515.

Upon selection of the question-by-question input 3411 of FIG. 34, the assignment questions may be accessed for viewing and/or grading one at a time, as illustrated in the graphical user interface of FIG. 35B. In FIG. 35B, a question summary screen 3521 is illustrated listing a particular assignment question in field 3527 and the student response for that question in table 3529. While only a single student is listed in table 3529, additional students from the class may be concurrently listed. The question field 3527 illustratively displays the question, the correct answer, and the point value. The student response table 3529 lists the student name, the student answer, a score field 3533 showing the earned points out of potential points, and the points percentage earned by the student. The score field 3533 may be automatically populated via the analyze module 123, or may be manually populated by the teacher, as described herein. A teacher may add or type a comment via the comment icons of column 3531 for each student's answer to the question. The question displayed may be changed via selectable input 3525. The question grading and edits may be saved or cancelled without saving via inputs 3535.

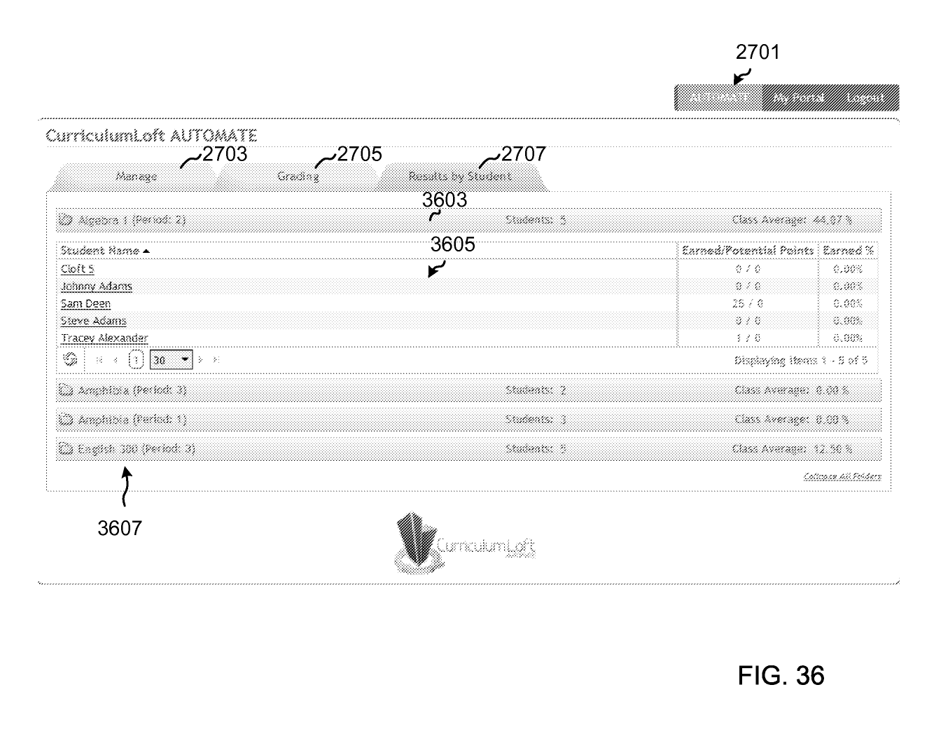

Referring to FIG. 36, the results by student tab 2707 of the automate portal 2701 of FIG. 33 is selected and displayed. This tab 2707 provides an alternative way to access the assignments and assignment responses and data. Under the results by student tab 2707, the user is able to manage the assignments assigned and completed by student for each class. The classes accessible by the user are illustrated with expandable bars 3607. With the Algebra 1 Period 2 class 3603 selected in FIG. 36, a list 3605 of students associated with that class 3603 are displayed. Each student in the list 3605 includes, for example, the student name, a score field showing the earned points out of potential points for the completed assignments in the class, and the points percentage earned by the student. The class points or percentage average and other suitable statistics may also be displayed. Each student entry in the list includes a selectable link for accessing the student's assignments and responses to the assignments. In particular, upon selecting a student, the assignments assigned to that student are listed along with links to the students answers to those assignments for grading. In one embodiment, updates to the grading and assignments under tab 2707 are automatically applied to the data accessed via tab 2705, and vice versa.

In one embodiment, the user may be able to set a cut score, or to adjust individual member scores of the class, or the class as a whole. In one or more screens described herein, the user may be able to view reports on the assignment data, may be able to print the results, and may be able to export some or all of the data to a spreadsheet program.

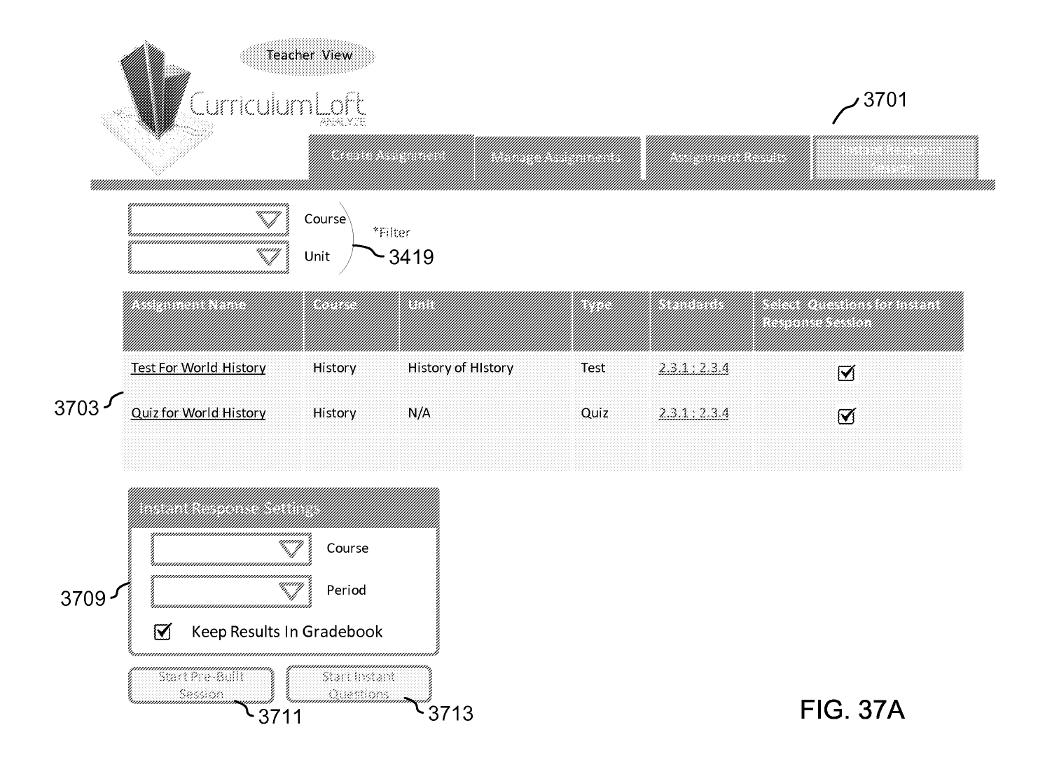

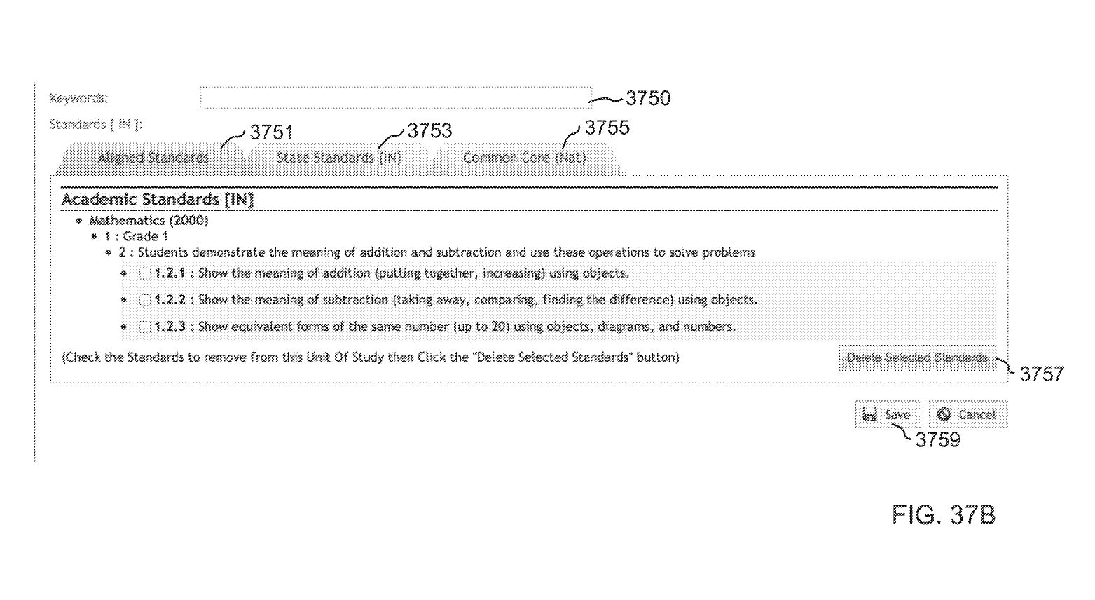

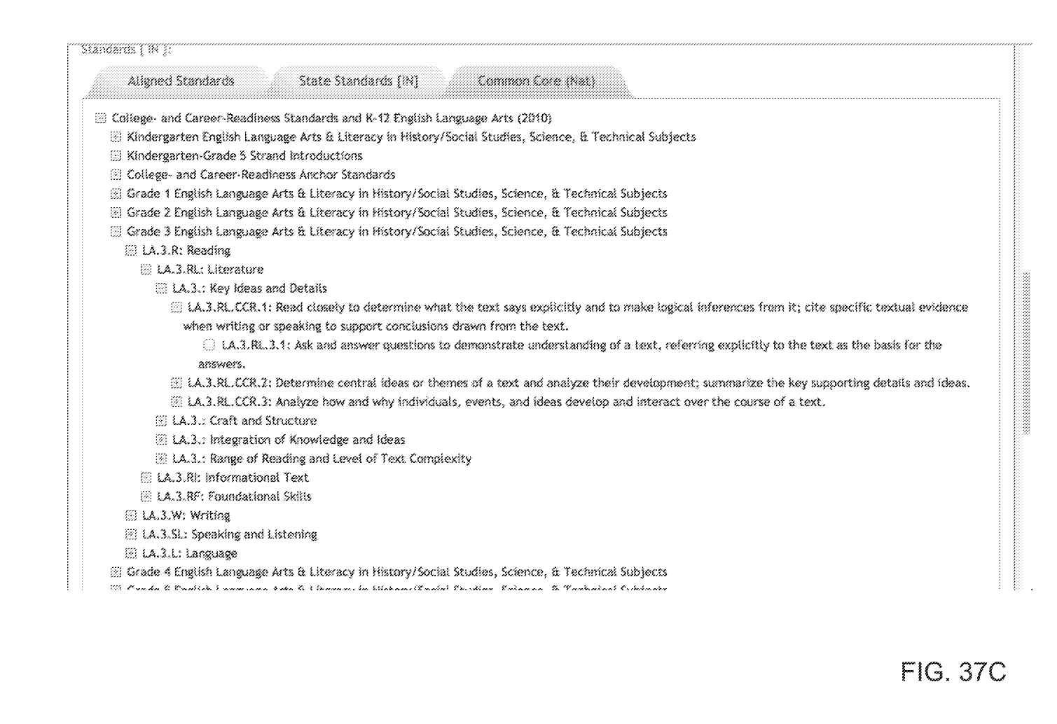

FIG. 37A is an exemplary graphical user interface 3701 showing standards mapping to assignments and an instant response session according to an embodiment of the present disclosure. The user may be able to filter via drop-down menus 3419 the assignment by course and/or unit. The results may be displayed 3703, and the user may be able to select one or more of the assignments, and one or more of the questions in one or more of the assignment, for an instant response session 3709. The instant response session may be provided to one or more of the student devices 127, and allow the students to answer a question, and transmits the answer back to the user. The user may be able to assign an instant response session to a particular course and/or period, and may elect or not elect to keep the results, or grade the results. The user may start a pre-build session with input 3711, and may be able to start the instant response session via input 3713.

FIG. 37B is an exemplary graphical user interface allowing standards assignment according to an embodiment of the present disclosure. FIG. 37B shows aligned standards 3751, state standards 3753, or common core standards 3755 associated with a particular grade, class, district, school, or building. A user building an assignment may select one or more standards or sub-standards that are applicable to the particular question, assignment, reference material, or unit. The user may select one or more standards or sub-standards, and may save the selection using a save button or link 3759. The user may be able to search the standards using a filter or other search criteria 3750. Additionally, the user may be able to delete one or more of the standards 3757, or to remove the applicability of one or more of the one or more standards to the assignment or other content.

FIG. 37C is an exemplary graphical user interface showing standards according to an embodiment of the present disclosure. In the embodiment, FIG. 37C shows aligned standards, state standards, and common core standards. The standards may be searched, and a user may select one or more standards when creating an assignment, or questions within the assignment. Additionally, a user may select one or more standards when creating a test or other content, to show that the standard is reflected in the content, or is being tested.

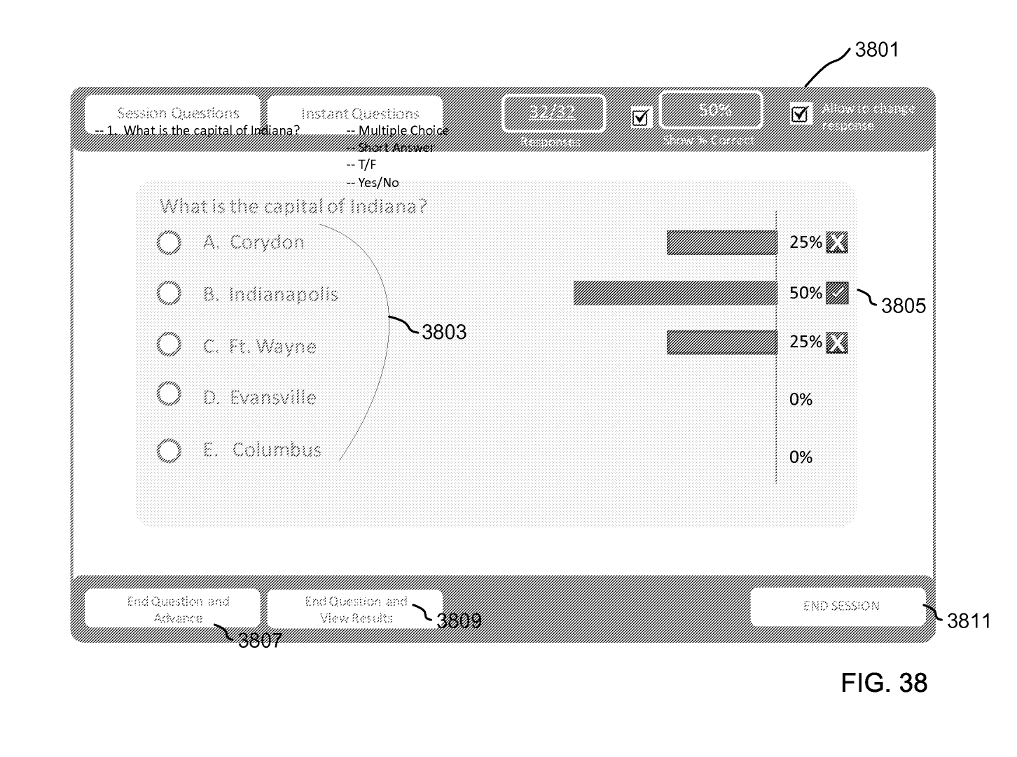

FIG. 38 is an exemplary graphical user interface 3801 showing the instant question session according to an embodiment of the present disclosure from a teacher's perspective. The user, in the embodiment, created an instant response session, shown in element 3803. In one embodiment, the instant response section is started via input 3713 of FIG. 37, and the question 3803 is generated. The instant response session illustrated in FIG. 38 may be viewed from a teacher's computing device that is in communication with the local content server 101 or administration system 103, for example. In one embodiment, multiple students access the instant response session concurrently via portable devices 127, and the students have a limited time to respond to each question before the next question is presented. A student selects an answer from element 3803. After all students have answered, the student feedback and answer statistics from the instant response session are shown in element 3805, along with the correct and incorrect answers. The user is also shown the number of responses collected, and the number of responses that are correct. The user may allow students to change their answer once the answers of been collected via an input. The user has the option of ending the question and advancing to the next question via input 3807, or ending the question and viewing the results via input 3809. The user may also end the session via input 3811.

FIG. 39 is an exemplary graphical user interface showing a student home screen according to an embodiment of the present disclosure. In one embodiment, the screens described in FIGS. 39-45 are viewed from a student's portable device 127. The student home screen of FIG. 39 may include a navigation bar 3903, allowing the student to select one or more grades, and view assignments associated with one or more grades. The student view may also allow the information to view student information, may allow the student to search the content management system, and may allow the student to log out. The student view may include a list of classes that the student is currently enrolled in. In an embodiment, the student may select one or more outstanding assignments, or one or more completed assignments, from window 3909. In an embodiment, the student may select assignments which may be outstanding, or which may have been completed. The student may be able to view assignments that have been assigned to the particular student, and may filter the assignments based on, for example and without limitation, whether or not the student has completed the assignment, whether or not the assignment is currently in progress, whether or not the assignment has not yet been started, or other criteria. In the embodiment, the student may be able to review and/or view assignments that have been graded, and may receive one or more grades based on the completed assignments. The student may be able to upload data to the local content server 101 or administration system 103 and/or other modules associated with the local content server 101 or system 103, may be able to upload additional files such as, for example and without limitation, one or more electronic files associated with a particular assignment. The student may be able to choose to move to an assignment view showing pending or completed assignments by selecting button or link 3905, or may be able to move to one or more instant response questions or sessions described herein by selecting button or link 3907.

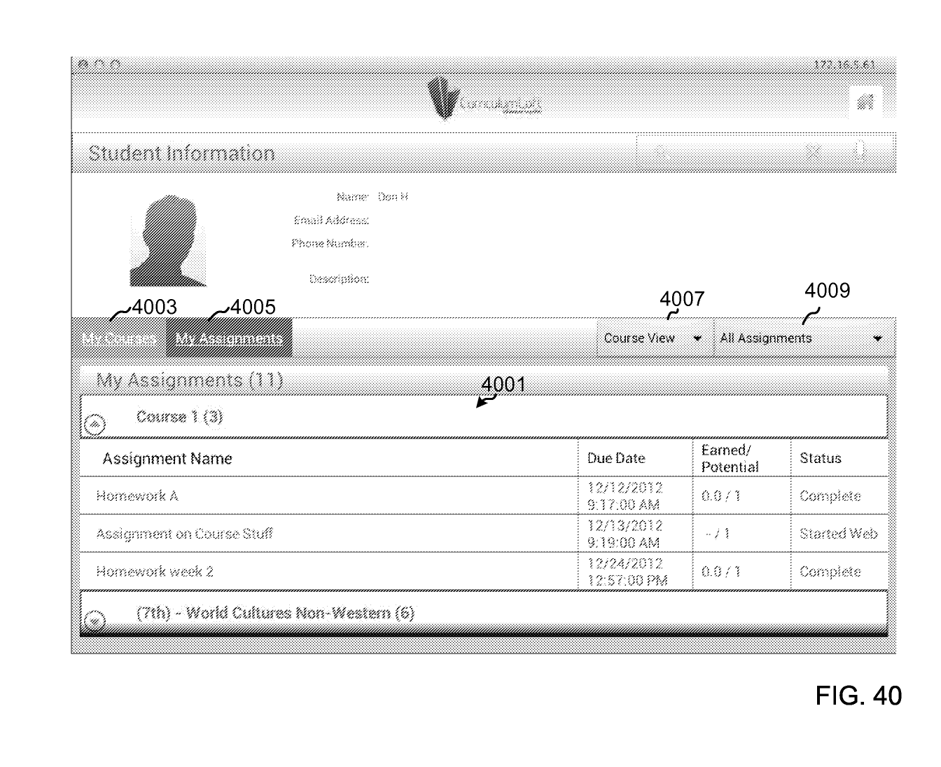

FIG. 40 is an exemplary graphical user interface showing a student assignment screen according to an embodiment of the present disclosure, illustratively accessed via link 3905 of FIG. 39. With input 4003 selected, the student assignment screen may allow the student to view assignments in table 4001 by class. With the Course 1 (3) class illustratively expanded, the pending and completed assignments for that class are listed in the table 4001. Using drop down menu 4009, the student may filter the assignments shown based on assignments currently due, assignments currently completed, assignments past due, all assignments, or other suitable filters. The student may also filter based on course or class using drop down menu 4007. The assignments may be displayed in table 4001 and may include data such as, for example, the associated teacher, the course, the assignment name and type, the due date, materials associated with the assignment, a grade or points earned, the assignment completion status, and other suitable data. Additionally, assignments may be marked as late if not completed by the due date. In an embodiment, the student receives one or more reminders to complete assignments on or before a due date. The student may select input 4005 to view all assignments in a list or table without being separated by class. For example, all incomplete assignments may be listed first.

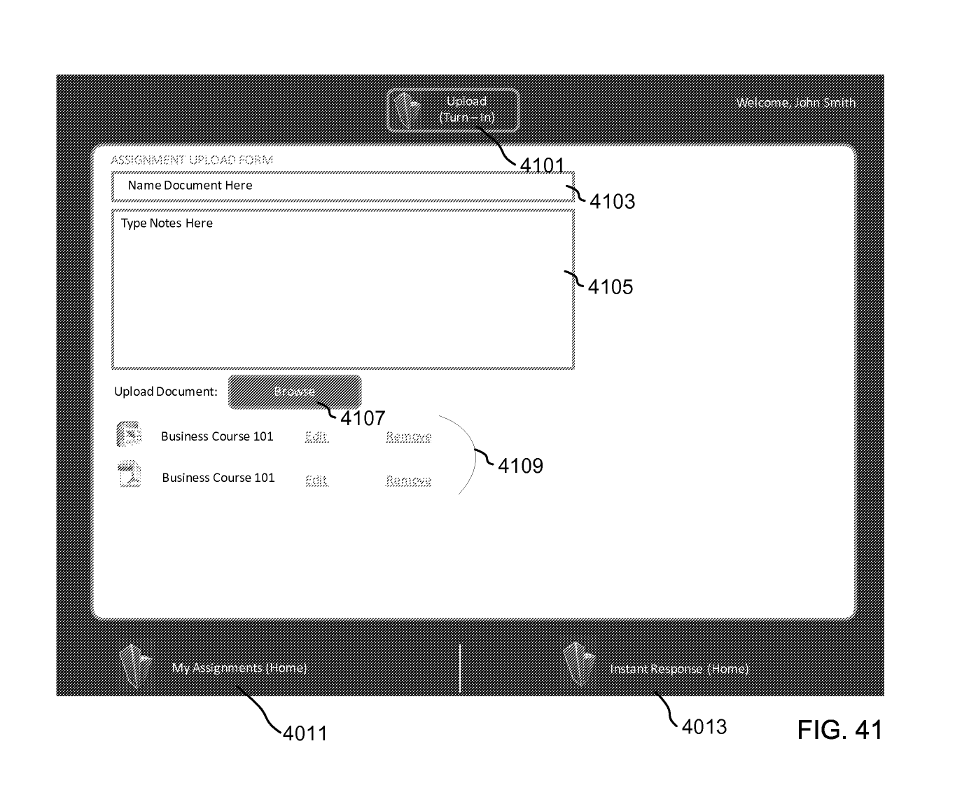

FIG. 41 is an exemplary graphical user interface showing an assignment upload form according to an embodiment of the present disclosure that is provided, for example, on a student's portable device 127. In the embodiment, the student may name a particular document associated with an assignment in field 4103, may type additional notes regarding the assignment and/or the document in field 4105, and may search for one or more documents to upload via input 4107. Exemplary documents to upload include an assignment, supporting material for the assignment, and other information that is to be submitted to a teacher or a user who has assigned the assignment. The selected documents for upload are listed at 4109. The student may, after data surrounding the assignment submission has been completed, upload the assignment via input 4101. In one embodiment, the assignment is uploaded to the local content server 101, or to storage in communication with the server 101, over the local area network 102 or other network 311. In an embodiment, the student may receive confirmation that the assignment has been completed and/or uploaded from the local area network 101.

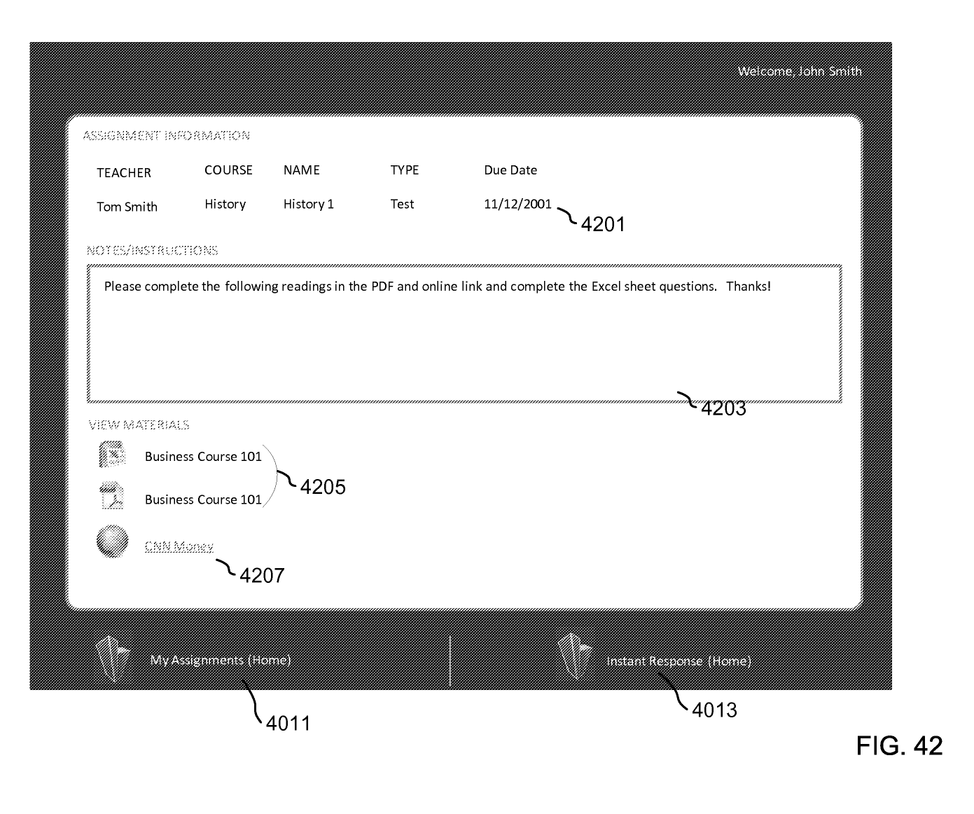

FIG. 42 is an exemplary graphical user interface showing a student assignment screen according to an embodiment of the present disclosure. In one embodiment, the assignment screen of FIG. 42 is generated upon selection of a particular assignment from the assignment list of FIG. 40. In the embodiment, specific information 4201 regarding an assignment may be provided. Information 4201 may include, but is not limited to, teacher, course, name, type, due date, points earned, number of questions, and any other suitable information. Additionally, notes and/or instructions 4203 provided by the teacher may accompany the assignment. For example, and without limitation, additional notes regarding the due date, the point value of the assignment, or other data regarding the assignment and/or attachments may be provided. In one embodiment, a student notes section is also provided to allow the student to write notes related to the assignment. In one embodiment, the student notes are transmitted back to the teacher. Additionally, links to the reference materials associated with the assignment may be provided for review. The materials may be for example, and without limitation, one or more electronic files or one or more Web links, or one or more applications. In one embodiment, the assignment screen of FIG. 42 provides a link or input for navigating to an assignment upload section, such as the assignment upload screen of FIG. 41. In one embodiment, the assignment screen of FIG. 42 provides a link or input for viewing returned assignment files from the teacher, such as assignments that have been graded or reviewed.

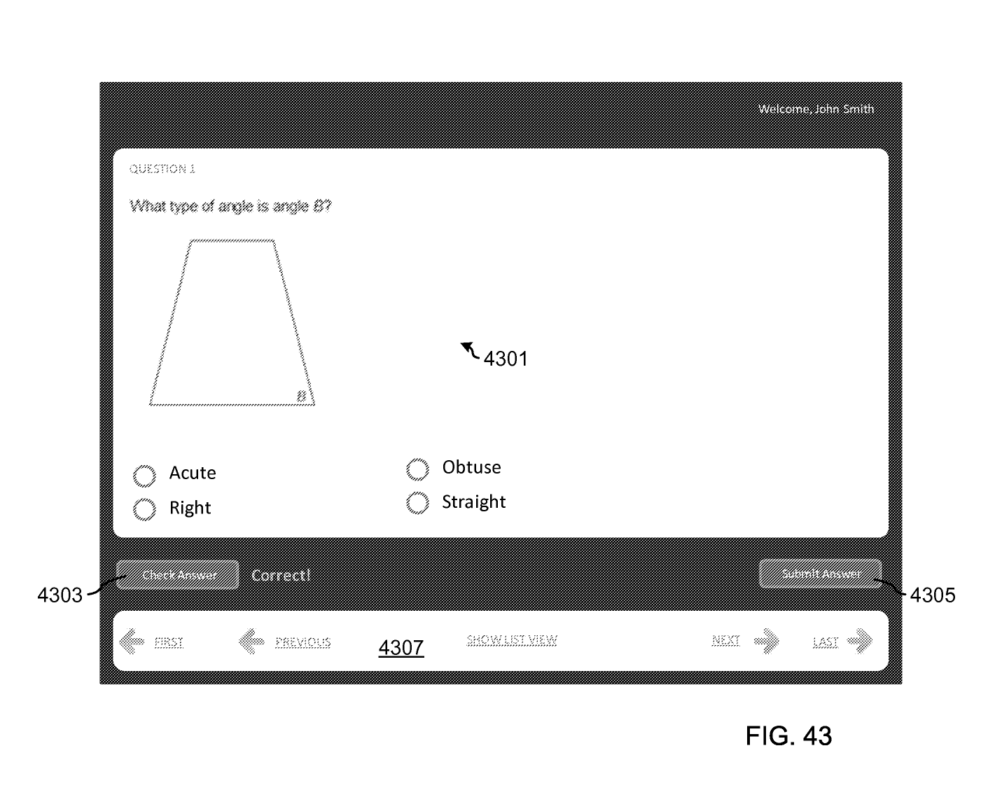

FIG. 43 is an exemplary graphical user interface showing a student question screen according to an embodiment of the present disclosure. In the embodiment, upon starting an assignment, a question 4301 from a selected assignment is displayed on the portable device 127. The question, in the embodiment, is a multiple-choice question, and includes a plurality of possible answers. The student may select one or more of the answers, depending on the type of question presented, and may submit the answer via input 4305. In an embodiment, the student may be able to check the students answer against the correct answer via input 4303. Depending on the assignment rules set by the teacher, the check may occur before or after the answer is submitted, providing the student with instant feedback regarding the answer to the question. Additionally, in an embodiment, the student may be able to move within the assignment from question to question via inputs 4307, without necessarily answering the question currently presented. For example, the student may move from the first question to the third question without answering the first or second question. In an embodiment, the student may be able to show a list of questions, and may be able to choose one or more of the questions to answer in a nonlinear way.

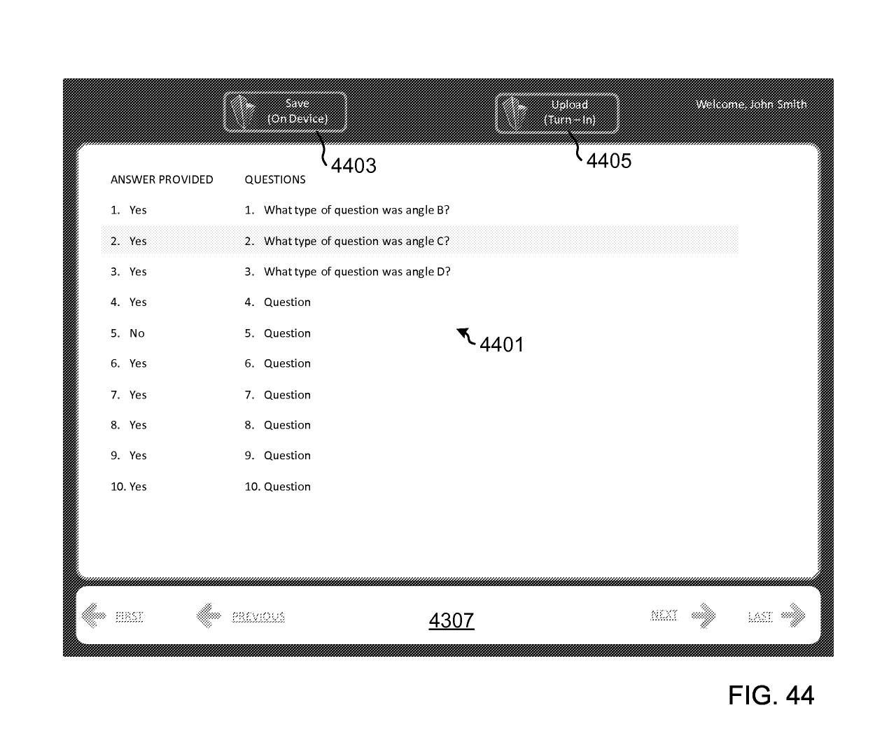

FIG. 44 is an exemplary graphical user interface showing an assignment summary screen for a student according to an embodiment of the present disclosure. In the exemplary embodiment, the student may be able to see a summary 4401 of the questions and the answers provided in the question screens of FIG. 43. In an embodiment, the correct answer may also be shown, or correct and/or incorrect answers may be highlighted. The student may be able, if allowed in the assignment, to change answers if possible, or may be able to upload and/or turn in the assignment via inputs 4405. Additionally, the student may be able to save the assignment to the local device 127 via input 4403, or to the student's space in a cloud storage area or other networked storage area.

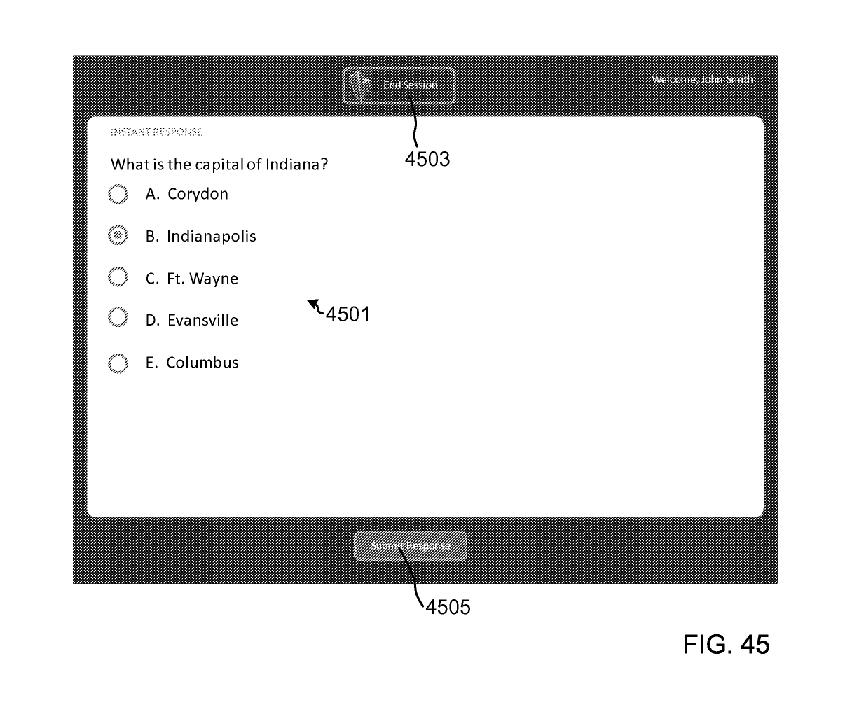

FIG. 45 is an exemplary graphical user interface showing an instant response screen according to an embodiment of the present disclosure as viewed on a student portable device 127. In an embodiment, an instant response question 4501 is provided to the student. In the embodiment, the question is provided to the student and a multiple-choice set of answers is also provided. The student may select one or more of the multiple-choice answers, and may be able to submit the response via input 4505. The student may also be able to end the session via input 4503. As described herein, the student may have a limited time to submit a response, and additional students may be viewing the question simultaneously on other portable devices 127. In one embodiment, the functionality and user interfaces provided in FIGS. 40-45 are executed at least in part by the automate module 141 and/or analyze module 123.

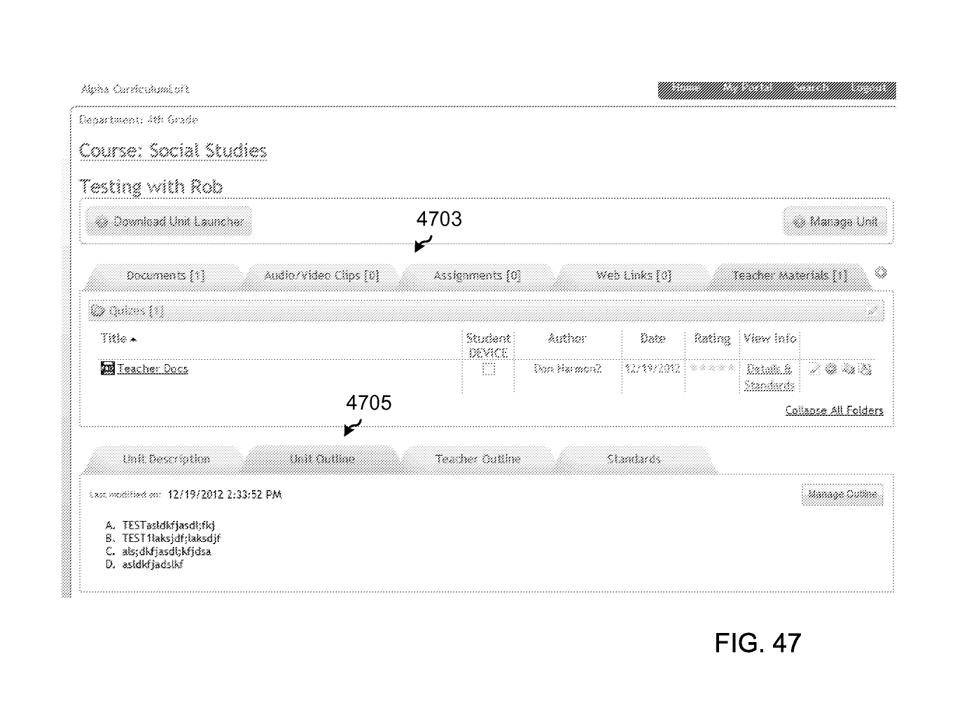

Referring now to FIG. 46, a navigation bar 4601 of a teacher's home screen is illustrated. Navigation bar 4601 may be the same as navigation bar 2109 described herein with respect to FIG. 21. With fourth grade and Math 4 selected as the department and course from the navigation bar 4601, several units of study 4603 are displayed. Units of study include categories, topics, or concepts that are covered in a course. For example, a unit of study may correspond to a chapter or group of chapters in a textbook or course book. Each unit of study 4603 may have lessons, assignments, tests, quizzes, instructional documents, reference materials, and other documents associated with it. Units of study 4603 may be added and edited for the course. Exemplary units of study for a math course may include, for example, addition, subtraction, multiplication, division, or any other categories of concepts/topics. Each unit of study 4603 may be accessed and edited upon selection in FIG. 46. Referring to FIG. 47, a management screen for a selected unit of study is illustrated. Organized under tabs 4703 are documents, audio/video clips, assignments, web links, teacher materials, and other content/documents associated with the unit of study. Each document and content in tabs 4703 may be accessed, edited, or deleted. In addition, a description and schedule or lesson outline of the unit of study is located under tabs 4705, as well as applicable state and national standards information. All information and content stored under the unit of study may be edited or added/deleted by the teacher via the user interface of FIGS. 46 and 47.

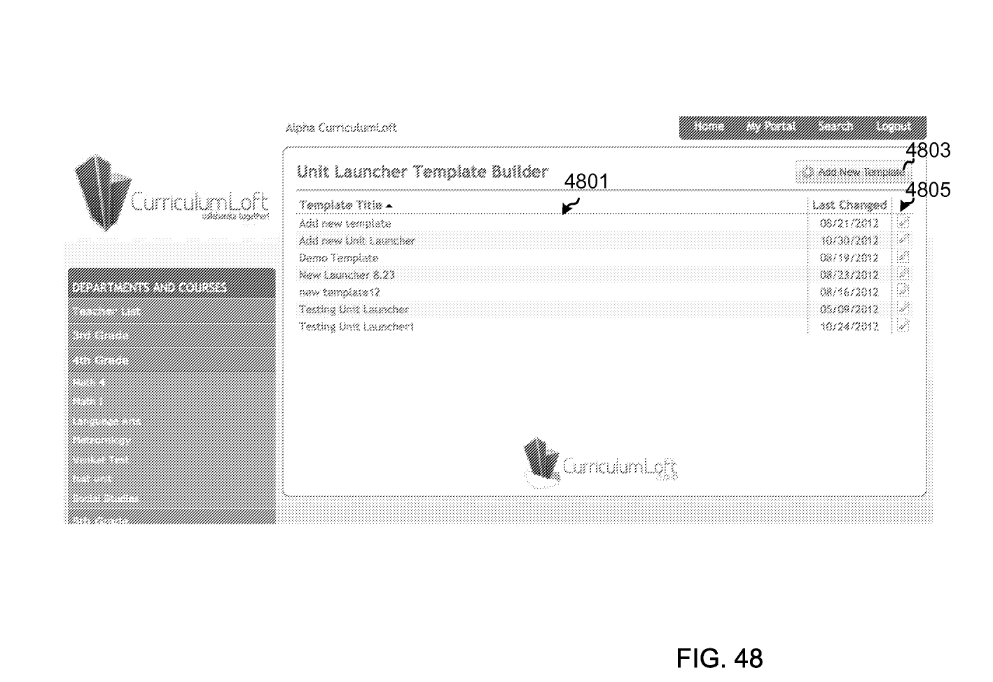

Upon selection of the unit launcher template builder link 2115 of FIG. 21, a unit launcher template builder screen is provided, as illustrated in FIG. 48. List 4801 includes several existing templates, stored at the local content server 101 or cloud, for example, that may be accessed by a user (e.g., teacher or administrator) to build a unit of study for a course. For example, the template may include various unit topics, lessons, relevant documents and references, applicable standards, etc. As such, a teacher may modify an existing unit of study that has been saved to the local content server 101 for use in a course.

In one embodiment, the framework module for application and/or software creation 107 and/or the framework module for digital content creation 105, and/or other suitable module or engine, allow content creators to create a user interface and/or application for a unit of study. A template builder engine, such as the unit launcher template builder for example or other suitable framework, may guide the user in the creation of the user interface/application. In one embodiment, the frameworks 105, 107 may include one or more forms, one or more tutorials, or one or more walk-through screens to help and/or guide a content creator, and to allow the content creator to input content into the framework, and create a user interface or other application from the content. For example, referring to FIG. 49, an exemplary user interface for a unit of study is illustrated that is created by a user using the content/application creation framework. The unit of study is illustratively related to science, and in particular to the study of dinosaurs, although any suitable subject or topic may be used. In one embodiment, the user interface is created by teachers, although any suitable user may be a content creator. The user interface of FIG. 49 is accessible by student users, for example, to access content and documents related to the unit of study, such as lessons, assignments, tests, quizzes, instructional documents, reference materials, and other documents associated with the unit of study. One or more images may be selected by the teacher and inserted into the space 4907 of a home page, and background colors, other images, screen layout, and other aspects may be designed by the teacher. A plurality of learning blocks 4909 may be created that cover various topics or concepts of the unit of study. The illustrative learning blocks 4909 include the topics of flying dinosaurs, meat eaters, plant eaters, and a learn-by-size learning block. Selection of each learning block 4909 may provide access to lesson plans, assignments, tests, quizzes, instructional documents, reference materials, and other associated documents and content related to the learning block topic. A lesson plan for the unit of study may be added/created and accessed via input 4901, and a chat room or other conferencing tool may be accessed via input 4903. Assignments for the unit of study and/or particular lesson of the unit of study may be accessed via input 4905. In one embodiment, user interfaces and/or applications created by the users may be shared with other users, such as on the cloud, or may be sold or otherwise made available on the application store module 139, for example.

An exemplary method of managing curriculum content on one or more networks, such as LAN 102 and network 311 of FIG. 1, in an educational environment includes providing a portable computing device 127 operative to execute a curriculum module 509 and at least one non-education based application, such as an internet web browser, for example, as described herein. The curriculum module 509 is configured to perform education-based functions including at least one of assignment management and test management and to connect to a network 102, 311 for accessing electronic course materials, as described herein. The method includes transmitting, by a computing system such as local content server 101 or administration system 103, a lock mode signal to the portable computing device 127 to initiate a lock mode at the portable computing device 127, as described herein. In the lock mode, the portable computing device 127 allows operation of the curriculum module 509 and blocks user access to the at least one non-education based application. The method may further include transmitting a test mode signal to the portable computing device 127 to block at least one non-testing operation of the curriculum module 509, such as access to course materials, as described herein. See, for example, at least FIGS. 6, 19, and 23 described herein. The method further includes transmitting, by the computing system, digital curriculum content to memory of the portable computing device 127. In one embodiment, the memory of the portable computing device 127 is organized into a plurality of content storage buckets, and the curriculum content is routed to the plurality of content storage buckets based on a type of the digital curriculum content. In one embodiment, the plurality of storage buckets include at least one of an assignment storage bucket for storing assignment content, a course materials storage bucket for storing course materials, and an applications storage bucket for storing applications. In one embodiment, the curriculum module 509 is operative to provide a graphical user interface including a plurality of selectable display icons, each display icon providing access to a corresponding content storage bucket. For example, icon 3905 of FIG. 39 and icon 4009 of FIG. 40 provide access to assignment content, icon 4003 of FIG. 40 provides access to course materials, etc.

In one embodiment, curriculum content generated and managed with the local content server 101 or with another administrator system/device is stored at the cloud, such as storage 411 of FIG. 3A. In an embodiment, the local content server 101 retrieves at least a portion of the content at the cloud, or copies of the content, and stores the content at the server 101 or at memory accessible by the server 101. The local content server 101 may then transmit the content to multiple portable devices 127 simultaneously, such as during a content sync or at another time, from the server 101 or server-accessible memory. The portable devices 127 may also retrieve the content directly from the cloud via one or more networks 311.

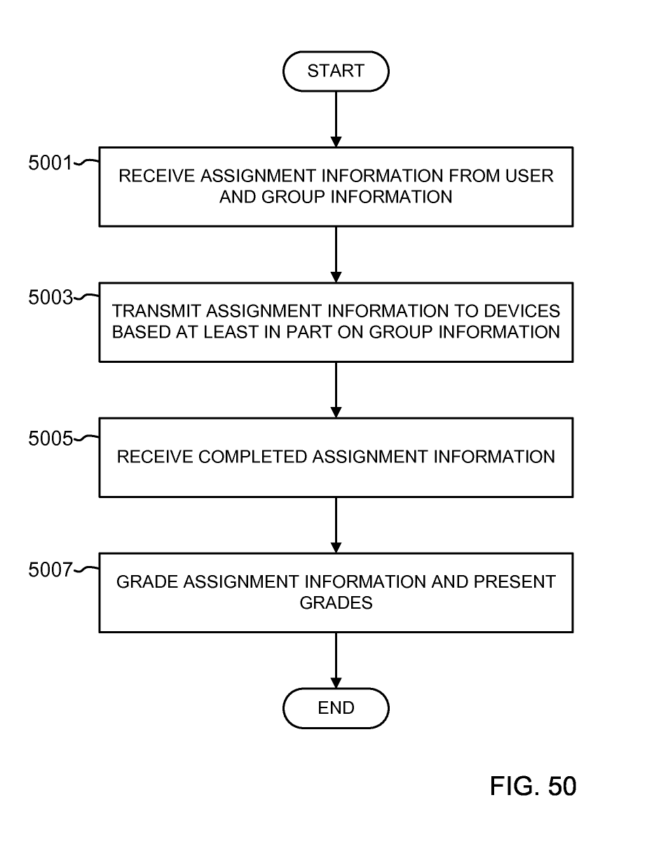

FIG. 50 is an exemplary flowchart showing a method of receiving and recording assignments according to an embodiment of the present disclosure. As shown in box 5001, one or more of the modules associated with the local content server 101 and/or the administration system 103 may receive assignment information from the user, such as, for example and without limitation, a teacher. The assignment information may include one or more questions intended to be posed to a student. The one or more questions may be designed by the teacher, or may be designed by other users, administrators, or may be retrieved from other systems. The user or teacher, in the embodiment shown in FIG. 50, may assign the assignment to one or more groups of students, or to an individual student or subgroup of students.

In box 5003, the local content server 101 and/or one or more modules associated with the local content server 101 may transmit the assignment information to one or more devices based at least in part on the selection of group information by the teacher or other user. The assignment may be transmitted to the one or more devices, or may otherwise be made available to the one or more devices, such as, for example and without limitation, by providing one or more links to the assignment, so that a student using the device may access the assignment and/or associated content through a network.

In box 5005, the local content server 101 and/or one or more modules associated with the local content server 101 may receive completed assignment information from one or more of the one or more devices. The local content server 101 and/or the one or more modules associated with the local content server 101 may receive the completed assignment information via, for example and without limitation, a network.

In box 5007, the local content server 101 and/or one or more modules associated with the local content server 101 may compare the data regarding the assignment received from the one or more devices to, for example and without limitation, one or more master lists that may contain correct answers to the particular assignment. In an embodiment, the teacher or other user may review the content received from the one or more devices, and may grade the content directly, such as in, for example, an assignment that includes free-form answers, or other essay type answers.

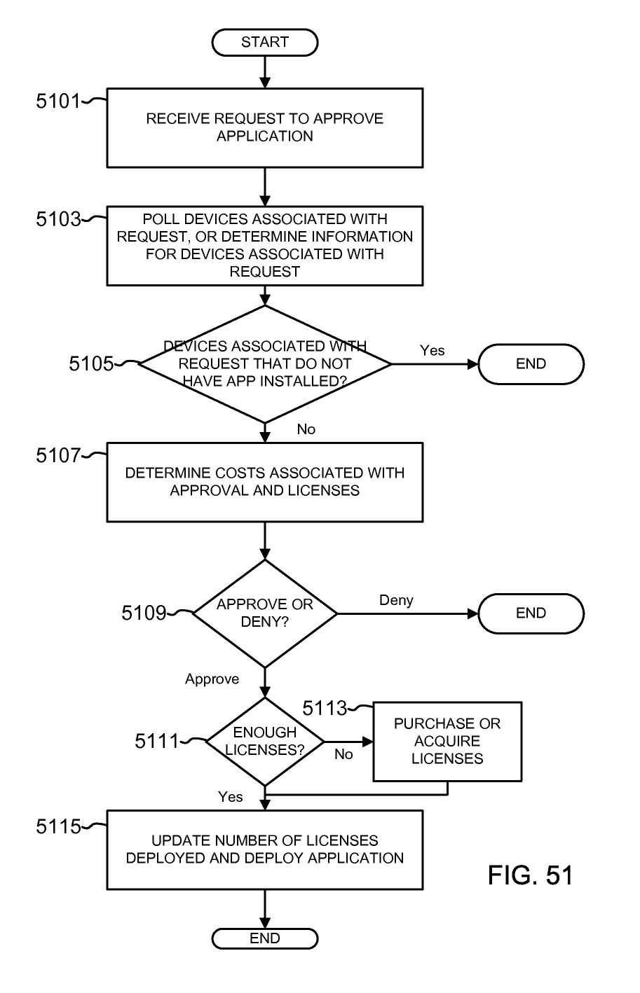

FIG. 51 is an exemplary flowchart showing a method of allocating applications according to an embodiment of the present disclosure. In box 5101, the user receives a request to approve an application for a group of devices, or a single device. The user, in the embodiment, may have been granted rights and/or access, to allow the user to approve or deny application requests. In box 5103, the local content server 101, the administration system 103, or other systems may poll devices that are associated with the request, to determine if the devices already have the application installed. In an embodiment, information regarding the applications installed on a device may be stored and accessible by the local content server 101 and/or the administration system 103. The request may be in the form of one or more groups. For example, and without limitation, the devices associated with a third grade science class may be placed into a group, and the group may be a part of the request for an application.

In box 5105, the local content server 101 and/or the administration system 103 may determine if the request includes devices that do not already have the application installed. If all devices included in the application requests have the application installed, the method may end. If devices included in the application request do not have the application installed, the local content server 101 and/or the administration system 103 may determine the number of devices associated with the applications request that do not have the application installed, and may determine an exact or approximate cost, in box 5107, associated with fulfilling the request, including installing the application on devices that do not currently have the application installed.

In box 5109, the user may be presented with the information on cost and availability, and may approve or deny the request. If the user denies the request, the method may end, and the denial may be transmitted to the requestor or to another user. If the user approves the request, the local content server 101 and/or the administration system 103 may determine if enough licenses are available to install the application on the devices that do not have the application installed. In an embodiment, the application may be free or may be covered by a license that allows unlimited installations, and the method may disregard the number of licenses available and requested. If enough licenses exist to cover the request, the local content server 101 and/or the administration system 103 may distribute the application to the devices that are to receive the application. If insufficient licenses exist to cover the request, the user may be prompted to purchase additional licenses, or may be prompted to make other arrangements to increase the number of total licenses and fulfill the request. In an embodiment, the user may deny the request if an insufficient number of licenses exist, or the application may be deployed to a smaller subset of the total group of requesting devices.

If a group is requested to receive an application, and the request is approved, the application is pushed to the group of devices. If, after the request, a device not assigned to the group is later assigned to the group, the local content server 101 and/or the administration system 103 may push the application or other content in the request to the device, if the device does not already have the application or other content. An administrator or other user may track licenses, and may purchase additional licenses if necessary to cover the newly added device. If, after the request, a device that was assigned to the group is no longer assigned to the group, the application or other content in the request may be deleted from the device, or the device user may be prompted to remove the content. The license, if required, is then unassigned.

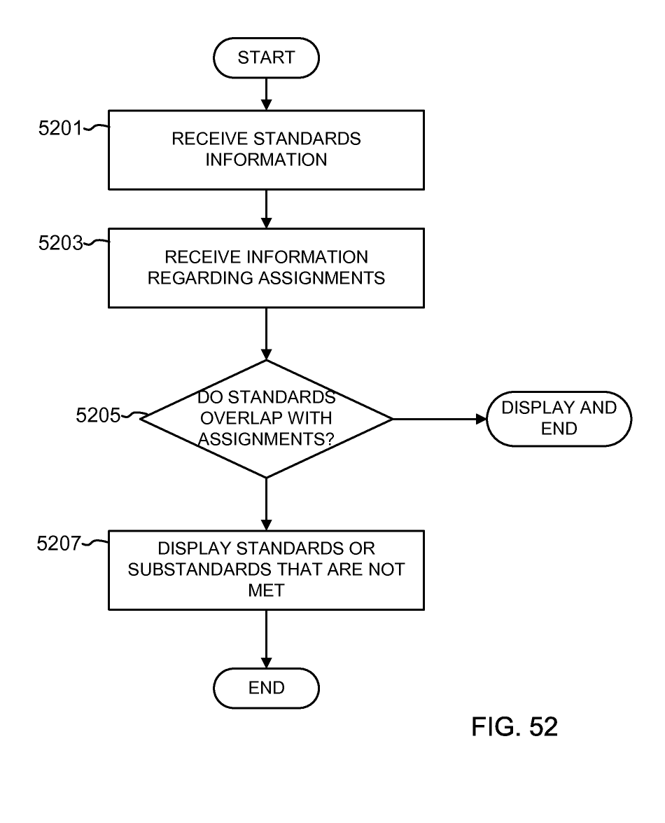

FIG. 52 is an exemplary flowchart showing a method of assigning and reporting standards information according to an embodiment of the present disclosure. In box 5201, the local content server 101 and/or the administration system 103 may receive standards information. The standards information may include, but is not limited to, information regarding the applicability of one or more standards to a particular class, a particular grade, or a particular district or state requirement. In box 5203, the local content server 101 and/or administration system 103 may receive information regarding one or more assignments used for a class, grade, or district or building.

In box 5205, based at least in part on the assignments or other coursework available and the standards received, the local content server 101 and/or administration system 103 analyzes the assignments in view of the standards. If assignments individually, or when taken together as a group, do not meet one or more of the standards or sub-standards, the user may be alerted. The alert may include, but is not limited to, the standard or portion of the standard that is not met by the assignment or assignments, and other information that may be useful to design coursework or other assignments to meet the requirements in the standards.

In an embodiment, a method for publishing content is provided. The method may include receiving assignment information from a user, transmitting assignments to one or more devices based at least in part on the assignment information received from the user, receiving completed assignments, and grading the completed assignments against at least one master file. In an embodiment, the assignment information includes a selection of groups or students to assign the assignment. In an embodiment, the assignment information includes one or more assignments. In an embodiment, the assignment information includes one or more attached electronic files associated with the assignment.

In an embodiment, a method for deploying content is provided. The method may include receiving a deployment request for one or more pieces of content, determining if one or more devices already has the one or more pieces of content requested, determining costs associated with the deployment request, allowing a user to approve or deny the request based at least in part on the determination of cost, and deploying the application to the one or more devices if the user accepts the deployment request. In an embodiment, a deployment request includes a group of devices to receive the one or more pieces of content. In an embodiment, the group is indicated in the deployment request, rather than devices individually. In an embodiment, if a device is removed from the group indicated in the deployment request, the application is deleted from the device. In an embodiment, if a device is added to the group indicated in the deployment request, after the deployment request is approved and the application is distributed, the application is delivered to the device added to the group.

In an embodiment, a method for determining standards alignment is provided. The method may include receiving standards information, receiving one or more assignments, determining if the one or more standards aligns with the one or more assignments, and displaying areas of alignment and/or nonalignment for analysis.

In one embodiment, teachers can view and copy course materials and other curriculum content on the cloud that were prepared or used by other teachers in the building or by teachers from other buildings. In one embodiment, the content is purchased. In one embodiment, teachers may assign and deploy different assignments and tests/quizzes, or versions of assignments and tests/quizzes, to different students within the same grade level or same class, such as based on the ability of the student, for example, using the automate module 141 and group settings and configurations, as described herein. The different assignments and tests/quizzes may have varying degrees of difficulty.

The above detailed description of the disclosure and the examples described therein have been presented for the purposes of illustration and description only and not by limitation. It is therefore contemplated that the present disclosure cover any and all modifications, variations or equivalents that fall within the spirit and scope of the basic underlying principles disclosed above.

What is claimed is:

1. A method of managing content on at least one network in an educational environment, the method including:
receiving, by a local content server, at least one software module from an administration system over a wide area network, the administration system including a plurality of software modules operative to perform education-based functions and to manage digital curriculum content;
at least one of generating and managing digital curriculum content with the at least one software module at the local content server, the local content server being connected to a local area network;
detecting at least one student computing device on the local area network, wherein digital curriculum content is stored at the at least one student computing device; and
syncing the digital curriculum content at the local content server with the digital curriculum content stored on the at least one student computing device.

2. The method of claim 1, wherein the syncing includes receiving a request for updated digital curriculum content from the at least one student computing device, and transmitting the updated digital curriculum content to the at least one student computing device.

3. The method of claim 1, wherein the digital curriculum content generated and managed by the local content server is stored on a cloud system accessible by the local content server over the wide area network.

4. The method of claim 1, wherein the digital curriculum content is synced upon detection of the at least one student computing device on the local area network.

5. The method of claim 1, wherein the digital curriculum content is synced at predefined polling intervals.

6. The method of claim 5, wherein the polling intervals are set via a graphical user interface generated by at least one of the plurality of software modules.

7. The method of claim 1, wherein the syncing includes receiving at the local content server assignment information from the at least one student computing device, the assignment information including student responses to assignment questions.

8. The method of claim 1, wherein the at least one student computing device receives and executes at least one of the plurality of software modules, the at least one software module at the at least one student computing device being configured to communicate with the at least one software module at the local content server for performing the syncing.

9. The method of claim 1, further including transmitting, by the local content server prior to the receiving, a request to the administration system over the wide area network for the at least one software module.

10. The method of claim 1, wherein the digital curriculum content includes assignment data and course material data.

11. A content management system configured to manage content on at least one network in an educational environment, the content management system including:
an administration system configured to communicate over a wide area network, the administration system including a plurality of software modules configured to perform education-based functions and to manage digital curriculum content stored on a cloud system;
a local content server connected to a local area network, the local content server being configured to receive at least one software module from the administration system over the wide area network and to at least one of generate and manage digital curriculum content with the at least one software module; and
a plurality of student computing devices each including a transceiver for communicating over the local area network with the local content server, the local content server being operative to sync digital curriculum content at the local content server with digital curriculum content stored on the plurality of student computing devices when the plurality of student computing devices are connected on the local area network.

12. The system of claim 11, wherein the local content server syncs the digital curriculum content upon receiving a request for updated digital curriculum content from the at least one student computing device, the local content server transmitting the updated digital curriculum content to the at least one student computing device upon receiving the request.

13. The system of claim 11, wherein the plurality of student computing devices are further configured to communicate with the administration system over the wide area network, wherein the wide area network is an internet network.

14. The system of claim 11, wherein the local content server stores the digital curriculum content on the cloud system, and the digital curriculum content includes assignment data and course material data.

15. The system of claim 11, wherein the local content server syncs the digital curriculum content at polling intervals set via a graphical user interface generated by at least one of the plurality of software modules.

16. A method of managing curriculum content on at least one network in an educational environment, the method including:
providing a portable computing device operative to execute a curriculum module and at least one non-education based application, the curriculum module being configured to perform education-based functions including at least one of assignment management and test management and to connect to a network for accessing electronic course materials;
transmitting, by a computing system, a lock mode signal to the portable computing device to initiate a lock mode at the portable computing device, wherein in the lock mode the portable computing device allows operation of the curriculum module and blocks user access to the at least one non-education based application; and
transmitting, by the computing system, digital curriculum content to memory of the portable computing device.

17. The method of claim 16, wherein the memory of the portable computing device is organized into a plurality of content storage buckets, the curriculum content being routed to the plurality of content storage buckets based on a type of the digital curriculum content.

18. The method of claim 17, wherein the plurality of storage buckets include at least one of an assignment storage bucket for storing assignment content, a course materials storage bucket for storing course materials, and an applications storage bucket for storing applications.

19. The method of claim 17, wherein the curriculum module is operative to provide a graphical user interface including a plurality of selectable display icons, each display icon providing access to a corresponding content storage bucket.

20. The method of claim 16, wherein the at least one non-education based application includes a web browser operative to access the internet.

21. The method of claim 16, wherein the computing system includes a local content server connected on a local area network, and the lock mode signal is transmitted to the portable computing device by the local content server upon detection of the portable computing device connected on the local area network.

22. The method of claim 16, further including transmitting a test mode signal to the portable computing device to block at least one non-testing operation of the curriculum module.

23. The method of claim 22, wherein, upon receipt of the test mode signal, the curriculum module blocks user access to course materials stored at the portable computing device.

24. The method of claim 16, wherein the digital curriculum content is transmitted to the portable computing device upon receipt of a content request signal from the portable computing device.

25. The method of claim 16, wherein the computing system is operative to access cloud storage over a wide area network, and at least a portion of the digital curriculum content is stored at the cloud storage.
